(19) United States
(12) Patent Application Publication
(10) Pub. No.: US 2012/0132701 A1
(43) Pub. Date: May 31, 2012

(54) REMOTE CODE READER SYSTEM

(76) Inventors: Katsuya Nakagawa, Shiga (JP); Shuhei Kato, Shiga (JP)

(21) Appl. No.: 12/600,008

(22) PCT Filed: May 13, 2008
(86) PCT No.: PCT/JP08/01192

§ 371 Date: Jan. 20, 2012

(30) Foreign Application Priority Data
May 14, 2007 (JP) 2007-127579
May 18, 2007 (JP) 2007-132556
May 23, 2007 (JP) 2007-136376
Jun. 5, 2007 (JP) 2007-149311

(51) Int. Cl. G06F 17/00

(52) U.S. Cl. 235/375

(57) ABSTRACT

In step S260, a center server 31 accesses a search engine 98 to search for each of a company name and a commodity name corresponding to a barcode 11 as received in step S254, on a network 33. In step S262, the center server 31 acquires URLs which appear at the highest positions in the search ranking of the respective search results, and regards them as an address of an web site of the company and an address of an web site of the commodity. In step S264, the center server 31 transmits an individual portal screen, which includes link buttons for accessing the acquired URLs (the home page of the company and the web site of the commodity), to a PC 43.

### TECHNICAL FIELD

The present invention relates to a remote code reader system and the related arts for collecting and processing codes (for example, barcodes) which are transmitted from local code readers.

### BACKGROUND ART

Patent Document 1 introduces technique utilizing a barcode in order to facilitate access to a predetermined WEB server. That is, a personal computer transmits a barcode received from a barcode reader to a barcode-URL converting server (hereinafter referred to as a “converting server”). Then, the personal computer receives a URL obtained by converting, and accesses the predetermined WEB server on the basis thereof.

Patent Document 2 discloses a device for providing a content corresponding to a barcode (English pronunciation and so on) by scanning the barcode printed on a card or a booklet.
Patent Document 1: Japanese Patent Published Application No. 2002-373311
Patent Document 2: Japanese Patent Published Application No. Hei 5-6135

### DISCLOSURE OF THE INVENTION

### Problem to be Solved by the Invention

In Patent Document 1, the converting server is required to have a barcode-URL converting table. Accordingly, when a barcode and a URL are registered in this table, the personal computer can not access the WEB server and therefore display a content. If this inaccessible case increases, there is a progression of estrangement of acquired users, and it becomes difficult to acquire new users. Also, the more complete the table is created, the more a lot of time, a great expense, and a great effort are required, and therefore increase of a cost is caused.

It is therefore an object of the present invention to provide a remote code reader system capable of converting a code to an address and moreover reducing a cost even if when data in which the code is associated with the address on a network is not held, and the related techniques thereof.

Meanwhile, in Patent Document 1, it is presumable that dishonest act, i.e., using a barcode for the other purpose without sending the barcode to the converting server, or sending the barcode to the other server which is not the qualified converting server, by installing a wrongful program on a personal computer or altering an already installed program, is committed. By obtaining rights such as a patent relating to the program and the device which execute the dishonest act as a method for excluding the dishonest act, if the wrongful program and so on are distributed or sold, it is possible to exclude them by the rights such as the patent.

It is therefore an another object of the present invention to provide a computer readable storage medium storing a computer program for executing a dishonest act preventing method of preventing dishonest act in accessing a network by using a code, and the related techniques thereof.

By the way, in Patent Document 2, a barcode to be scanned is previously fixedly printed on the card or the booklet.

It is therefore a further object of the present invention to provide a barcode creating apparatus capable of creating a barcode dynamically, and the related techniques thereof.

Also, it is a still further object of the present invention to provide a remote code reader system capable of executing various processings in accordance with a barcode that is dynamically created, and the related techniques thereof.

### Solution of the Problem

In accordance with a first aspect of the present invention, a remote code leader system comprising: a plurality of local code leaders each of which is capable of reading a code and connected with a communication terminal corresponding thereto, said communication terminal being connectable with Internet; and a host computer operable to receive a plurality of the codes transmitted from the plurality of said local code leaders, wherein each of said local code leaders includes a transmitter configured to transmit the code as read to said host computer through the communication terminal corresponding thereto and the Internet, and wherein said host computer includes a processing unit configured to search for a name of a company corresponding to the received code on the Internet by using a search engine, and acquire address information of a site related to the company.

In accordance with this configuration, it is possible to acquire the address information (e.g., URL) of the site relating to the company corresponding to the code using the existing search engine, so that there is no need to preliminarily prepare the address information of the site relating to the corresponding company by associating with the code. As the result, it is possible to reduce the cost. By comparison, to prepare address information items of the sites of all the companies, a lot of time, effort and cost are required. Also, even the case where the address information is preliminarily prepared by associating with the code, it is possible to complement address information which is not prepared by acquiring the address information using the search engine.

Also, a plurality of arbitrary local code leaders are connected with the host computer through the Internet and the plurality of arbitrary communication terminals connected thereto. In other words, a plurality of various and arbitrary local code readers are connected to the host computer, regardless of the individuals and enterprises. Accordingly, the host computer can globally collect and process a number of various and arbitrary codes.

In accordance with a second aspect of the present invention, a remote code leader system comprising: a plurality of local code leaders each of which is capable of reading a code and connected with a communication terminal corresponding thereto, said communication terminal being connectable with Internet; and a host computer operable to receive a plurality of the codes transmitted from the plurality of said local code leaders, wherein each of said local code leaders includes a transmitter configured to transmit the code as read to said host computer through the communication terminal corresponding thereto and the Internet, and wherein said host computer includes a processing unit configured to search for an item corresponding to the received code on the Internet by using a search engine, and acquire address information of a site related to the item.

In accordance with this configuration, it is possible to acquire the address information (e.g., URL) of the site relating to the item corresponding to the code using the existing search engine, so that there is no need to preliminarily prepare the address information of the site relating to the corresponding item by associating with the code. As the result, it is possible to reduce the cost. By comparison, to prepare address information items of the sites of all the items, a lot of time, effort and cost are required. Also, even the case where the address information is preliminarily prepared by associating with the code, it is possible to complement address information which is not prepared by acquiring the address information using the search engine.

Also, a plurality of arbitrary local code leaders are connected with the host computer through the Internet and the plurality of arbitrary communication terminals connected thereto. In other words, a plurality of various and arbitrary local code readers are connected to the host computer, regardless of the individuals and enterprises. Accordingly, the host computer can globally collect and process a number of various and arbitrary codes.

In the remote code reader systems according to the above first and second aspects, said processing unit acquires the address information which appears at the highest position in search ranking of the search result by the search engine.

In accordance with this configuration, it is easily possible to determine the address information to be acquired even if many sites appear in the search result.

In the remote code reader systems according to the above first and second aspects, said processing unit generates a screen including link information to the corresponding site on the basis of the acquired address information in order to send to the communication terminal.

This screen includes the link to the site (hereinafter referred to as the “direct site”) which directly relates to the company or the item corresponding the code, and therefore functions as a page for relaying to the site to be accessed.

The user of the communication terminal accesses the direct site via always the screen for relaying (hereinafter referred to as the “relay screen”). Accordingly, the business entity operating the host computer (hereinafter referred to as the “system operating business entity”) can promptly obtain statistical data relating to the company or the item corresponding to the code by collecting and analyzing status of the user access to the relay screen and the linked page included therein. For example, it is possible to analyze the market of the item based on the obtained statistical data Also, it is also possible to analyze based on the comparison with an item of the same sort. These are economically worth, and therefore can be income stream of the system operating business entity. In this way, it is possible to increase income-generating opportunity of the system operating business entity by providing the relay screen. By comparison, if the user can directly access the direct site in response to the scan of the code, the system operating business entity can not recognize the access status to the respective direct sites.

Besides, when the relay screen is generated, the address information relating to the company or the item corresponding to the code is acquired using the search engine. Thus, in as far as the site of the company or the item corresponding to the code exists on the network, it is possible to prevent such disadvantageous situation as the link of the company or the item corresponding to the code is not included in the relay screen. That is, since it is possible to prevent inability to access the site of the company or the site of the item as much as possible, it is possible to prevent the existing user from disaffiliating, and also contribute to new user acquisition.

In this remote code reader system, the code is a code given specific to each item, and wherein the screen is a screen specific to the item corresponding to the code.

In accordance with this configuration, when the user who is interested in a commodity (item) or has purchased a commodity transmits the code information given specific to the commodity (item) through the terminal installed in the store, the personal residence or the like, the terminal can receive information for generating the relay screen (hereinafter referred to as “individual portal screen”) specific to the commodity (item) from the host computer, and display the individual portal screen. Since this individual portal screen is a screen specific to the commodity indicated by the code information, it includes link information to the server of the manufacturer, vendor or the like (advertising client) distributing the information about the commodity, and so forth. Accordingly, the user of the terminal can easily access the server of the manufacturer, vendor or the like of the commodity through the individual portal screen, and can easily browse information about the desired commodity.

For the advertising client such as the manufacturer, vendor or the like, there is an advantage that the information about a commodity can be provided to the individual who is interested in the commodity or has purchased the commodity with pinpoint accuracy through the individual portal screen. In this regard, this system substantially differs from the conventional affiliate program.

On the other hand, for the user of the terminal, for example, when the user becomes interested in a commodity or wants to search some information about a purchased commodity, it is possible to display the individual portal screen which is specific to the commodity on the terminal only by transmitting the code information given specific to the commodity. The user can therefore easily access the target site through the individual portal screen. Because of this, it becomes much easier to acquire the information about the commodity as compared with the case where the information about the commodity is acquired by inputting terms, which seem to be related to the commodity, to a general purpose search engine, or by making use of a conventional portal site and searching for the information about the desired commodity among a number of commodities which are classified in a structured manner.

As a consequence, it is possible to effectively support the terminal in accessing the server of the advertising client which distributes the information about a commodity.

Incidentally, the system operating business entity can make a profit from the advertising client when preparing the individual portal screen. For example, while charging no fee for the individual portal screen in which only the link information to the home page of the advertising client is displayed, a certain fee is charged to the advertising client who desires to display more link information items in the individual portal screen. The link information items increase in the individual portal screen in this manner.

If many link information items are displayed in the individual portal screen, the corresponding commodity can be advertised from a variety of angles, and thereby the users are more encouraged to buy the commodity than when a fewer link information items are displayed in the individual portal screen. In other words, when comparing similar commodities, the sales total of commodity products of the advertising client having the individual portal screen containing many link information items is expected to be larger than the sales total of commodity products of the advertising client having the individual portal screen containing a fewer link information items. Accordingly, the manufacturer, vendor or the like of the commodity is expected to desire to display extra link information items even if it requires paying a fee.

For the same reason, it is apparent that a difference occurs in sales between the store such as a retail store with this system, and another store without this system. Accordingly, most business entities operating stores are also expected to introduce the present system. In this case, the system operating entity can make profits by charging the business entities operating the respective stores.

In this remote code reader system, the link information includes link information to a home page of an advertising client of an item indicated by the code information, link information to a site in which a commercial video of the item indicated by the code information is distributed, link information to a site in which the item indicated by the code information can be purchased, link information to a site in which an image of the item indicated by the code information is displayed, link information to a site in which description is given for the item indicated by the code information, link information to a site in which user registration can be done in relation to the item indicated by the code information, link information to a site in which a questionnaire can be conducted in relation to the item indicated by the code information, link information to a site in which after-sales service is provided for the item indicated by the code information, or any arbitrary combination thereof.

In accordance with this configuration, it is possible to provide the user the information about the commodity itself from a variety of angles via the portal screen. Particularly, the portal screen includes the link information to the site in which a questionnaire can be conducted, and therefore it is possible to perform market research about various commodities. In this case, it is possible to swiftly obtain the result in real time. In this way, the system operating business entity can obtain profitable information.

Also, in this remote code reader system, the screen includes link information to a site in which user registration can be done, link information to a site in which a questionnaire can be conducted, or any arbitrary combination thereof.

In accordance with this configuration, it is possible to collect the user information, and perform the aggregation of questionnaire which does not depend on a company and an item to which the code is assigned, through the portal screen.

Further, in this remote code reader system, the screen includes link information to a site of a store or a retailer, which sells an item indicated by the code information.

In accordance with this configuration, it is possible to improve the convenience of the user, and in addition thereto, the system operating business entity can make a profit from the store and so on.

In the remote code reader systems according to the above first and second aspects, said processing unit sends the acquired address information to the communication terminal.

In accordance with this configuration, the user can directly access the site of the company or item corresponding to the code by scanning the code.

Besides, the address information relating to the company or the item corresponding to the code is acquired using the search engine. Thus, in as far as the site of the company or the item corresponding to the code exists on the network, it is possible to prevent such disadvantageous situation as it is impossible to access the company site or the item site.

In accordance with a third aspect of the present invention, a remote code leader system comprising: a plurality of local code leaders each of which is capable of reading a code and connected with a communication terminal corresponding thereto, said communication terminal being connectable with Internet; and a host computer operable to receive a plurality of the codes transmitted from the plurality of said local code leaders, wherein each of said local code leaders includes a transmitter configured to transmit the code as read to said host computer through the communication terminal corresponding thereto and the Internet, and wherein said host computer includes a processing unit configured to generate address information on the Internet on the basis of a part or entirety of the received code.

In accordance with this configuration, the host computer can acquire the data which corresponds to the code and is located on the Internet based on the generated address information.

In this remote code reader system, said processing unit acquires data located at a location indicated by the generated address information, and generates a screen including information included in the data in order to send to the communication terminal.

In accordance with this configuration, the user can browse the screen specific to the code by scanning the code. Because, the address information is address information specific to the code, and therefore the data located at the location designated by the address information is also data specific to the code.

In this remote code reader system, the address information includes at least a part or entirety of a protocol, a domain name, and the code.

In the remote code reader systems according to the above first, second and third aspects, the code is a common product code.

The common product codes are originally designed for use in the POS system rather than for use in the present system. In other words, the common product codes are provided independently of the present system, and widely distributed in the world for the aforementioned purpose. Accordingly, the present system can provide services by the use of the common product codes which have been widely distributed in the world.

In addition, the user can easily obtain a good to which a common product code having been widely distributed is attached, and the present system can readily be available only with the code reader on the assumption that an appropriate network environment has been established.

Furthermore, on the system installation side, since the common product codes having been widely distributed can be used, it requires smaller labor as compared with the case where only the other codes are used.

In this remote code reader system, the common product code is a code which is used in a POS (Point Of Sale) system. For example, the common product code is a code according to JAN (Japanese Article Number), EAN (European Article Number), or UPC (Universal Product Code). Also, for example, the common product code is a code according to ISBN (International Standard Book Number).

In this remote code reader system, when the code as received is an instore code, the processing unit returns a predetermined message to the communication terminal.

In this remote code reader system, said host computer further including: a receiver configured to receive the code which are transmitted from said local code leader; and a classification unit configured to classify the received code into one of a plurality of groups, wherein said processing unit performs, by a use of the received code, a process corresponding to the group to which the received code belongs, and wherein at least one of the groups is a group of the common product code.

In accordance with this configuration, the host computer performs processing in accordance with the group to which the code belongs, and sends the content depending on the group and corresponding to the code, to the communication terminal. Thereby, the communication terminal can display a variety of contents in accordance with the codes. In other words, in response to sending the code to the host computer, the user of the local code reader can receive a variety of services which are provided by the host computer in correspondence with the code. In this case, as long as the user possesses at least one local code reader, he/she can receive a variety of different services. In addition to this, only by scanning the code, the user of the local code reader can readily receive the service and content provided corresponding to the code with no need to search websites for receiving the desired service and content.

Also, the host computer classifies a code as received into either the group consisting of common product codes or another group, and can perform the processing in accordance with the result of classification The common product codes are originally designed for use in the POS system rather than for use in the present system. In other words, the common product codes are provided independently of the present system, and widely distributed in the world for the aforementioned purpose. Accordingly, the present system can provide services by the use of the common product codes which have been widely distributed in the world. On the other hand, the codes other than the common product codes are designed for the purpose of providing a particular service by the use of the present system, but not designed for use in the POS system. Namely, the codes other than the common product codes are provided for use in the present system. Accordingly, in correspondence with the codes other than the common product codes, a variety of services can be provided by the present system in accordance with the purposes of preparing these codes.

As discussed above, while the common product codes are different from the other codes in nature and feature, the user can scan these codes by the use of the same code reader without awareness of this fact, and receive the service provided in accordance with the group consisting of common product codes and a variety of services in accordance with the various codes belonging to the other group.

In addition, the user can easily obtain a good to which a common product code having been widely distributed is attached, and the present system can readily be available only with the code reader on the assumption that an appropriate network environment has been established. On the other hand, the user can receive a wide variety of different services by scanning the codes belonging to the group other than the common product code group.

Furthermore, on the system installation side, since the common product codes having been widely distributed can be used, it requires smaller labor as compared with the case where only the other codes are used.

In the remote code reader systems according to the above first, second and third aspects, the code is transmitted to the host computer by the communication terminal through the Internet in response to transmission of the code from said local code reader.

In accordance with this configuration, since the operation of scanning a code serves as a trigger, the user of the communication terminal can transmit the code to the host computer only by reading the code through the local code reader without need for any particular operation of the communication terminal. That is to say, it is possible to improve the convenience of the user.

In this remote code reader system, the transmission unit outputs, to the communication terminal, the code, address information of said host computer and a command for instructing the communication terminal to transmit the code to said host computer. In this case, the transmission unit outputs the code, the address information and the command to said communication terminal as keyboard data. Also, the command is a command for instructing an operating system which is installed in the communication terminal, and instructs the communication terminal to launch a browser. For example, the operating system is Windows (registered trademark). In this case, the command is output as keyboard data corresponding to a GUI (Graphical User Interface) key+“R” key of a keyboard.

Since the command for an OS such as Windows which is taking a significant market share is output by the local code reader, it is possible to make use of most communication terminals (for example, a personal computer) for use in the present system by an easy procedure, i.e., only by connecting the local code reader to the communication terminal.

In the remote code reader systems according to the above first, second and third aspects, the processing unit performs a different process corresponding to the same code in accordance with a location where the communication terminal is installed.

In accordance with this configuration, the host computer can provide effective service and contents considering a situation of the user even if the codes are the same as each other. Incidentally, the case, where the host computer receives the code attached to the commodity and then transmits the WEB site including the links related to the commodity or the WEB site related to the commodity to the communication terminal, will be explained as an example. In this case, in accordance with the present invention, since it is possible to perform processing by taking into consideration the mental state of the user and in which step the user is when purchasing the commodity (for example, after or before purchasing, away from home or at home), it is possible to effectively provide services and content by taking into consideration the mental state of the user and in which step the user is when purchasing the commodity. This is because differences in the installation locations (referred to as transmission sources of the codes, or connection locations of the local code readers) of the communication terminals, i.e., the locations the users stay, may result in differences in regard to the mental state of the user and in which step the user is when purchasing the commodity.

Accordingly, for example, the installation location of the communication terminal can at least be either a personal residence or a store, wherein the processing unit receives, from the communication terminal installed in the personal residence, the information for determining that the communication terminal is installed in the personal residence, and receives, from the communication terminal installed in the store, the information for determining that the communication terminal is installed in the store.

Also, only the installation locations of the communication terminals are taken into consideration in processing regardless of the hardware performances of the communication terminals. Accordingly, in the case where the categories (e.g., a store and a personal residence) of the installation locations of the communication terminals are different from each other, the host computer performs the different processing even if the hardware performances of the communication terminal are equal to each other, conversely in the case where the categories of the installation locations of the communication terminals are the same as each other, the host computer performs the same processing even if the hardware performances of the communication terminal are different from each other. Needless to say, it is also possible to change the processing depending on the hardware performances of the communication terminals in addition to changing the processing depending on the installation locations.

As described above, it is possible to provide the different services (including contents) based on the same codes depending on the installation locations of the communication terminals even if the hardware performances of the communication terminals are equal to each other.

In the remote code reader systems according to the above first, second and third aspects, the codes are assigned to articles which include tangible entities inclusive of goods or estate, intangible entities inclusive of service or information, commodities, and living things inclusive of human being and animals, and wherein the information includes an image, a sound, a program or data. In this case, the codes include one-dimensional codes, two-dimensional codes, and/or codes which are stored in IC tags. For example, the one-dimensional codes are one-dimensional barcodes, the two-dimensional codes are QR codes, and the IC tags are RFID tags. Particularly, it is possible to promote the use of the present system by making use of barcode which is widely distributed for distinguishing each item of commodity and identifying the manufacturer.

In accordance with a fourth aspect of the present invention, a host computer connectable with a plurality of local code leaders each of which is capable of reading a code and connected with a communication terminal which is provided corresponding to the each local code leader and connectable with Internet, the host computer being connectable with each of the local code leaders through the Internet and the communication terminal corresponding thereto, said host computer comprising: a receiver operable to receive a plurality of the codes transmitted from the plurality of the local code leaders; and a processing unit operable to search for a name of a company corresponding to the received code on the Internet by using a search engine, and acquire address information of a site related to the company.

In accordance with a fifth aspect of the present invention, a host computer connectable with a plurality of local code leaders each of which is capable of reading a code and connected with a communication terminal which is provided corresponding to the each local code leader and connectable with Internet, the host computer being connectable with each of the local code leaders through the Internet and the communication terminal corresponding thereto, said host computer comprising: a receiver operable to receive a plurality of the codes transmitted from the plurality of the local code leaders; and a processing unit operable to search for an item corresponding to the received code on the Internet by using a search engine, and acquire address information of a site related to the item.

In the host computers according to the above fourth and fifth aspects, said processing unit acquires the address information which appears at the highest position in search ranking of the search result by the search engine.

In the host computers according to the above fourth and fifth aspects, said processing unit generates a screen including link information to the corresponding site on the basis of the acquired address information in order to send to the communication terminal.

In this host computer, the code is a code given specific to each item, and wherein the screen is a screen specific to the item corresponding to the code.

In this host computer, the link information includes link information to a home page of an advertising client of an item indicated by the code information, link information to a site in which a commercial video of the item indicated by the code information is distributed, link information to a site in which the item indicated by the code information can be purchased, link information to a site in which an image of the item indicated by the code information is displayed, link information to a site in which description is given for the item indicated by the code information, link information to a site in which user registration can be done in relation to the item indicated by the code information, link information to a site in which a questionnaire can be conducted in relation to the item indicated by the code information, link information to a site in which after-sales service is provided for the item indicated by the code information, or any arbitrary combination thereof.

Also, in this host computer, the screen includes link information to a site in which user registration can be done, link information to a site in which a questionnaire can be conducted, or any arbitrary combination thereof.

Further, in this host computer, the screen includes link information to a site of a store or a retailer, which sells an item indicated by the code information.

In the host computers according to the above fourth and fifth aspects, said processing unit sends the acquired address information to the communication terminal.

In accordance with a sixth aspect of the present invention, a host computer connectable with a plurality of local code leaders each of which is capable of reading a code and connected with a communication terminal which is provided corresponding to the each local code leader and connectable with Internet, the host computer being connectable with each of the local code leaders through the Internet and the communication terminal corresponding thereto, said host computer comprising: a receiver operable to receive a plurality of the codes transmitted from the plurality of the local code leaders; and a processing unit operable to generate address information on the Internet on the basis of a part or entirety of the received code.

In this host computer, said processing unit acquires data located at a location indicated by the generated address information, and generates a screen including information included in the data in order to send to the communication terminal.

In this host computer, the address information includes at least a part or entirety of a protocol, a domain name, and the code.

In the host computers according to the above fourth, fifth and sixth aspects, the code is a common product code. In this case, the common product code is a code which is used in a POS (Point Of Sale) system. For example, the common product code is a code according to JAN (Japanese Article Number), EAN (European Article Number), or UPC (Universal Product Code). Also, for example, the common product code is a code according to ISBN (International Standard Book Number).

In this host computer, when the code as received is an instore code, the processing unit returns a predetermined message to the communication terminal.

This host computer further comprising: a classification unit operable to classify the received code into one of a plurality of groups, wherein said processing unit performs, by a use of the received code, a process corresponding to the group to which the received code belongs, and wherein at least one of the groups is a group of the common product code.

In the host computers according to the above fourth, fifth and sixth aspects, the code is transmitted to said host computer by the communication terminal through the Internet in response to transmission of the code from said local code reader.

In the host computers according to the above fourth, fifth and sixth aspects, the processing unit performs a different process corresponding to the same code in accordance with a location where the communication terminal is installed. In this case, the installation location of the communication terminal can at least be either a personal residence or a store, wherein the processing unit receives, from the communication terminal installed in the personal residence, the information for determining that the communication terminal is installed in the personal residence, and receives, from the communication terminal installed in the store, the information for determining that the communication terminal is installed in the store.

In the host computers according to the above fourth, fifth and sixth aspects, the codes are assigned to articles which include tangible entities inclusive of goods or estate, intangible entities inclusive of service or information, commodities, and living things inclusive of human being and animals, and wherein the information includes an image, a sound, a program or data. Also, the codes include one-dimensional codes, two-dimensional codes, and/or codes which are stored in IC tags. For example, the one-dimensional codes are one-dimensional barcodes, the two-dimensional codes are QR codes, and the IC tags are RFID tags.

The host computers according to the fourth to sixth aspects have advantages similar to the above remote code reader systems according to the first to third aspects respectively.

In accordance with a seventh aspect of the present invention, a code processing method used by a host computer connectable with a plurality of local code leaders each of which is capable of reading a code and connected with a communication terminal which is provided corresponding to the each local code leader and connectable with Internet, the host computer being connectable with each of the local code leaders through the Internet and the communication terminal corresponding thereto, said method comprising the steps of: receiving a plurality of the codes transmitted from the plurality of the local code leaders; and searching for a name of a company corresponding to the received code on the Internet by using a search engine, and acquiring address information of a site related to the company.

In accordance with an eighth aspect of the present invention, a code processing method used by a host computer connectable with a plurality of local code leaders each of which is capable of reading a code and connected with a communication terminal which is provided corresponding to the each local code leader and connectable with Internet, the host computer being connectable with each of the local code leaders through the Internet and the communication terminal corresponding thereto, said method comprising: receiving a plurality of the codes transmitted from the plurality of the local code leaders; and searching for an item corresponding to the received code on the Internet by using a search engine, and acquiring address information of a site related to the item.

In accordance with a ninth aspect of the present invention, a code processing method used by a host computer connectable with a plurality of local code leaders each of which is capable of reading a code and connected with a communication terminal which is provided corresponding to the each local code leader and connectable with Internet, the host computer being connectable with each of the local code leaders through the Internet and the communication terminal corresponding thereto, said method comprising: receiving a plurality of the codes transmitted from the plurality of the local code leaders; and generating address information on the Internet on the basis of a part or entirety of the received code.

The code processing method according to the seventh to ninth aspects have advantages similar to the above remote code reader systems according to the first to third aspects respectively.

In accordance with a tenth aspect of the present invention, a code processing program is a computer program for performing the code processing method according to the above seventh aspect, the above eighth aspect, or the above ninth aspect. The advantages are similar to the above remote code reader systems according to the first to third aspects respectively.

In accordance with an eleventh aspect of the present invention, a computer readable storage medium is a storage medium storing the code processing program according to the above tenth aspect. The advantage is similar to the code processing program according to the tenth aspect.

In accordance with a twelfth aspect of the present invention, a computer readable storage medium storing a computer program that causes a communication terminal connected to a local code reader to execute: accessing a computer different from a predetermined host computer when a local code reader capable of reading a code outputs data to the communication terminal, the local code reader being connected to the predetermined host computer through the communication terminal and a network.

If the wrongful computer program is executed, the access to the proper host computer to be originally accessed is not performed. As the result, the business of the business entity providing the service based on the access to the proper host computer is thwarted (obstruction of business). Also, if the user of the communication terminal desires to access the proper host computer, the benefit of the user is also damaged. Accordingly, by obtaining a patent relating to the wrongful computer program, if the wrongful computer program is delivered, sold or the like, it is possible to exclude it by the patent. That is, it is possible to prevent the injustice when accessing the network using the code.

In this storage medium, the data that the local code reader outputs to the communication terminal includes the read code, and wherein the computer program causes the communication terminal to execute: transmitting the code to the different computer.

It is possible to exclude the wrongful computer program and obstruct the misuse of the code by obtaining a patent relating to the wrongful computer program. Incidentally, the term “misuse” means that the business entity providing the service based on the access to the proper host computer suffers a loss. Therefore, even if the user desires, it is misuse if the business entity suffers the loss.

In accordance with a thirteenth aspect of the present invention, a computer readable storage medium storing a computer program that causes a communication terminal connected to a local code reader to execute: receiving a code that the local code reader capable of reading the code outputs to the communication terminal, the local code reader being connected to a predetermined host computer through the communication terminal and a network; and performing a predetermined process by using the received code.

This storage medium has the advantage similar to the storage medium according to the above twelfth aspect.

In accordance with a fourteenth aspect of the present invention, a computer readable storage medium storing a computer program that causes a communication terminal connected to a local code reader to execute: receiving data that the local code reader capable of reading a code outputs to the communication terminal, the local code reader being connected to a predetermined host computer through the communication terminal and a network; and scrapping the received data.

This storage medium has the advantage similar to the storage medium according to the above twelfth aspect.

In the storage mediums according to the above twelfth, thirteenth and fourteenth aspects, the data that the local code reader outputs to the communication terminal includes address information of the predetermined host computer.

Also, in these storage mediums, the data that the local code reader outputs to the communication terminal includes command information, the command information instructs the communication terminal to access the predetermined host computer.

In the storage mediums according to the above twelfth, thirteenth and fourteenth aspects, the code is assigned to a thing, the thing includes tangible entities inclusive of goods or estate, intangible entities inclusive of service or information, commodities, and living things inclusive of human being and animals, and the information includes an image, a sound, a program or data.

In the storage mediums according to the above twelfth, thirteenth and fourteenth aspects, the codes includes one-dimensional codes, two-dimensional codes, and/or codes which are stored in IC tags.

In these storage mediums, the one-dimensional codes are one-dimensional barcodes, the two-dimensional codes are QR codes, and the IC tags are RFID tags.

In accordance with a fifteenth aspect of the present invention, a method of preventing a dishonest act, comprising the step of converting, on a network, a transmission request of address information of a predetermined host computer into a transmission request of address information of a computer different from the predetermined host computer when a communication terminal connected to the network sends the transmission request of the address information of the predetermined host computer to the network in response to transmission of a code from a local code reader capable of reading the code.

If the step is executed, the access to the proper host computer to be originally accessed is not performed. As the result, the business of the business entity providing the service based on the access to the proper host computer is thwarted (obstruction of business). Also, if the user of the communication terminal desires to access the proper host computer, the benefit of the user is also damaged. Accordingly, by obtaining a patent relating to the method, if the method is performed on the network, it is possible to exclude it by the patent. That is, it is possible to prevent the injustice when accessing the network using the code.

In accordance with a sixteenth aspect of the present invention, a computer program enables a computer to perform the method of preventing a dishonest act according to the fifteenth aspect.

This computer program has the advantage similar to the method of preventing a dishonest act according to the fifteenth aspect.

In accordance with a seventeenth aspect of the present invention, the storage medium stores the above computer program according to the sixteenth aspect.

This storage medium has the advantage similar to the method of preventing a dishonest act according to the fifteenth aspect.

In accordance with a eighteenth aspect of the present invention, a method of preventing a dishonest act, comprising the step of sending address information of a computer different from a predetermined host computer to the communication terminal by replacing, on a network, address information of the predetermined host computer to be sent to the communication terminal with the address information of the different computer when the communication terminal connected to the network sends a transmission request of the address information of the predetermined host computer to the network in response to transmission of a code from a local code reader capable of reading the code.

This method of preventing a dishonest act has the advantage similar to the method of preventing a dishonest act according to the fifteenth aspect.

In accordance with a nineteenth aspect of the present invention, a computer program enables a computer to perform the method of preventing a dishonest act according to the eighteenth aspect.

This computer program has the advantage similar to the method of preventing a dishonest act according to the eighteenth aspect.

In accordance with a twentieth aspect of the present invention, the storage medium stores the computer program according to the nineteenth aspect.

This storage medium has the advantage similar to the method of preventing a dishonest act according to the eighteenth aspect.

In accordance with a twenty-first aspect of the present invention, a remote code reader system comprising: a barcode creating unit operable to create a barcode by aligning a plurality of pieces, a barcode character being indicated on the piece; a plurality of local code leaders each of which is capable of reading the barcode and connected with a communication terminal corresponding thereto, the communication terminal being connectable with a network; and a host computer operable to receive the barcode transmitted from the local code leader through the communication terminal, wherein said host computer includes a processing unit configured to perform a process corresponding to the received barcode.

In accordance with this configuration, the user can make the host computer perform the various processes by reading the barcode that is dynamically created by the barcode creating unit, by means of the local barcode reader.

In this remote code reader system, the plurality of the pieces of said barcode creating unit is a plurality of rotating bodies that aligns by commonly using a rotation axis, the plurality of the rotating bodies has a plurality of blocks respectively, and the different barcode character is indicated on for each of the blocks.

In accordance with this configuration, the user can dynamically creates the barcode by rotating the rotating bodies of the barcode creating unit and thereby changing the combination of the barcode characters, and therefore make the host computer perform the various processes.

Or, the above remote code reader system, the plurality of the pieces of said barcode creating unit has a planate configuration, the barcode characters are indicated on predetermined areas of the respective pieces, and the barcode is created by aligning the arbitrary number of the arbitrary pieces in arbitrary order.

In accordance with this configuration, the user can dynamically creates the barcode by changing the number and/or the order of the pieces and thereby changing the combination of the barcode characters, and therefore make the host computer perform the various processes.

In the above remote code reader system, a letter, a numeral, and/or a drawing are/is indicated on the piece corresponding to the barcode character.

In accordance with this configuration, since the letter, numeral, and/or drawing is/are indicated corresponding to the barcode character, the user can recognize the content of the barcode created by the barcode creating unit. And, the user scans, by the local barcode reader, the barcode created by arranging the desired letter and so on in the barcode creating unit, and thereby the user can make the host computer perform the processing related to the desired letter and so on.

In the above remote code reader system, the barcode character indicated on the piece designates a predetermined character code.

In accordance with this configuration, since the character code is output when the local barcode reader scans the barcode, if the host computer has the table for converting the character code into the letter, it is possible to input the letter by the barcode to the host computer. In this case, a character code according to a unified standard, such as JIS, may be employed, or a standard that a business entity operating the remote barcode reader system independently defines may be employed.

In the above remote code reader system, said barcode creating unit creates the barcode by aligning a start piece followed by the pieces, a predetermined barcode character is indicated on the start piece.

In accordance with this configuration, since the barcode created by the barcode creating unit includes the predetermined barcode character at the head thereof certainly, the host computer can easily distinguish between the barcode created by the barcode creating unit according to the present invention and other kinds of barcodes.

In accordance with a twenty-second aspect of the present invention, a barcode creating apparatus comprising: a plurality of planate pieces, barcode characters being indicated on predetermined area of the respective pieces; and an aligning unit configured to align the plurality of the pieces tightly, wherein the complete barcode is formed by the barcode characters when said aligning unit aligns the plurality of the pieces.

In accordance with this configuration, it is possible to dynamically create the various barcodes by aligning the plurality of the pieces in arbitrary order in the aligning unit.

In this barcode creating apparatus, a letter, a numeral, and/or a drawing are/is indicated on the piece in addition to the barcode character.

In accordance with this configuration, since the letter, numeral, and/or drawing is/are indicated corresponding to the barcode character, the user can recognize the content of the barcode created by the barcode creating unit. And, the user scans, by the local barcode reader, the barcode created by arranging the desired letter and so on in the barcode creating unit, and thereby the user can make the host computer perform the processing related to the desired letter and so on.

In this barcode creating apparatus, the barcode character indicated on the piece designates a predetermined character code.

In accordance with this configuration, since the character code is output when the barcode reader scans the barcode, it is possible to input the letter by the barcode to the information processing apparatus (e.g., a host computer, a terminal, or the like) that has the table for converting the character code into the letter. In this case, a character code according to a unified standard, such as JIS, may be employed, or a standard that a business entity operating the remote barcode reader system independently defines may be employed.

In this barcode creating apparatus, said barcode creating unit creates the barcode by aligning a start piece followed by the pieces, a predetermined barcode character is indicated on the start piece.

In accordance with this configuration, since the barcode created by the barcode creating unit includes the predetermined barcode character at the head thereof certainly, the information processing apparatus (e.g., a host computer, a terminal, or the like) for processing the barcode can easily distinguish between the barcode created by the barcode creating apparatus and other barcodes.

In the present specification, the recording mediums include, for example, a flexible disk, a hard disk, a magnetic tape, a magneto-optical disk, a CD (including CD-ROM, Video-CD), a DVD (including DVD-Video, DVD-ROM, DVD-RAM), a ROM cartridge, a RAM memory cartridge with a battery backup unit, a flash memory cartridge, a nonvolatile RAM cartridge, a semiconductor memory, and so on.

### BRIEF DESCRIPTION OF DRAWINGS

The novel features of the present invention are set forth in the appended any one of claims. The invention itself, however, as well as other features and advantages thereof, will be best understood by reference to the detailed description of specific embodiments which follows, when read in conjunction with the accompanying drawings, wherein:

FIG. 1 is a view showing the overall configuration of a remote barcode reader system in accordance with an embodiment of the present invention.

FIG. 2(a) is a schematic diagram for showing the electric configuration of a local barcode reader 7 shown in FIG. 1. FIG. 2(b) is an explanatory schematic diagram for showing programs and data segments stored in a ROM 19 embedded in an MCU 15 shown in FIG. 2(a).

FIG. 3 is a schematic diagram for showing one example of the communication procedure among the local barcode reader 7, a communication terminal 5 and a host computer 1 as illustrated in FIG. 1.

FIG. 4 is a schematic diagram for showing the overall configuration of an advertisement support system to which the remote barcode reader system shown in FIG. 1 is applied.

FIG. 5(a) is a schematic diagram for showing the general outline of the advertisement support system. FIG. 5(b) is a view for showing a first individual portal screen 100 which is a first example of an individual portal screen provided for a certain commodity.

FIG. 6(a) is a schematic diagram for showing the electric configuration of a center server 31 shown in FIG. 4. FIG. 6(b) is a schematic representation showing programs and data segments stored in a storage area 200 of the center server 31 shown in FIG. 6(a). FIG. 6(c) is a schematic diagram for showing the configuration of a first individual portal screen file 230 shown in FIG. 6(b).

FIG. 7 is a flow chart showing an example of the communication procedure in accordance with the advertisement support system shown in FIG. 4.

FIG. 8 is a schematic diagram for showing one example of the communication procedure between an e-commerce server and a PC 43 after it is determined in step S208 of FIG. 7 that this server is addressed by the URL.

FIG. 9 is a view for showing an example of a first individual portal screen 130 of an application example 1.

FIG. 10 is a view for showing an example of an individual portal screen table which is referred to when generating the first individual portal screen 130 shown in FIG. 9.

FIG. 11(a) is a view for showing an example of a second individual portal screen 101 of an application example 2. FIG. 11(b) is a schematic representation of a program storing section 199 of the application example 2. FIG. 11(c) is a schematic representation of a second individual portal screen file 222 of the application example 2. FIG. 11(d) is a schematic diagram for showing the configuration of the second individual portal screen file 222 of the application example 2.

FIG. 12 is a flow chart for showing the process of generating an individual portal screen of the application example 2.

FIG. 13 is a flowchart for showing an example of the communication procedure among a server 47 of an advertising client 45-M, a computer 37 of a store 35-K, and the center server 31 in the case of the application example 2.

FIG. 14 is a flowchart for showing an example of the communication procedure between a server 77 of a store central office 75-P and the computer 37 after it is determined in step S608 of FIG. 13 that the server 77 is addressed by the URL.

FIG. 15 is an explanatory view for showing an application example 3.

FIG. 16 is an explanatory view for showing a program storing section 172 of the application example 3.

FIG. 17 is a flow chart for showing the process of generating a screen in the application example 3.

FIG. 18 is a perspective external view for showing a camera unit 180 of an application example 4.

FIG. 19 is a schematic diagram for showing the electric configuration of the camera unit 180 as shown in FIG. 18.

FIG. 20 is a flow chart for showing an example of the process of scanning a barcode by an MCU 192.

FIG. 21 is a flow chart for showing an example of processing mouse operation by the MCU 192.

FIG. 22 is an explanatory view for showing an application example 5.

FIG. 23 is a view for showing an example of a book 160 with barcodes in accordance with the application example 5.

FIG. 24 is a view for showing an example of a controlling file which the center server 31 sends to the terminal 5 corresponding to the barcode 11.

FIG. 25 is a view for showing an example of a screen displayed by a terrestrial globe application 86 installed in the PC 43 of the application example 5.

FIG. 26 is a flowchart for showing an example of the communication procedure among a contents server 72, the PC 43, and the center server 31 in the application example 5.

FIG. 27 is a view for showing an example of a converting table of the application example 5.

FIG. 28 is a flowchart for showing an example of the communication procedure between a terrestrial globe server 80 and the PC 43 in the application example 5.

FIG. 29 is an explanatory view for showing an application example 6.

FIG. 30 is a view for showing an example of a converting table of the application example 6.

FIG. 31 is an explanatory view for showing state transition of a contents server 74 of the application example 6.

FIG. 32 is a flow chart for showing a classifying process of the center server 31 in the application example 6.

FIG. 33 is a flow chart for showing a first example of processing of the contents server 74 in the application example 6.

FIG. 34 is a flow chart for showing a second example of the processing of the contents server 74 in the application example 6.

FIG. 35 is an explanatory view for showing an application example 7.

FIG. 36 is a flow chart for showing a classifying process of the center server 31 in the application example 7.

FIG. 37 is a flow chart for showing processing of the contents server 74 in the application example 7.

FIG. 38 is a flow chart for showing another example of the processing of the contents server 74 in the application example 7.

FIG. 39 is a perspective external view for showing a PC 361 and a BC mouse 363 of an application example 8.

FIG. 40 is a functional block diagram of the BC mouse 363 of FIG. 39.

FIG. 41 is an explanatory view for showing a method for reading a barcode by the BC mouse 363 of FIG. 39.

FIG. 42 is a view for showing examples of the barcode 11, pixel data P(t) at a predetermined location (n, m) in a frame image 311, and binary data B (t) thereof.

FIG. 43 is a flow chart for showing processing of a barcode decoder 314 of FIG. 40.

FIG. 44 is a schematic representation of a business model realized by a barcode service providing system of an application example 9.

FIG. 45 is an explanatory view for showing barcode assignment.

FIG. 46 is a schematic diagram for showing the communication procedure between a receiver group 417-n and a server 413 of a barcode service provider 405.

FIG. 47 is a flow chart for showing processing of issuing the barcodes by a barcode issuing system 407 of FIG. 44.

FIG. 48 is a schematic diagram for showing a URL retrieval file 421 stored in a data base 409 of FIG. 44.

FIG. 49 is an explanatory view for showing a modification of the barcode issuing system 407 of FIG. 44.

FIG. 50 is an explanatory view for showing an application example 10.

FIG. 51 is a flow chart for showing a process of generating an individual portal screen of the application example 10.

FIG. 52 is an explanatory view for showing an application example 11.

FIG. 53 is a flow chart for showing processing of giving barcodes in the application example 11.

FIG. 54 is an explanatory view for showing an application example 12.

FIG. 55 is a flow chart for showing processing by a wrongful program 81 in the application example 12.

FIG. 56 is an explanatory view for showing a modification of the application example 12.

FIG. 57(a) is a schematic diagram for showing an example of a barcode creating apparatus according to an application example 13. FIG. 57(b) is an explanatory view for showing how to use the barcode creating apparatus of FIG. 57(a).

FIG. 58(a) is a schematic diagram for showing another example of the barcode creating apparatus according to the application example 13. FIG. 58(b) is an explanatory view for showing how to use the barcode creating apparatus of FIG. 58(a). FIG. 58(c) is an explanatory view for showing a configuration of a case of FIG. 58(a).

FIG. 59 is a flow chart for showing a process of the local barcode reader 7 in decoding the barcode 11 in the application example 13.

FIG. 60 is a view for showing an example of a converting table in which the barcode 11 is associated with address information designating a storage location of a corresponding content, in the host computer 1 of the application example 13.

FIG. 61 is a view for showing an example of a converting table for converting a letter code 474 to a letter in a first modification of the application example 13.

FIG. 62 is a flow chart for showing a process that the host computer 1 performs by using the received barcode in a second modification of the application example 13.

### EXPLANATION OF REFERENCES

1 . . . host computer, 3 . . . . Internet, 5 . . . terminal, 5f . . . stationary terminal, 5m . . . mobile terminal, 7 . . . local barcode reader, 9 . . . user network, 11 . . . barcode, 13 . . . scanner, 15 . . . MCU, 17 . . . communication device, 19 . . . ROM, 21 . . . decoding program, 23 . . . keyboard emulation program, 25 . . . output control program, 27 . . . URL, 29 . . . command, 31 . . . center server, 33 . . . network, 35-1 to 35-k . . . stores, 41-1 to 41-n . . . personal residences, 45-1 to 45-m . . . advertising clients, 75-1 to 75-p . . . store central offices, 100 and 130 . . . first individual portal screen, 101 . . . second individual portal screen, 180 . . . camera unit, 251 . . . first group (JAN), 252 . . . second group (except JAN), 72 and 74 . . . contents server, 80 . . . terrestrial globe server, 82 . . . browser, 83 . . . web site, 84 . . . OS, 86 . . . terrestrial globe application, 160 . . . book with barcodes, 70 and 162 . . . photograph, 78 . . . hit icon, 94 . . . message, 361 . . . PC, 363 . . . BC mouse, 307 . . . mouse function unit, 308 . . . light emitting unit, 310 . . . imaging unit, 314 . . . barcode decoder, 315 . . . scanning switch, 18 . . . transmitter, 403 . . . applying and issuing path, 400 . . . user, 419 . . . PC, 415 . . . delivering path, 417-0 to 417-N . . . receiver group, 431 . . . barcode, 433 . . . barcode reader, 435 . . . PC, 137 . . . network, 96 . . . barcode database, 98 . . . search engine, 91 . . . book database, 93 . . . publisher database, 450 and 451 . . . digital camera, 452 . . . printer, 454 . . . photograph, 456 . . . GPS unit, 69 . . . wrongful server, 81 . . . wrongful program, 458, 462 . . . barcode creating apparatus, 460A to 460D . . . rotating drum, 466 . . . start card, and 468 . . . letter card.

### BEST MODE FOR CARRYING OUT THE INVENTION

In what follows, several embodiments of the present invention will be explained in detail with reference to the accompanying drawings. Meanwhile, like references indicate the same or functionally similar elements throughout the respective drawings, and therefore redundant explanation is not repeated.

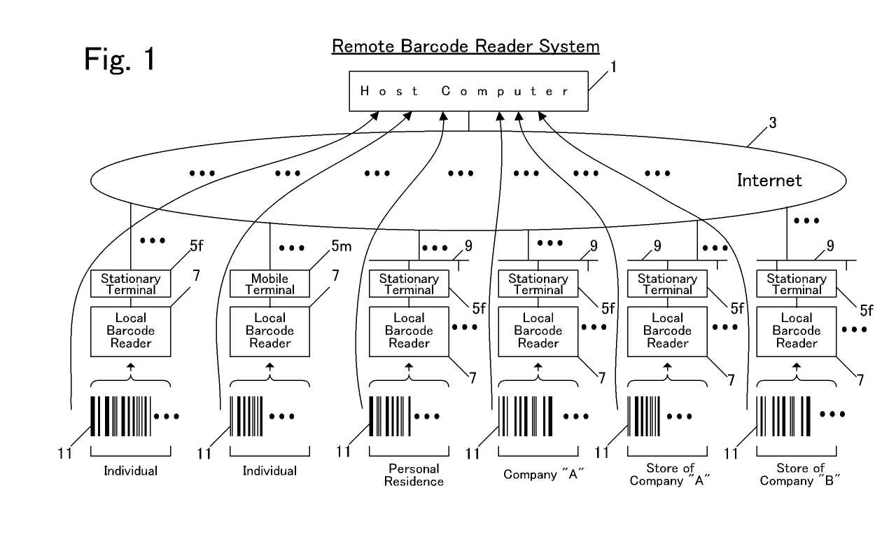

FIG. 1 is a view showing the overall configuration of a remote barcode reader system in accordance with an embodiment of the present invention. Referring to FIG. 1, the remote barcode reader system includes a host computer 1, and a plurality of arbitrary local barcode readers 7 capable of reading arbitrary barcodes 11. The local barcode reader 7 may be for example a pen scanner, a CCD touch scanner, a handheld laser scanner, a desktop laser scanner, a slot reader, or any other type of barcode reader.

In the context of this document, the term “barcode” is intended to generally represent the information contained in a barcode or the pattern of a barcode, so that when there is no need to distinguish the barcode information and the barcode pattern, the term “barcode” is simply used. From a different view point, the barcode is a code which is assigned to an article (tangible entity such as goods or estate, intangible entity such as service or information (image, sound, program, data or the like), commodity, or, human being, animal or another living being), or any other thing which can be identified by some means.

The barcode information represents a string of characters such as numerals, letters, symbols and the like. The barcode pattern is a pattern of black bars and white spacings which are combined in order to encode the barcode information. Incidentally, the barcode and the barcode pattern are given the same reference numeral “11”.

The host computer 1 and each of the local barcode readers 7 are connected with each other through the Internet 3, and a stationary terminal 5f or a mobile terminal 5m. The stationary terminal 5f may be any type of fixed line terminal such as a desktop computer provided with communication functionality. The mobile terminal 5m may be any type of portable computer such as a notebook computer provided with communication functionality, or any type of wireless communication terminal such a cellular phone, or a PDA (Personal Digital Assistant). Incidentally, when there is no need to distinguish the stationary terminal 5f and the mobile terminal 5m, the term “terminal 5” is simply used.

The illustrated example will be explained. The local barcode reader 7 used by a certain individual is connected to the Internet 3 through the stationary terminal 5f and an access network which is not shown in the figure, and connected to the host computer 1 through an access network which is not shown in the figure. The local barcode reader 7 used by another individual is connected to the Internet 3 through the mobile terminal 5m and an access network which is not shown in the figure, and connected to the host computer 1 through the access network. The local barcode reader 7 used in the house of an individual is connected to the Internet 3 through the stationary terminal 5f, a user network 9 such as a LAN and an access network which is not shown in the figure, and connected to the host computer 1 through the access network.

The local barcode reader 7 used in a company “A” (company having a chain of convenience stores) is connected to the Internet 3 through the stationary terminal 5f, a user network 9 such as a LAN and an access network which is not shown in the figure, and connected to the host computer 1 through the access network. The local barcode reader 7 used in a store (for example, a convenience store) operated by the company “A” is connected to the Internet 3 through the stationary terminal 5f, a user network 9 such as a LAN and an access network which is not shown in the figure, and connected to the host computer 1 through the access network.

The local barcode reader 7 used in a store operated by a company “B” which is a different company than the company “A”, for example, a rival company is connected to the Internet 3 through the stationary terminal 5f, a user network 9 such as a LAN and an access network which is not shown in the figure, and connected to the host computer 1 through the access network.

In this case, the local barcode readers 7 and the stationary terminals 5f used in the stores of the companies “A” and “B” are not POS terminals. However, they can be POS terminals.

While the example shown in the figure is illustrative only, a number of various and arbitrary local barcode readers 7 are connected with the host computer 1 through various networks inclusive of the Internet 3, regardless of the individuals and enterprises. Accordingly, the host computer 1 can globally collect a number of various and arbitrary barcodes. The barcodes 11 are classified into a plurality of groups. The host computer 1 performs a process in accordance with the group to which the barcode 11 belongs, and provides a service to the user by performing this process. In this case, the host computer 1 can provide a service (including content) through the terminal 5 and the Internet 3. However, in response to the processing result of the host computer 1, it is possible to provide a service through not only the Internet 3 but also WAN (Wide Area Network), LAN (Local Area Network) or any other network, or a combination thereof. The barcodes 11 can be collected in the same manner. Incidentally, WAN includes a public switched telephone network, an exclusive line network, a power line communication network, a CATV network and so forth. Alternatively, in response to the processing result of the host computer 1, it is also possible to provide a service through another route (broadcast, postal mail, another communication tool, door-to-door parcel delivery service, and so forth) without using a network. In other words, while the network has to be used for collecting the barcodes 11, any other appropriate means can be used for providing a service to the user.

Next, the above groups into which the barcodes 11 are classified will be described by way of example. The first example is a group of barcodes which are printed on paper mediums such as magazines. The host computer 1 receives a barcode belonging to this group, gives the terminal 5 the URL of a website in which is placed the information about the paper medium printed with the barcode, or content described in the paper medium (for example, advertisement). The information is then displayed on the terminal 5. The second example is a group of barcodes which are assigned to companies respectively in a printed material such as Kaisha Shikiho describing stock price information. The host computer 1 receives a barcode belonging to this group, gives the terminal 5 the URL of a website in which is placed the stock price information about the company corresponding to this barcode. The information is then displayed on the terminal 5.

The third example is a group of barcodes which are assigned to companies respectively in a printed material describing job information. The host computer 1 receives a barcode belonging to this group, gives the terminal 5 the URL of a website in which is placed the job information about the company corresponding to this barcode. The information is then displayed on the terminal 5. The fourth example is a group of barcodes which are assigned to landscapes respectively in a printed material showing landscape photographs. The host computer 1 receives a barcode belonging to this group, gives the terminal 5 the URL of a website in which is placed the detailed information about the landscape corresponding to this barcode. The information is then displayed on the terminal 5.

The fifth example is a group of barcodes which are assigned to articles respectively in a newspaper. The host computer 1 receives a barcode belonging to this group, gives the terminal 5 the URL of a website in which is placed the detailed information about the article corresponding to this barcode. The information is then displayed on the terminal 5. The sixth example is a group of barcodes which are assigned to name cards respectively. The host computer 1 receives a barcode belonging to this group, gives the terminal 5 the URL of a website in which is placed the detailed information about the holder of the name card corresponding to this barcode. The information is then displayed on the terminal 5.

The seventh example is a group of barcodes which are assigned to chapters of a book respectively. The host computer 1 receives a barcode belonging to this group, gives the terminal 5 the URL of a website in which is placed the detailed information about the chapter corresponding to this barcode. The information is then displayed on the terminal 5. The eighth example is a group of barcodes which are assigned to the titles of music CDs or cinema DVDs respectively. The host computer 1 receives a barcode belonging to this group, gives the terminal 5 the URL of a website which enables listening/watching the music or movie corresponding to this barcode. The title is played on the terminal 5.

The ninth example is a group of barcodes which are assigned to pictures of trading cards respectively. The host computer 1 receives a barcode belonging to this group, gives the terminal 5 the URL, of a website in which is placed the information about the picture corresponding to this barcode. The information is then displayed on the terminal 5. The tenth example is a group of barcodes which are printed on purchase receipts issued after shopping respectively. The host computer 1 receives a barcode belonging to this group, gives the terminal 5 the URL of a website in which is placed the information about the store issued the purchase receipt corresponding to this barcode (for example, information for sale). The information is then displayed on the terminal 5.

The eleventh example is a group of barcodes corresponding to standard commodity codes. The host computer 1 receives a barcode belonging to this group, gives the terminal 5 the URL of a website in which is placed the information about the good corresponding to this barcode. The information is then displayed on the terminal 5. The standard commodity codes are codes used by a POS (Point Of Sale) system, and include codes according to JAN (Japanese Article Number), EAN (European Article Number), and UPC (Universal Product Code) and so forth.

As has been discussed above, in accordance with the present system, while the barcode 11 is classified into one of the plurality of groups, the host computer 1 performs the process corresponding to the group to which the received barcode 11 belongs, and provides the terminal 5 with the content which is given according to this group and corresponding to the received barcode 11. Incidentally, the aforementioned groups are illustrative only, but needless to say the present invention is not limited thereto.

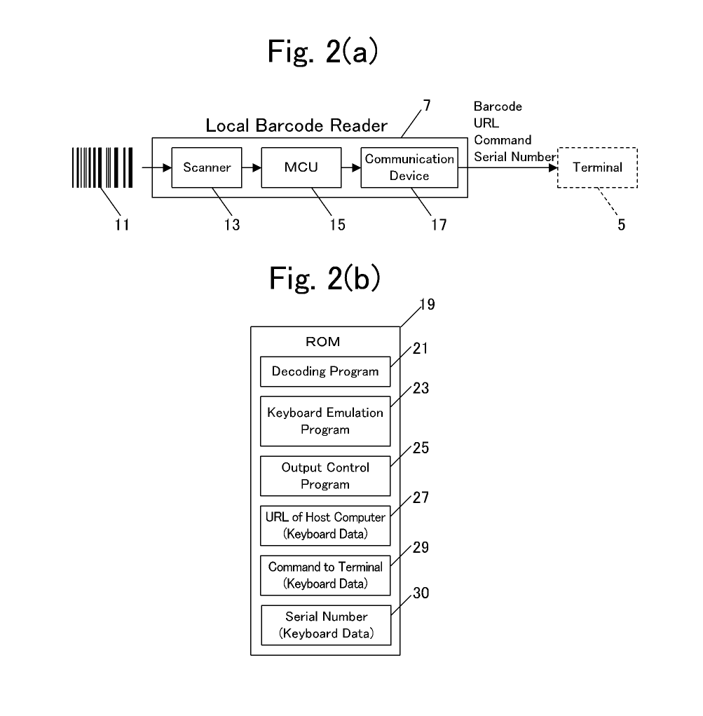

FIG. 2(a) is a schematic diagram for showing the electric configuration of the local barcode reader 7 shown in FIG. 1. FIG. 2(b) is an explanatory schematic diagram for showing programs and data segments stored in a ROM 19 embedded in an MCU (Microcontroller Unit) 15 shown in FIG. 2(a). Referring to FIG. 2(a), the local barcode reader 7 includes a scanner 13, the MCU 15 and a communication device 17. The scanner 13 optically reads a barcode pattern 11, and converts (scans) bars and spacings into an electrical signal. In this case, the scanning process can be arbitrarily performed as described above. The electrical signal corresponding to the barcode pattern 11 is given to the MCU 15 from the scanner 13.

The MCU 15 includes, as built-in elements, a CPU (not shown in the figure), a RAM (not shown in the figure), an A/D converter, the ROM 19 shown in FIG. 2(b) and so forth. The ROM 19 is used to store a decoding program 21, a keyboard emulation program 23, an output control program 25, a URL (Uniform Resource Locator) 27 of the host computer 1 provided in terms of keyboard data, a command 29 provided in terms of keyboard data to be issued to the terminal 5, a serial number 30 provided in terms of keyboard data, and any other necessary programs and data.

The command 29 is a command which is used to instruct the terminal 5 to run a browser and access the host computer 1 by the use of the URL 27. For example, in the case where the OS (Operating System) is Windows (registered trademark), the command is provided as the keyboard data corresponding to a GUI (Graphical User Interface) key+“R” key of a keyboard if the OS is Windows 98 or latter version. Windows launches a browser (Internet Explorer) in response to this command. In other words, this command is included as a default command of Windows which is an OS. Meanwhile, the GUI key of Windows is generally referred to as Windows key. Since the local barcode reader 7 stores and outputs the command of an OS such as Windows which is taking a significant market share, it is possible to make use of most terminals as the terminal 5 by an easy procedure, i.e., only by connecting the local barcode reader 7 to the terminal 5. Because of this, the local barcode reader 7 need not store a plurality of commands in advance, and recognize the OS used by each terminal 5, select and use one of the commands depending on the OS, and so forth.

The serial number 30 is a unique number that is assigned to identify the local barcode reader 7.

The MCU 15 runs the decoding program 21, decodes the electrical signal corresponding to the barcode pattern 11 which is input, and acquires the barcode information. Then, the MCU 15 runs the keyboard emulation program 23, converts the barcode information into keyboard data, and stores the keyboard data in the RAM. The MCU 15 runs the output control program 25, acquires the command 29, the URL 27 and the serial number 30 from the ROM 19, acquires the barcode information from the RAM, and transfers the keyboard data thereof to the communication device 17.

The communication device 17 is, for example, a USB controller or the like, and transmits the keyboard data (the command 29, the URL 27, the barcode information and the serial number 30) which is received from the MCU 15, to the terminal 5. Then, in response to the received command 29, the terminal 5 transmits the barcode information and the serial number 30 to the host computer 1 with reference to the received URL 27 through the Internet 3. Incidentally, while the personal information of the user can optionally be registered from the terminal 5, it requires careful handling. In connection with the serial number 30 which is acquired by the host computer 1, the personal information has to be handled particularly in a careful way.

Meanwhile, it is possible to make changeable the URL and the programs by the use of an EEPROM, a flash memory or the like, provided outside the MCU 15. In addition, while the MCU 15 and the communication device 17 are illustrated as separate units in the figure, they can be incorporated in a single unit.

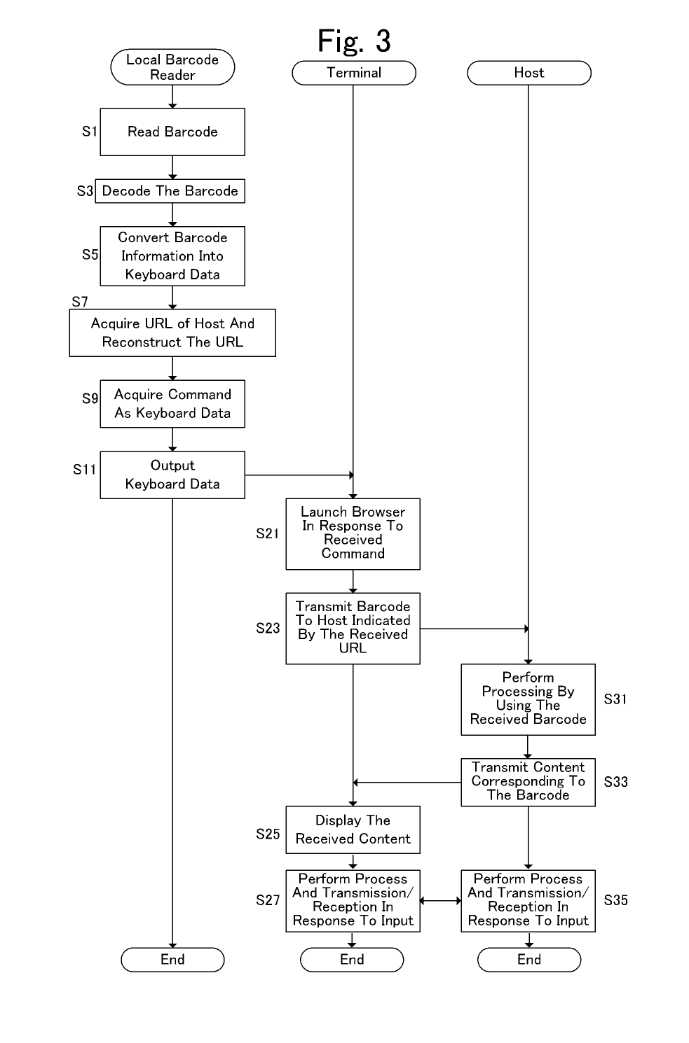

Referring to FIG. 3, in step S1, the local barcode reader 7 reads the barcode pattern 11 in response to the operation of the user. In step S3, the local barcode reader 7 decodes the barcode pattern 11 on the basis of a known barcode decoding technique.

In step S5, the local barcode reader 7 converts the barcode information which is the result of decoding into keyboard data, and stores the keyboard data in the RAM. Then, in step S7, the local barcode reader 7 acquires the URL 27 of the host computer 1 (for example, “http://www.ssd.co.jp”) from the ROM 19 as keyboard data, appends the barcode information (for example, “4560256580016”) and the serial number 30 (for example, “13222159”) as keyboard data to the end of the URL 27, and stores it in the RAM as a new URL (for example, “http://www.ssd.co.jp/?bc=4560256580016&sn=13222159”).

In step S9, the local barcode reader 7 acquires the command 29 from the ROM 19 in the form of keyboard data which instructs the terminal 5 to launch the browser and access the host computer 1, and stores the command 29 in the RAM. In step S11, the local barcode reader 7 outputs the keyboard data (the command 29 and URL (URL 27+barcode information+serial number 30) to the terminal 5.

The terminal 5 receives the keyboard data which is output from the local barcode reader 7. Then, the terminal 5 launches the browser in response to the command 29 received from the local barcode reader 7 in step S21, and accesses the host computer 1 with reference to the URL received from the local barcode reader 7 in step S23. At this time, the URL is transmitted to the host computer 1.

The host computer 1 then receives the URL (including the barcode information and the serial number 30). And, in step S31, the host computer 1 performs the process corresponding to the group to which the received barcode 11 belongs, and generates the content which is provided corresponding to this group and corresponding to the barcode information. In step S33, the host computer 1 transmits the content corresponding to the barcode information (for example, which is described in HTML) as a result of the process in step S31, to the terminal 5.

In step S25, the terminal 5 displays the content, which is transmitted from the host computer 1, in a display (for example, by parsing the received HTML information and displaying a web page). In step S27, the terminal 5 performs processing and communication with the host computer 1 in response to the input operation by the user. Likewise, in step S35, the host computer 1 performs processing and communication with the terminal 5 in response to the access from the terminal 5. Meanwhile, the content transmitted from the host computer 1 to the terminal 5, i.e., the content which is provided for the user is an example of a service which is provided for the user. An example of a service which is provided for the user will be explained below as an application example of the present system.

Next is a supplementary explanation of step S23. More specifically, in step S23, the terminal 5 accesses a DNS (Domain Name System) server, acquires an IP address corresponding to a domain name (“www.ssd.co.jp” in the aforementioned example), transmits the aforementioned URL including the barcode information and the serial number 30 to the network including the Internet 3 together with the IP address, and transmits the barcode information and the serial number 30 to the host computer 1 by accessing the host computer 1. However, detailed description of the above processing is dispensed with because these steps are performed by well-known protocols.

As has been discussed above, in the case of the present embodiment, a number of various and arbitrary local barcode readers 7 are connected with the host computer 1 through various networks inclusive of the Internet 3 and a number of arbitrary terminals 5 which are connected to these networks. In other words, a number of various and arbitrary local barcode readers 7 are connected with the host computer 1, regardless of the individuals and enterprises. Accordingly, the host computer 1 can globally collect a number of various and arbitrary barcodes 11. The host computer 1 performs a process in accordance with the group to which the barcode 11 belongs, and transmits to the terminal 5 the content which is provided corresponding to this group and corresponding to the barcode 11. Thereby, the terminal 5 can display a variety of contents in accordance with the barcodes 11. In other words, in response to sending the barcode 11 to the host computer 1, the user of the local barcode reader 7 can receive a variety of services which are provided by the host computer 1 in correspondence with the barcode 11. In this case, as long as the user possesses at least one local barcode reader 7, he/she can receive a variety of different services. For example, the user can receive any service of the first to eleventh examples as described above only by the use of a single local barcode reader 7. In addition to this, only by scanning a barcode 11, the user of the local barcode reader 7 can readily receive the service and content provided corresponding to this barcode 11 with no need to search websites for receiving the desired service and content.

Furthermore, in the case of the present embodiment, the local barcode reader 7 outputs the URL 27 of the host computer 1 and the command 29 to the terminal 5 together with the barcode 11. In response to this, the terminal 5 transmits the barcode 11 to the host computer 1. Namely, the transmission of the barcode 11 can be triggered by scanning the barcode 11. Because of this, the user of the local barcode reader 7 can transmit the barcode 11 to the host computer 1 only by reading the barcode 11 through the local barcode reader 7 without need for any particular operation of the terminal 5. In addition, the user need neither install software in the terminal 5 nor input the URL 27 of the host computer 1 for transmitting the barcode 11 to the host computer 1. As a result, it is possible to improve the convenience of the user.

Furthermore, since the serial number 30 of the local barcode reader 7 is transmitted to the host computer 1, the user can receive content provided for him/her irrespective of the terminal 5 to which his/her own local barcode reader 7 is connected. In other words, as long as the user uses his/her own local barcode reader 7, the user can receive content provided for him/her through the arbitrary terminal 5. Needless to say, in this case, the host computer 1 performs a process associated with the serial number 30 of the local barcode reader 7, and transmits content corresponding to the serial number 30, to the terminal 5. Meanwhile, the transmission of the serial number 30 from the local barcode reader 7 or the terminal 5 is optionally performed, but can be dispensed with.

Incidentally, while the host computer 1 serves as a Web server in the above example, the present invention is not limited thereto. However, of course, the present invention can also be applied in a different way in which the protocol supported by the host computer 1 serving as another type of server is used with a different URL. The host computer 1 may further be provided with a plurality types of server functions.

Next, several practical applications of the remote barcode reader system shown in FIG. 1 will be explained.

### Application Example 1

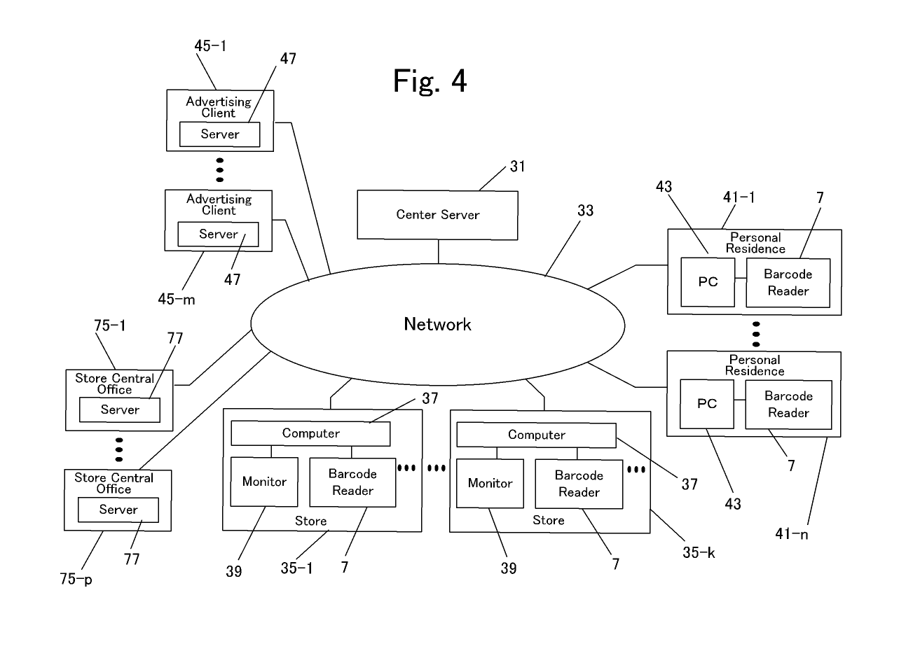

FIG. 4 is a schematic diagram for showing the overall configuration of an advertisement support system to which the remote barcode reader system shown in FIG. 1 is applied. Referring to FIG. 4, this advertisement support system includes a center server 31 which is connected to a network 33. The network 33 includes various networks such as the Internet, LAN (Local Area Network) and so forth.

Each of personal residences 41-1 to 41-n (“n” is one or a lager integer) is provided with a personal computer (hereinafter referred to as “PC”) 43 to which is connected a barcode reader 7 for reading the barcode attached to a commodity product. Also, the PC 43 is connected to the network 33.

Each of stores 35-1 to 35-k (“k” is one or a lager integer) is provided with a computer 37 to which are connected a monitor 39 and a barcode reader 7 for reading the barcode attached to a commodity product. Particularly, a plurality of sets of these peripherals are provided in each of the stores 35-1 to 35-k which are connected to the network 33 through the computers 37 thereof respectively.

Each of store central offices 75-1 to 75-p (“p” is one or a lager integer) is provided with a server 77 and connected the network 33.

Each of advertising clients 45-1 to 45-m (“m” is one or a lager integer) of the various commodities is provided with a server 47 and connected the network 33.

In this case, the personal residences 41-1 to 41-n are collectively referred to as the “personal residence 41-N”, the stores 35-1 to 35-k are collectively referred to as the “store 35-K”, the advertising clients 45-1 to 45-m are collectively referred to as the “advertising clients 45-M”, and the store central offices 75-1 to 75-p are collectively referred to as “the store central office 75-P”.

Known types of various servers can be used to provide the center server 31, the server 47 of the advertising client 45-M, and the server 77 of the store central office 75-P. However, these servers are implemented by Web servers as examples in the case of the present embodiment. Also, the advertising client 45-M is a business entity which is generally located in the upstream side of the commodity product flow, such as a manufacturer of commodity, a vendor of commodity products or the like. The store central office 75-P is a business entity which is generally located in the downstream side of the commodity product flow, such as a retailer or the like. The store 35-K is a store which is under the control of the store central office 75-P. The personal residence 41-N is the house of an end user.

In this example, the center server 31 corresponds to the host computer 1 shown in FIG. 1. The PC 43, and the computer 37 and the monitor 39 correspond to the stationary terminals 5f shown in FIG. 1 respectively. The barcode reader 7 corresponds to the local barcode reader 7 shown in FIG. 1.

Next, the general outline of the advertisement support system shown in FIG. 4 will be explained. In this case, the communication among the center server 31, the personal residence 41-N and the advertising client 45-M will be explained as an example.

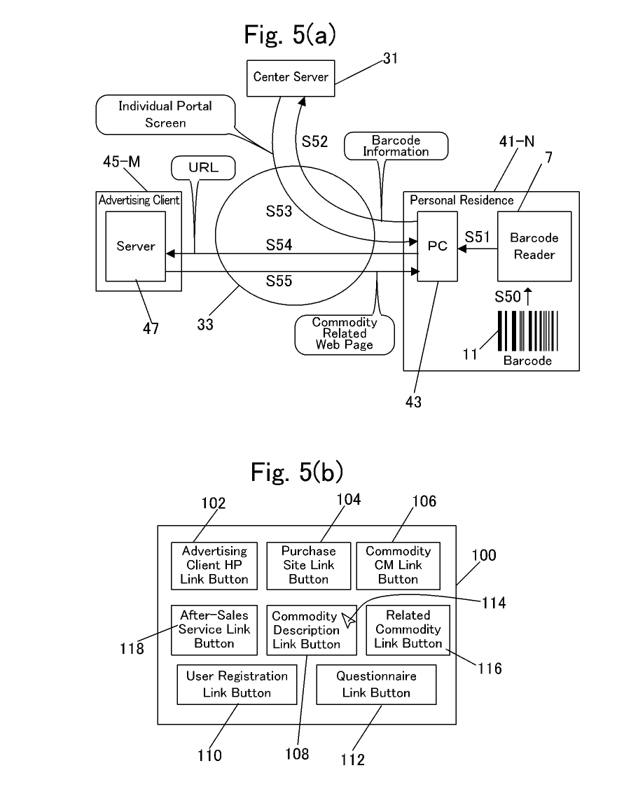

FIG. 5(a) is a schematic diagram for showing the general outline of the advertisement support system. Referring to FIG. 5(a), in step S50, the barcode reader 7 scans and decodes a barcode pattern 11 in response to user's operation, and acquires barcode information contained in the barcode pattern 11.

The PC 43 receives the barcode information which is output from the barcode reader 7 in step S51, and transmits the barcode information to the center server 31 through the network 33 in step S52. In step S53, the center server 31 transmits, to the PC 43 through the network 33, the information which can be used to display an individual portal screen provided in correspondence with the barcode information as received from the PC 43. The PC 43 then displays the individual portal screen on the basis of the information as received.

The individual portal (entrance) screen is a screen which is provided individually for each item of commodity for displaying link information related to the each commodity. In other words, the individual portal screens are provided in a one-to-one correspondence with the individual commodity items.

FIG. 5(b) is a view for showing a first individual portal screen 100 which is a first example of the individual portal screen provided for a certain commodity. Referring to FIG. 5(b), the first individual portal screen 100 includes a link button 102 for opening the home page (HP) of the advertising client 45-M of the commodity indicated by barcode information, a link button 104 for opening a website in which the commodity indicated by the barcode information can be purchased, a link button 106 for opening a website in which a commercial message (CM) of the commodity indicated by the barcode information is distributed, the link button 118 for opening a website in which after-sales service is provided for the commodity indicated by the barcode information, a link button 108 for opening a website in which commodity description is given for the commodity indicated by the barcode information, a link button 116 for opening a website in which related commodities of the commodity indicated by the barcode information are described, a link button 110 for opening a website in which user registration can be done, and a link button 112 for opening a website in which a questionnaire can be conducted. Also, a cursor 114 is displayed in the first individual portal screen 100. Meanwhile, in this example, the related commodities indicated by the link button 116 are commodities provided by the advertising client 45-M of the commodity indicated by the barcode information. Also, it is assumed that the link button 110 serves as a link to the site in which user registration can be made for the present system. Alternatively, the link button 110 may be a link to the site in which user registration can be made for the commodity indicated by the barcode information, or may be a link to the site in which user registration can be made for both the commodity and the present system. It is possible to collect user information easily and promptly.

Furthermore, the link button 112 is a link to the site in which a questionnaire can be conducted for the commodity indicated by the barcode information. Accordingly, it is possible to perform market research about various commodities. In this case, it is possible to swiftly obtain the result in real time. In this way, the advertisement support corporation can obtain profitable information. However, the link button 112 may be not a link to a web site for having a questionnaire about a commodity indicated by barcode information but a link to a web site for having a questionnaire with the other purpose. In this case, it is possible to have a questionnaire which does not depend on a commodity to which the barcode is assigned.

However, as a default process (for which the advertising client 45-M is not charged), only the link button 102 for opening the home page of the advertising client 45-M, the link button 110 for opening the website in which user registration can be made for the present system, and a link button 112 for opening the website in which the questionnaire can be conducted, are displayed. The other link buttons 104, 106, 108, 116 and 118 are displayed as options only after the advertising client 45-M becomes a member of the advertisement support system of the business entity (advertisement support corporation) running the center server 31. However, in the case where the link button 104 does not provide a link to the shopping website of the advertising client 45-M, but provides a link to the shopping website of another commodity retailer, the link button 104 is displayed as a default button. This is because, in this case, the advertisement support corporation can make profits by affiliate advertising.

The system of charging the members can be implemented as a fixed charge system such as the system of charging an annual fee for membership, a pay-per-click system for charging a fee in accordance with the number of times of clicking (pressing) the link buttons displayed in the first individual portal screen 100, a fee-for-result system for charging a fee in accordance with the result (purchase of a commodity and so forth) or any combination thereof.

When the user of the PC 43 presses either one of the link buttons 102, 104, 106, 108, 116 and 118, in step S54 of FIG. 5(a), the PC 43 accesses the server 47 of the advertising client 45-M through the network 33 on the basis of the URL corresponding to the link button which is pressed. The server 47 then transmits information for displaying the web page corresponding to the link button which is pressed, to the PC 43 through the network 33 in step S55. In response to this, the PC 43 displays the web page.

Returning to FIG. 4, the computer 37 and the monitor 39 of the store 35-K correspond to the PC 43 of the personal residence 41-N, and the barcode reader 7 of the store 35-K corresponds to the barcode reader 7 of the personal residence 41-N. Accordingly, the communication among the center server 31, the store 35-K and the advertising client 45-M is performed in the same manner as the communication among the center server 31, the personal residence 41-N and the advertising client 45-M as illustrated in FIG. 5(a), and therefore no redundant description is repeated.

Also, the content items of the individual portal screen displayed on the monitor 39 of the store 35-K are similar to the content items of the first individual portal screen 100 displayed on the PC 43 of the personal residence 41-N as shown in FIG. 5(b), and therefore no redundant description is repeated. However, in this case, it is also possible to display in the individual portal screen a link button specific to the store 35-K, for example, providing a link to a website describing information for sales, special services and the like information of the store 35-K.

When the advertisement support system is introduced to the store 35-K, it is preferred for the business entity operating the center server 31 to have the owner of the store 35-K be a member and to charge a predetermined fee such as an annual fee (in a fixed charge system). Also, in connection with the link button specific to the store 35-K, a pay-per-click system or a fee-for-result system may be employed as in the case of the advertising client 45-M.

Next, the center server 31 will be explained in detail.

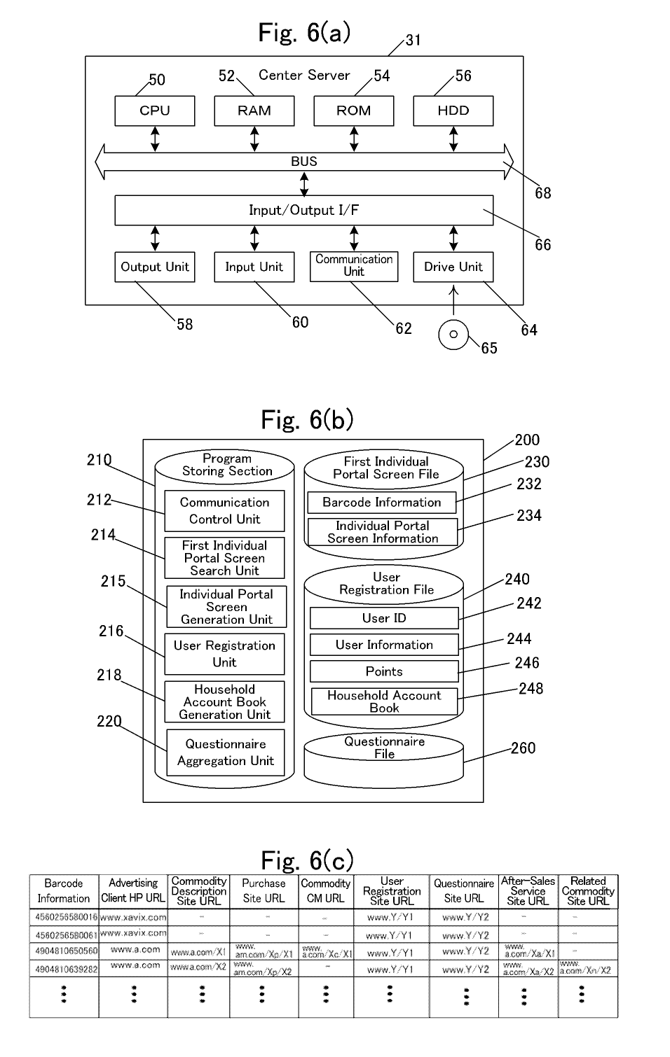

FIG. 6(a) is a schematic diagram for showing the electric configuration of the center server 31 shown in FIG. 4. Referring to FIG. 6(a), the center server 31 includes a CPU (Central Processing Unit) 50, a RAM (Random Access Memory) 52, a ROM (Read Only Memory) 54, a HDD (Hard Disk Drive) 56, an input/output interface (input/output I/F) 66, an output unit 58, an input unit 60, a communication unit 62, a drive 64 and a bus 68.

The CPU 50 is connected to the RAM 52, the ROM 54, the HDD 56, and the input/output I/F 66 through the bus 68. The input/output I/F 66 is connected to the output unit 58 such as an LCD display, the input unit 60 such as a mouse or a keyboard, the communication unit 62 such as a LAN card or a USB controller serving to make a connection with the network 33, and the drive 64 for driving a removable recording medium 65 such as CD-ROM, DVD-ROM, respectively.

Incidentally, the hardware configurations of the PC 43, the computer 37, the server 47 and the server 77 are similar to the hardware configuration of the center server 31, and therefore no redundant description is repeated. Also, the hardware configurations of the host computer 1 and the stationary terminal 5f shown in FIG. 1 are similar to the hardware configuration of the center server 31. Furthermore, the hardware configuration of the mobile terminal 5m shown in FIG. 1 is well known in the art.

FIG. 6(b) is a schematic representation showing the configuration of the storage area 200 of the center server 31. As shown in FIG. 6(b), the storage area 200 of the HDD 56 and the ROM 54 of the center server 31 includes a program storing section 210, a first individual portal screen file 230, a user registration file 240, and a questionnaire file 260.

The first individual portal screen file 230 is provided to form a database for storing barcode information 232 provided individually for each of commodities, and individual portal screen information 234 corresponding to each item of commodity indicated by the barcode information 232 in association with each other.

FIG. 6(c) is a schematic diagram for showing the configuration of the first individual portal screen file 230. Referring to FIG. 6(c), the first individual portal screen file 230 is a file in which, for each commodity, the barcode information 232 is associated with the individual portal screen information 234. The individual portal screen information 234 contains the URL of the home page of the advertising client corresponding to the link button 102 of FIG. 5(b), the URL of the commodity description site corresponding to the link button 108, the URL of the commodity purchase site corresponding to the link button 104, the URL of the commercial message site corresponding to the link button 106, the URL of the user registration site corresponding to the link button 110, the URL of the questionnaire site corresponding to the link button 112, the URL of the related commodity site corresponding to the link button 116, and the URL of the after-sales service site corresponding to the link button 118. Incidentally, the protocol indication (“http://”) is omitted in FIG. 6(c).

Returning to FIG. 6(b), the user registration file 240 is provided to form a database for storing user identification information (ID) 242, user information 244 which is registered through the first individual portal screen 100 (the link button 110) displayed on the PC 43 of the personal residence 41-N or the monitor 39 of the store 35-K, point information 246, and household account book information 248 in association with each other. The user information contains various information items including a name, a gender, an age, a birth date, a residence, a telephone number, an email address, a profession and other information relating to each user. The point information 246 indicates points to be added under predetermined conditions when the link button of the first individual portal screen 100 is pressed. A specific benefit is given to the user when the points have amounted to a predetermined number. The household account book information 248 is a file for storing a daily record of household expenses of the user. The user can access the household account book information 248 through the PC 43 or the computer 37 by inputting a user ID and a password.

The questionnaire file 260 is provided to form a database for storing the results of questionnaire collected through the first individual portal screen 100 (the link button 112) which is displayed the PC 43 of the personal residence 41-N or the monitor 39 of the store 35-K.

The program storing section 210 includes a communication control unit 212, a first individual portal screen search unit 214, an individual portal screen generation unit 215, a user registration unit 216, a household account book generation unit 218, and a questionnaire aggregation unit 220. These function units are implemented as programs of computer software, or subroutines of a program installed in the ROM 54 and/or the HDD 56. These programs are stored in the removable recording medium 65, and installed in the center server 31 therefrom. Also, these function units will be explained by the use of the following flow chart.

Next, the communication procedure among the server 47 of the advertising client 45-M, the PC 43 of the personal residence 41-N and the center server 31 will be explained with reference to a flow chart.

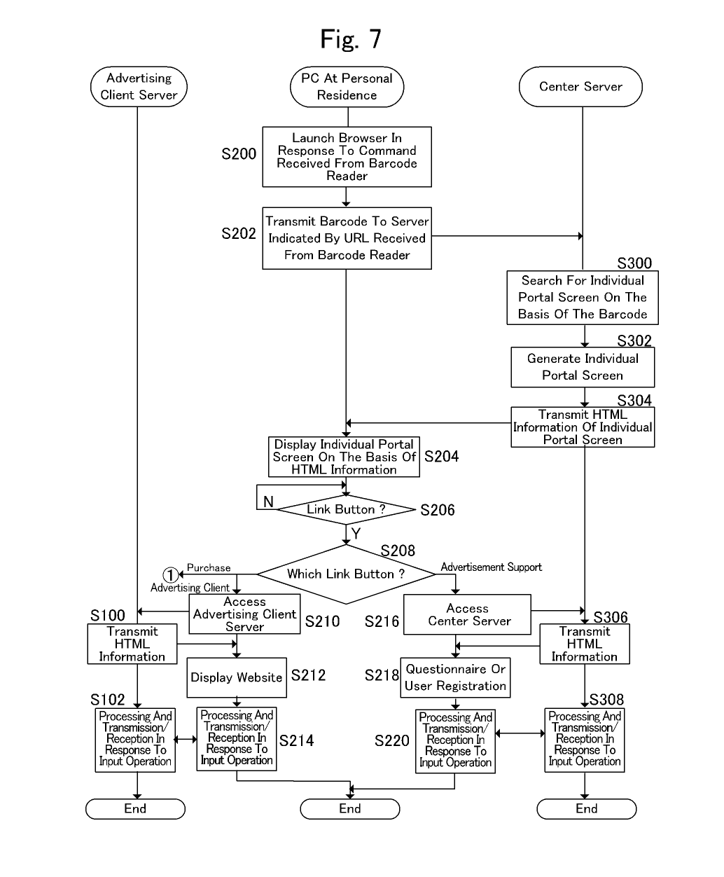

FIG. 7 is a flow chart showing an example of the communication procedure in accordance with the advertisement support system. Meanwhile, since the process as shown in FIG. 7 is performed by the use of well-known protocols such as TCP/IP (Transmission Control Protocol/Internet Protocol) and HTTP (HyperText Transfer Protocol), and therefore the details of the communication procedure will not be described.

Referring to FIG. 7, in step S200, the PC 43 of the personal residence 41-N launches a browser in response to the command given from the barcode reader 7. Then, in step S202, the PC 43 accesses the center server 31 on the basis of the URL given from the barcode reader 7, and transmits the URL (including the barcode information and the serial number 30) given from the barcode reader 7 to the center server 31. In this case, before the PC 43 receives the information, the barcode reader 7 performs the steps similar to steps S1 to S11 of FIG. 3, and therefore no redundant description is repeated. Meanwhile, the ROM 19 of the barcode reader 7 stores the URL 27 of the center server 31.

The communication control unit 212 of the center server 31 receives the URL including the barcode information and the serial number 30. Then, in step S300, the first individual portal screen search unit 214 of the center server 31 accesses the first individual portal screen file 230, and searches for the URL (refer to FIG. 6(c)) which is associated with the barcode information as received.

In step S302, the individual portal screen generation unit 215 of the center server 31 generates HTML (HyperText Markup Language) information for enabling the PC 43 to display the first individual portal screen 100 including the link buttons corresponding to the URLs acquired in step S300. In step S304, the communication control unit 212 of the center server 31 transmits the generated HTML information to the PC 43 of the personal residence 41-N.

In this case, it is also possible to prepare an HTML information file for displaying the first individual portal screen 100 corresponding to each barcode information in advance, retrieve the HTML information file with the barcode information as an index, and transmit the retrieved HTML information files to the PC 43.

The PC 43 receives the HTML information of the first individual portal screen 100, and displays the first individual portal screen 100 by parsing the HTML information in step S204. In step S206, the PC 43 determines whether or not any one of the link buttons 102, 104, 106, 108, 110, 112, 116 and 118 of the first individual portal screen 100 is pressed. If not pressed, the process is returned to step S206. If pressed, the process proceeds to step S208.

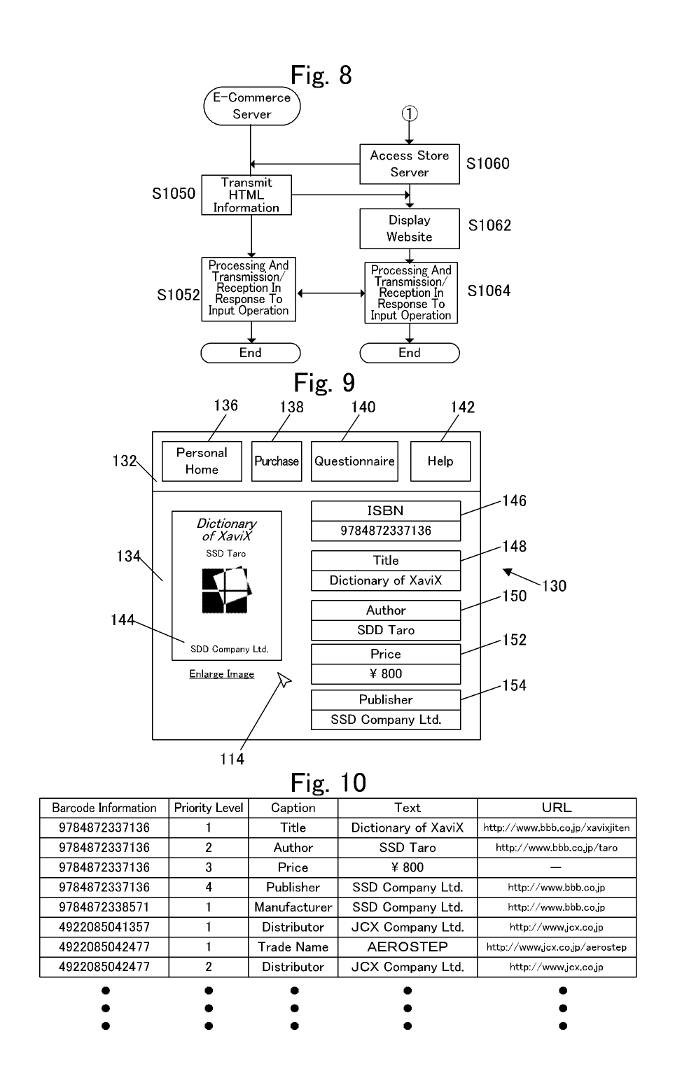

When the link button pressed in step S206 is any one of the link buttons 102, 106, 108, 116 and 118, the PC 43 proceeds to step S210 (from step S208). Conversely, when the link button pressed is either of the link buttons 110 and 112, the PC 43 proceed to step S216 (from step S208). Otherwise, when the link button pressed is the link button 104, the PC 43 proceeds to step S1060 of FIG. 8 (from step S208).

In step S210, the PC 43 accesses the server 47 of the advertising client 45-M on the basis of the URL corresponding to the link button which is pressed. The server 47 of the advertising client 45-M then transmits the corresponding HTML information to the PC 43 of the personal residence 41-N in step S100. The PC 43 receives and parses this HTML information, and display a website. In this case, when the link button pressed in step S206 is the link button 108, the website for explaining the commodity indicated by the barcode information transmitted in step S202 is displayed. When the link button as pressed is the link button 102, the home page of the advertising client 45-M of the commodity indicated by the barcode information is displayed. When the link button as pressed is the link button 106, the website for distributing the commercial message of the commodity indicated by the barcode information is displayed. When the link button pressed in step S206 is the link button 116, the website of the commodities which are related to the commodity indicated by the barcode information is displayed. When the link button as pressed is the link button 118, the website for the after-sales service of the commodity indicated by the barcode information is displayed.

In step S214, the PC 43 performs processing and communication with the server 47 of the advertising client 45-M in response to the input from the user. In step S102, the server 47 performs processing and communication with the PC 43 in response to the access from the PC 43.

On the other hand, in step S216, the PC 43 of the personal residence 41-N accesses the center server 31 on the basis of the URL corresponding to the link button as pressed. The communication control unit 212 of the center server 31 then transmits the corresponding HTML information to the PC 43 of the personal residence 41-N in step S306. In this case, when the link button pressed in step S206 is the link button 110, the user registration unit 216 of the center server 31 generates the HTML information of the website in which user registration can be done. Also, when the link button as pressed is the link button 112, the questionnaire aggregation unit 220 of the center server 31 generates the HTML information of the website in which a questionnaire can be conducted.

The PC 43 receives and parses the HTML information, and displays the website in step S218. In this case, when the link button pressed in step S206 is the link button 110, the website in which user registration can be done is displayed. Also, when the link button as pressed is the link button 112, the website in which a questionnaire can be conducted is displayed.

In step S220, the PC 43 performs processing and communication with the center server 31 in response to the input operation by the user. In step S308, the center server 31 performs processing and communication with the PC 43 in response to the access from the PC 43. In this case, when the link button pressed in step S206 is the link button 110, the user registration unit 216 of the center server 31 performs various processing for user registration, and stores the result of the processing in the user registration unit 216. Also, when the link button as pressed is the link button 112, the questionnaire aggregation unit 220 of the center server 31 performs various processing for collection and aggregation of questionnaire, and stores the result of the processing in the questionnaire file 260.

Referring to FIG. 8, when it is determined in step S206 of FIG. 7 that the link button 104 is pressed, the PC 43 accesses an e-commerce server (not shown in the figure) of the business entity running an e-commerce site (i.e., a commodity purchase site) in step S1060 on the basis of the URL corresponding to the link button 104 which is pressed. This server then transmits the corresponding HTML information to the PC 43 in step S1050. In step S1062, the PC 43 receives and parses this HTML information, and displays the e-commerce site. In step S1064, the PC 43 performs processing and communication with the e-commerce server in response to the input operation by the user. In step S1052, this server performs processing and communication with the PC 43 in response to the access from the PC 43, and accepts the order for a commodity indicated by the barcode information. Incidentally, the electric configuration of this server is similar to that of the center server 31 shown in FIG. 6(a).

Next, the household account book generation unit 218 of the center server 31 will be explained. A household account book generation service is provided for the user who has made user registration and desires this service. The household account book generation unit 218 calculates daily household expenses and generates a household account book on the basis of the barcode information transmitted from the PC 43 of the user, and stores the generated household account book in the user registration file 240 in association with the user ID. In this case, while the name of the commodity is acquired from the barcode information, the price of the commodity is input to the PC 43 by the user and transmitted to the center server 31.

Incidentally, while the computer 37 and the monitor 39 of the store 35-K correspond to the PC 43 of the personal residence 41-N, the communication procedure among the server 47 of the advertising client 45-M, the computer 37 of the store 35-K and the center server 31 is performed in the same manner as shown in the flow charts of FIG. 7 and FIG. 8, and therefore no redundant description is repeated.

Meanwhile, the first individual portal screen 100 of FIG. 5(b) is an example of the individual portal screen. A first individual portal screen 130 will be explained as another example with reference to drawings.

FIG. 9 is a view for showing an example of the first individual portal screen 130 used in an application example 1. Referring to FIG. 9, this first individual portal screen 130 includes a frame 132 which is managed solely by the advertisement support corporation, and a frame 134 which is managed by the advertising client 45-M. Incidentally, while the advertising client 45-M manages the content in the frame 134, the system itself is managed by the advertisement support corporation. A cursor 114 is displayed in the first individual portal screen 130.

The frame 132 includes a personal home button 136, a purchase button 138, a questionnaire button 140, and a help button 142. The user can display a personal site by moving the cursor 114 to the personal home button 136, and clicking this button. This personal site is a website which is assigned to each user for displaying and managing the information specific to the each user. For example, the personal site is used to display the history of the barcodes 11 scanned by the user, manage the barcodes 11, and so forth. Meanwhile, the URL of the personal site is associated with the serial number 30 of the barcode reader 7 in a table which is stored in the HDD 56. Accordingly, the center server 31 can acquire the corresponding URL by referring to this table with the received serial number 30 as an index.

The user can display a commodity purchase site (i.e., an e-commerce site) by moving the cursor 114 to the purchase button 138, and clicking this button. This commodity purchase site is a site for performing the procedure of buying a commodity displayed in the frame 134, i.e., a commodity indicated by the barcode 11 which is scanned. The user can display a questionnaire site by moving the cursor 114 to the questionnaire button 140, and clicking this button. This questionnaire site is a site in which the user can input answers to a questionnaire. The user can display a help site by moving the cursor 114 to the help button 142, and clicking this button. This help site is a site for explaining in detail to the user the method of using the present system.

The frame 134 includes an image 144 of the commodity indicated by the scanned barcode 11, a barcode section 146 for displaying the barcode information indicated by the scanned barcode 11, and commodity information sections 148, 150, 152 and 154 for displaying various information items related to the commodity indicated by the scanned barcode 11. Each of the commodity information sections 148, 150, 152 and 154 includes an upper field (caption field) and a lower field (text field). In the example shown in FIG. 9, the commodity information section 148 is used to describe a caption (“Book Title”) and a text (“XaviX Dictionary”). The commodity information section 150 is used to describe a caption (“Author”) and a text (“Shinsedai Taro”). The commodity information section 152 is used to describe a caption (“Price”) and a text (“800 Yen”). The commodity information section 154 is used to describe a caption (“Publisher”) and a text (“SSD Company Limited”). In this example, these sections 148, 150 and 154 serve as link buttons. Accordingly, by moving the cursor 114 to any desired one of the commodity information sections 148, 150 and 154 and clicking this button, the user can browse a website for providing more detailed information about the information contained in the commodity information section which is clicked.

Next, the method of generating the first individual portal screen 130 by the center server 31 will be explained. The first individual portal screen 130 is generated with reference to an individual portal screen table shown in FIG. 10 and stored in the HDD 56.

Referring to FIG. 10, this table is a table in which each barcode is associated with a priority level, a caption, a text and a URL.

The “Priority Level” field in this table indicates a higher priority level by a smaller number. Then, the “Priority Level” field determines the priority levels of displaying the commodity information sections (148, 150, 152 and 154) respectively. A commodity information section having a higher priority level is displayed in a higher position in the frame 134. The “Caption” field contains a character string to be described in the upper field of each commodity information section. The “Text” field contains a character string to be described in the lower field of each commodity information section. The “URL” field contains the URL of the link target in the case where the corresponding commodity information section serves as a link button.

This will be explained in accordance with a specific example. The first through fourth lines of the table of FIG. 10 correspond to the commodity information sections 148, 150, 152 and 154 of FIG. 9 respectively. Priority levels are given to the commodity information sections 148, 150, 152 and 154 respectively in descending order. Accordingly, the commodity information sections 148, 150, 152 and 154 are displayed in this order from the above in the frame 134.

Of course, it can be arbitrarily determined by setting the content of this table how many commodity information sections are provided for one barcode 11, i.e., one first individual portal screen 130. In addition, the advertising client 45-M can freely determine what character strings are input to the “Caption” field and the “Text” field. Also, the advertising client 45-M can freely determine the priority levels in the “Priority Level” field. Furthermore, the advertising client 45-M can freely determine what URL is input to the “URL” field.

However, the advertisement support corporation permits displaying one commodity information section in the first individual portal screen 130 as a default, i.e., with no charge. In this case, the advertisement support corporation permits only describing a character string such as “Manufacturer”, “Retailer” or “Provider” in the “Caption” field, the name of company in the “Text” field and the URL of the home page of the company (the top page of the WEB site of the company, rather than the page of the commodity) in the “URL” field. The system may be designed such that the advertising client 45-M can determine the default settings of the commodity information section, that the advertisement support corporation can determine the default settings, or that both the advertising client 45-M and the advertisement support corporation can determine the default settings. However, it is not desirable that, despite scanning the barcode 11, no information is displayed for the corresponding commodity. It is assumed therefore that the advertisement support corporation determines the default settings of the commodity information section at the outset. Also, the commodity information sections other than the default commodity information section are displayed as an option. The advertising client 45-M desiring the option is charged a fee and then permitted to set up the table.

In the case of the example shown in FIG. 10, with respect to the barcode information “9784872337136” and “4922085042477” in the table, the option has been selected such that four and two commodity information sections are displayed respectively. Also, with respect to the barcode information “9784872338571” and “4922085041357”, the option is not selected such that only one commodity information section is displayed as the default in which only the name of company is described.

Returning to FIG. 9, the barcode section 146 is located in a predetermined position to display the barcode information which is scanned. The position of the commodity image 144 is also determined in advance. However, the commodity image 144 is displayed in the first individual portal screen 130 only as an option, which incurs an extra fee.

Incidentally, the communication procedure of the advertisement support system for displaying the first individual portal screen 130 is the same as shown in FIG. 7 and FIG. 8. However, in step S300, the first individual portal screen search unit 214 of the center server 31 collects the information which is necessary for providing the first individual portal screen 130. In other words, the first individual portal screen search unit 214 accesses the individual portal screen table shown in FIG. 10, searches it by the use of the barcode information which is received, and retrieves the content of the commodity information sections. In addition to this, the first individual portal screen search unit 214 acquires the URL to be assigned to the personal home button 136 from the HDD 56 with reference to the received serial number 30 from the barcode reader 7 as an index. Meanwhile, the serial number of the barcode reader 7 is stored in the HDD 56 in association with the URL of the personal site of the user. Also, the first individual portal screen search unit 214 acquires the URL to be assigned to the purchase button 138 from the HDD 56 with reference to the received barcode information as an index. Incidentally, the barcode information is stored in the HDD 56 in association with the URL of the commodity purchase site. Furthermore, the first individual portal screen search unit 214 acquires the address, at which the commodity image 144 is stored, from the HDD 56 with reference to the received barcode information as an index. The barcode information is stored in the HDD 56 in association with the address information of the commodity image 144. The commodity image 144 is stored in the HDD 56.

In step S302, the individual portal screen generation unit 215 of the center server 31 generates HTML information for displaying the first individual portal screen 130 on the PC 43 on the basis of the information collected in step S300. Then, in step S304, the communication control unit 212 of the center server 31 transmits the generated HTML information to the PC 43 of the personal residence 41-N.

As has been discussed above, in accordance with the application example 1 of the remote barcode reader system shown in FIG. 1, when the user who is interested in a commodity or has purchased a commodity scans the barcode by the barcode reader 7, the computer 37 installed in the store 35-K or the PC 43 installed in the personal residence 41-N (collectively referred to as “the terminal “tm” in the following description) transmits the barcode information of the commodity, and the terminal “tm” can receives information for generating the first individual portal screen 100 or 130 from the center server 31, and display the first individual portal screen 100 or 130.

Since each of the first individual portal screens 100 and 130 is a screen specific to the commodity indicated by the barcode information, it includes link information to the server 47 of the advertising client 45-M providing the information about the commodity. Accordingly, the user of the terminal “tm” accesses easily the server 47 of the advertising client 45-M of the commodity through the first individual portal screen 100 or 130, and can easily browse information about the desired commodity.

For the advertising client 45-M, there is an advantage that the information about a commodity can be provided to the individual who is actually interested in the commodity or has purchased the commodity with pinpoint accuracy through the first individual portal screen 100 or 130. In this regard, this system substantially differs from the conventional affiliate program.

On the other hand, for the user of the terminal “tm”, for example, when the user becomes interested in a commodity or wants to search some information about a purchased commodity, it is possible to display the first individual portal screen 100 or 130 which is specific to the commodity on the monitor of the terminal “tm” only by scanning the barcode of the commodity with the barcode reader 7 and transmitting the barcode information with the terminal “tm”. The user can therefore easily access the target site through the first individual portal screen 100 or 130. Because of this, it becomes much easier to acquire the information about the commodity as compared with the case where the information about the commodity is acquired by inputting terms, which seem to be related to the commodity, to a general purpose search engine, or by making use of a conventional portal site and searching for the information about the desired commodity among a number of commodities which are classified in a structured manner.

Also, when making use of a conventional technique such as a general purpose search engine or portal site service, such a situation may arise that the user cannot find which information is the information he wants from among a number of commodity sites having the equivalent or similar titles in the search results obtained by the conventional technique. However, such a situation can be avoided in accordance with the above system. Furthermore, in accordance with these conventional techniques, the search results often include misleading sites and informal sites, which become a hindrance when the advertising client 45-M wants website audience accessing the server 47 thereof. However, such a situation can be avoided also in accordance with the above system.

The advertisement support corporation running the center server 31 can make a profit from the business entity operating the advertising client 45-M or the store 35-K when preparing the first individual portal screen 100 or 130. For example, while charging no fee for the first individual portal screen 100 or 130 in which only the link button 102 of the home page of the advertising client 45-M is displayed, a certain fee is charged to the advertising client 45-M who desires to display more link information items in the first individual portal screen 100 or 130. The link information items increase in the first individual portal screen 100 or 130 in this manner.

If many link information items are displayed in the first individual portal screen 100 or 130, the corresponding commodity can be advertised from a variety of angles, and thereby the users are more encouraged to buy the commodity than when a fewer link information items are displayed in the first individual portal screen 100 or 130. In other words, when comparing similar commodities, the sales total of commodity products of the advertising client having the first individual portal screen 100 or 130 containing many link information items is expected to be larger than the sales total of commodity products of the advertising client having the first individual portal screen 100 containing a fewer link information items. Accordingly, the advertising client 45-M is expected to desire to display extra link information items even if it requires paying a fee.

For the same reason, it is apparent that a difference occurs in sales between the store 35-K such as a retail store with the present system installed, and another store without the present system. Accordingly, most business entities operating stores are also expected to introduce the present system. In this case, the advertisement support corporation can make profits by charging the business entities operating the respective stores 35-K.

Of course, the center server 31 could provide the PC 43 or the computer 37 with the URL of the website of the commodity indicated by the barcode information in place of the first individual portal screen 100 or 130, and enable the PC 43 or the computer 37 to directly display the website. However, in this case, there is no advantages as has been described above and specific to the first individual portal screen 100 or 130.

Also, the link button 104 or 138 corresponding to the URL of the commodity purchase site which is run by an e-commerce business entity is displayed in the first individual portal screen 100 or 130. Accordingly, since the commodity can be sold through these buttons 104 and 138, the advertisement support corporation running the first individual portal screen 100 or 130 can make profits by affiliate advertising.

### Application Example 2

The center server 31 provides different content items between the individual portal screen displayed on the PC 43 of the personal residence 41-N from which the user accesses the center server 31 and the individual portal screen displayed on the computer 37 of the store 35-K from which the user accesses the center server 31, even though the same barcode is scanned.

In the case where the user accesses the center server 31 from the computer 37 of the store 35-K, it is considered that the user has been mulling over buying, and thereby the individual portal screen is designed to include many links to information which enhances buying motivation such as commodity commercial. On the other hand, in the case where the user accesses the center server 31 from the PC 43, it is considered that the user often has already purchased the commodity, and thereby the individual portal screen is designed to include many links to information about a new type of the commodity, information for after-purchase service and the like information. The individual portal screen can therefore be designed to meet the needs of advertising clients and users as much as possible. In this manner, even if the same barcode is scanned, the individual portal screen is provided with a different design depending upon in which step the user is when purchasing the commodity. In the case of the application example 2, the installation location of the terminal “tm” is used to determine in which step the user is when purchasing the commodity.

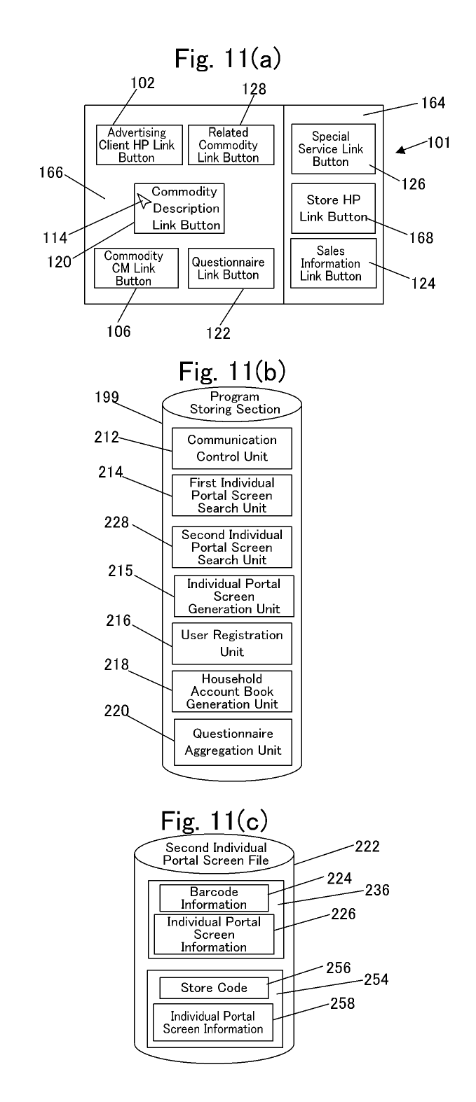

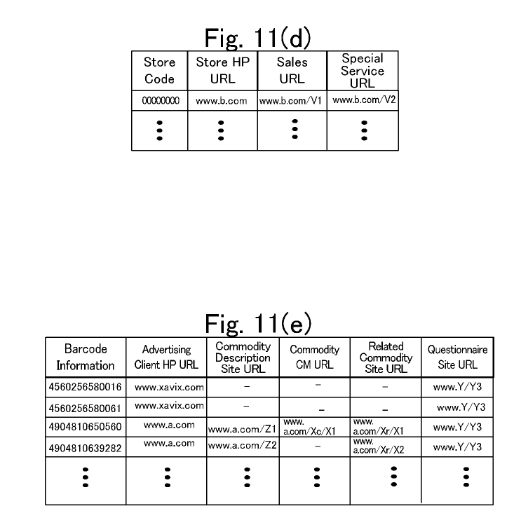

More specifically speaking, in the case of the application example 2, the first individual portal screen 100 shown in FIG. 5(b) is displayed on the PC 43 when the user accesses the center server 31 from the PC 43. On the other hand, when the user accesses the center server 31 from the computer 37 of the store 35-K, a second individual portal screen 101 shown in FIG. 11(a) is displayed on the monitor 39.

Referring to FIG. 11(a), the second individual portal screen 101 includes a frame 166 containing links to content items which are managed by the advertising client 45-M, and a frame 164 containing links to content items which are managed by the store central office 75-P.

The frame 166 includes a link button 102 for opening the home page (HP) of the advertising client 45-M of the commodity indicated by barcode information, a link button 128 for opening a website in which related commodities of the commodity indicated by the barcode information are described, a link button 106 for opening a website in which a commercial message (CM) of the commodity indicated by the barcode information is distributed, a link button 120 for opening a website in which commodity description is given for the commodity indicated by the barcode information, and a link button 112 for opening a website in which a questionnaire can be conducted for the commodity indicated by the barcode information. The frame 164 includes a link button 124 providing a link to a website describing information for sales of the store 35-K, a link button 126 providing a link to a website describing special services of the store 35-K, and a link button 168 for opening the home page (HP) of the store central office 75-P. Furthermore, the cursor 114 is displayed on the second individual portal screen 101.

However, as a default link buttons (for which the advertising client 45-M is not charged), only the link button 102 for opening the home page of the advertising client 45-M, and a link button 122 for opening the website in which the questionnaire can be conducted, are displayed. The other link buttons 128, 106 and 120 are displayed only after the advertising client 45-M becomes a member of the advertisement support system of the business entity running the center server 31. Furthermore, the link buttons 124, 126 and 168 are displayed only after the store central office 75-P becomes a member of the advertisement support system of the business entity running the center server 31.

The common points and different points between the first individual portal screen 100 and the second individual portal screen 101 of the application example 2 will be explained. First, the common points will be explained. The link button 102 and 106 are the same in both sides. This is because there is little reason to differentiate these content items between the personal residence 41-N and the store 35-K.

Next, the different points will be explained. The link button 108 of the first individual portal screen 100 is different from the link button 120 of the second individual portal screen 101. For example, while the link button 108 serves as a link to a site showing how to use the commodity or application examples because the user is viewing it in the personal residence 41-N, the link button 120 serves as a link to a site describing explanation which can enhance buying motivation in addition to explanation of how to use because the user is viewing it in the store 35-K and thereby expected to be considering purchasing in a proactive manner.

Also, the link button 116 of the first individual portal screen 100 is different from the link button 128 of the second individual portal screen 101. For example, while the link button 116 serves as a link to a site describing not only how to use the commodity or application examples, but also information about model changes and new products because the user is viewing it in the personal residence 41-N and thereby he is expected to have already possessed the commodity. Also, the link button 128 serves as a link to a site showing other items belonging to the same category which are manufactured and sold by the advertising client 45-M in order to expand the range of options to purchase, because the user is viewing it in the store 35-K.

Furthermore, the link button 112 of the first individual portal screen 100 is different from the link button 122 of the second individual portal screen 101. This is because there may be differences between the store 35-K and the personal residence 41-N, in regard to the mental state of the user and the proportion of the number of users who already have purchased (or have not purchased yet), and thereby some significant information could be acquired by conducting different questionnaires.

Meanwhile, the link button 104 is displayed only in the first individual portal screen 100 which is viewed at the personal residence 41-N, but not displayed in the second individual portal screen 101. This is because, while it is expected to purchase through an e-commerce service at the personal residence 41-N, it is expected to purchase directly at the store 35-K and thereby the link button 104 is not needed in the second individual portal screen 101.

Meanwhile, the link button 118 is displayed only in the first individual portal screen 100 which is viewed at the personal residence 41-N, but not displayed in the second individual portal screen 101. This is because, while it is expected that the user at the store 35-K has not purchased the commodity yet, the user may at the personal residence 41-N have already purchased the commodity so that after-sales service is often needed.

Meanwhile, the link button 110 is displayed only in the first individual portal screen 100 which is viewed at the personal residence 41-N, but not displayed in the second individual portal screen 101. This is because it is unlikely that the user makes user registration at the store 35-K, but usually the user makes user registration at the personal residence 41-N.

Meanwhile, the link buttons 124, 126 and 168 are displayed only in the second individual portal screen 101, but not displayed in the first individual portal screen 100. This is because the link buttons 124, 126 and 168 are provided for information related to the store 35-K, and the PC 43 of the personal residence 41-N does not have the information of the store 35-K.

Incidentally, the system configuration of this application example 2 is similar to the system configuration shown in FIG. 4. However, the barcode reader 7 of the store 35-K is a barcode reader which is commercially available in the marketplace, rather than the barcode reader having the configuration shown in FIG. 2 which is specific to the present invention. Incidentally, the computer 37 of the store 35-K is provided with dedicated software preinstalled therein for transmitting the barcode 11 through a browser to the center server 31. In this case, this dedicated software is automatically launched in response to the input of the barcode 11, and automatically transmits the barcode 11 to the center server 31.

Meanwhile, even in the case where such preinstalled dedicated software is used, it is substantially not needed to take troublesome installation into consideration at the store 35-K, unlike at the personal residence 41-N. This is because, in the case of the store 35-K, the computer 37, the monitor 39 and the barcode reader 7 is set up by the entity in many cases.

Also, the programs and data segments are stored in the storage area 200 of the center server 31 in the same fashion as illustrated in FIG. 6(b). However, a program storing section 199 shown in FIG. 11(b) is used in place of the program storing section 210. Particularly, the storage area 200 is used to store a second individual portal screen file 222 as shown in FIG. 11(c) in addition to the first individual portal screen file 230.

Referring to FIG. 11(b), the program storing section 199 is provided with a second individual portal screen search unit 228 in addition to the configuration of the program storing section 210. The second individual portal screen file 222 of FIG. 11(c) includes an advertising client file 236 and a store file 254. The advertising client file 236 is provided to form a database for storing barcode information 224 provided individually for each item of commodity, and individual portal screen information 226 corresponding to each item of commodity indicated by the barcode information 224 in association with each other. The store file 254 is provided to form a database for storing store codes 256 which are assigned to the stores 35-K respectively, and individual portal screen information 258 in association with each other.

Referring to FIG. 11(d), the store file 254 is a file in which the store codes 256 are stored in association with the individual portal screen information 258. The individual portal screen information 258 contains the URL of the home page of the store central office corresponding to the link button 168 of FIG. 11(a), the URL of the special service information site corresponding to the link button 126, and the URL of the sales information site corresponding to the link button 124.

Referring to FIG. 11(e), the advertising client file 236 is a file in which, for each commodity, the barcode information 224 is associated with the individual portal screen information 226. The individual portal screen information 226 contains the URL of the home page of the advertising client corresponding to the link button 102 of FIG. 11(a), the URL of the related commodity site corresponding to the link button 128, the URL of the commercial message site corresponding to the link button 106, the URL of the commodity description site corresponding to the link button 120, the URL of the questionnaire site corresponding to the link button 122. Incidentally, the protocol indication (“http://”) is omitted in FIG. 11(d) and FIG. 11(e).

Meanwhile, the communication procedure among the server 47 of the advertising client 45-M, the PC 43 of the personal residence 41-N and the center server 31 is performed in the advertisement support system of the application example 2 in the same manner as shown in the flow charts of FIG. 7 and FIG. 8. Nevertheless, there are different points which will be explained sequentially in the following description.

Referring to FIG. 7, in step S202, the PC 43 of the personal residence 41-N transmits to the center server 31 the URL (for example, “http://www.ssd.co.jp/house/” in which the barcode information and the serial number are omitted herein for the sake of clarity in description) which is different from the URL (for example, “http://www.ssd.co.jp/kiosk/” in which the barcode information and the serial number are omitted herein for the sake of clarity in description) which is transmitted by the dedicated software installed in the computer 37 of the store 35-K. Namely, the URL transmitted to the PC 43 by the barcode reader 7 of the personal residence 41-N is different from the URL transmitted by the dedicated software installed in the computer 37 of the store 35-K. As described above, for example, different directory names are concatenated just after the domain name between the personal residence 41-N and the store 35-K. Alternatively, for example, it is possible to provide different subdomains therebetween. In brief, any known technique can be used as long as the center server 31 can distinguish between the personal residence 41-N and the store 35-K. The dedicated software of the computer 37 transmits also the store code assigned to the store 35-K, to the center server 31.

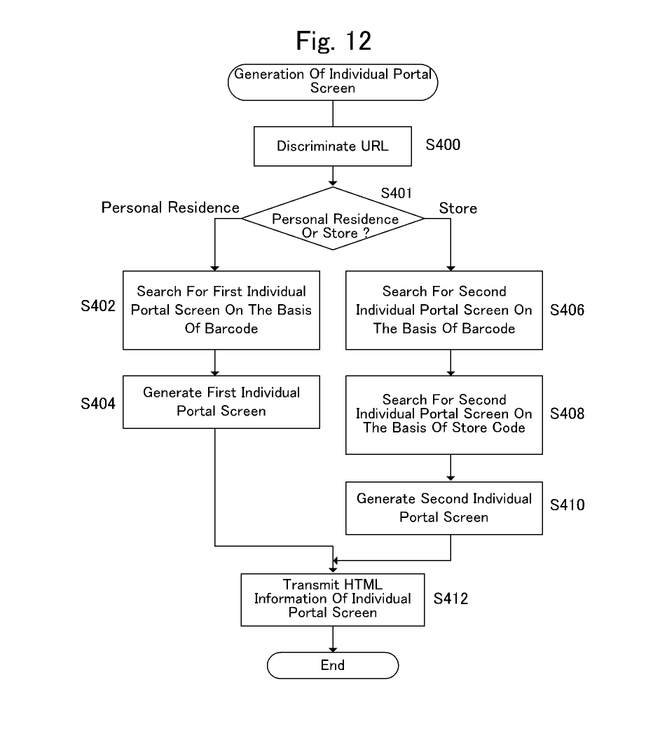

Furthermore, in the case of the application example 2, the process of generating the individual portal screen as shown in FIG. 12 is performed in place of steps S300, S302 and S304 of FIG. 7.

Referring to FIG. 12, in step S400, the communication control unit 212 of the center server 31 confirms the content of the URL which is received, and determines which of the personal residence 41-N and the store 35-K transmits the received URL. In step S401, when the received URL is transmitted from the PC 43 of the personal residence 41-N, i.e., if the directory name concatenated just after the domain name is “house” in the aforementioned example, the communication control unit 212 proceeds to step S402 by giving control to the first individual portal screen search unit 214. Conversely, when the received URL is transmitted from the computer 37 of the store 35-K, i.e., if the directory name concatenated just after the domain name is “kiosk” in the aforementioned example, the communication control unit 212 proceeds to step S406 by giving control to the second individual portal screen search unit 228.

In step S402, the first individual portal screen search unit 214 accesses the first individual portal screen file 230, and searches for the URLs (refer to FIG. 6(c)) associated with the barcode information which is received. Then, in step S404, the individual portal screen generation unit 215 generates HTML (HyperText Markup Language) information for enabling the PC 43 of the personal residence 41-N to display the first individual portal screen 100 including the link buttons corresponding to the URLs acquired in step S402.

On the other hand, in step S406, the second individual portal screen search unit 228 accesses the advertising client file 236 of the second individual portal screen file 222, and searches for the URLs (refer to FIG. 11(e)) associated with the barcode information which is received. Furthermore, in step S408, the second individual portal screen search unit 228 accesses the store file 254 of the second individual portal screen file 222, and searches for the URLs (refer to FIG. 11(d)) which are associated with the store code which is received. Then, in step S410, the individual portal screen generation unit 215 generates HTML information for enabling the computer 37 of the store 35-K to display the second individual portal screen 101 including the link buttons corresponding to the URLs acquired in steps S406 and S408.

In step S412 after step S404, the communication control unit 212 of the center server 31 transmits the HTML information generated in step S404 to the PC 43 of the personal residence 41-N. On the other hand, in step S412 after step S410, the communication control unit 212 transmits the HTML information generated in step S410 to the computer 37 of the store 35-K.

Next is a description of explaining the communication procedure among the server 47 of the advertising client 45-M, the computer 37 of the store 35-K, and the center server 31 in the case of the application example 2.

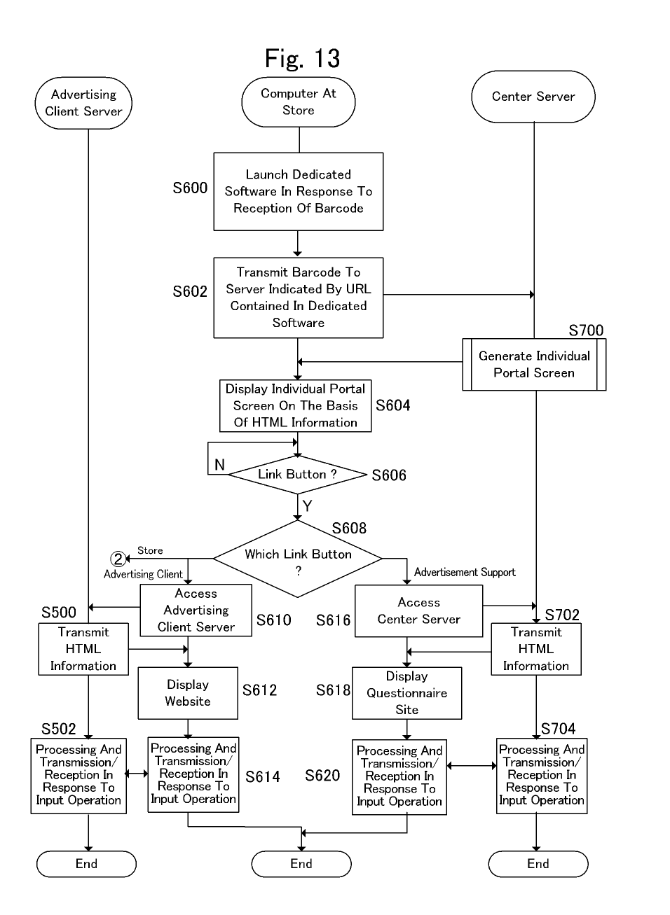

FIG. 13 is a flow chart for showing an example of the communication procedure among the server 47 of the advertising client 45-M, the computer 37 of the store 35-K, and the center server 31 in the case of the application example 2. Incidentally, in FIG. 13, the details of the communication procedure of the above processing is dispensed with because these steps are performed by well-known protocols, such as TCP/IP, HTTP and so forth.

Referring to FIG. 13, in step S600, the computer 37 of the store 35-K launches the dedicated software as described above when the barcode information is given from the barcode reader. In step S602, then, the dedicated software transmits the barcode information as given from the barcode reader and the store code contained therein to the center server 31 on the basis of the URL contained therein of the center server 31. Incidentally, this barcode reader is an ordinary barcode reader which provides the computer 37 with only the barcode information as keyboard data, unlike the barcode reader 7. Incidentally, the dedicated software saves the URL of the center server 31 and the store code, for example, by storing them in the HDD of the computer 37.

The communication control unit 212 of the center server 31 receives this barcode information and the store code. In step S700, then, the center server 31 performs the process of generating the individual portal screen as shown in FIG. 12.

The computer 37 of the store 35-K receives the HTML information of the second individual portal screen 101, and parses the HTML information to display the second individual portal screen 101 in step S604. In step S606, the computer 37 determines whether or not any one of the link buttons 102, 128, 120, 106, 122, 126, 168 and 124 is pressed in the second individual portal screen 101. If none of the link buttons is pressed, the process is returned to step S606, but if anyone of these link buttons is pressed, the process proceeds to step S608.

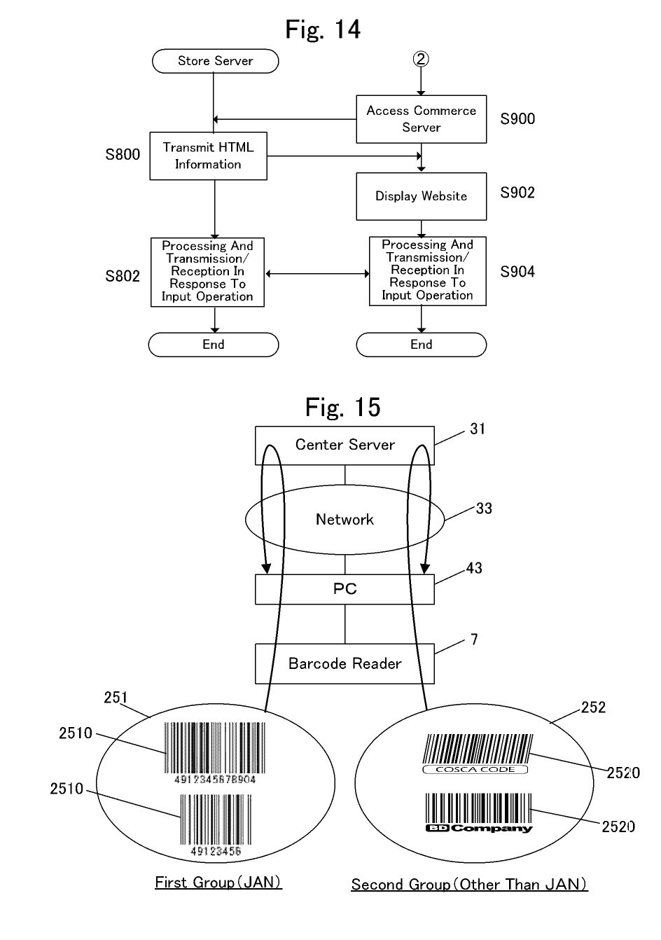

When the link button pressed in step S606 is any one of the link buttons 102, 128, 120 and 106, the computer 37 proceeds to step S610 (from step S608). Conversely, when the link button pressed is the link button 122, the computer 37 proceeds to step S616 (from step S608). Otherwise, when the link button pressed is any one of the link buttons 126, 168 and 124, the computer 37 proceeds to step S900 of FIG. 14 (from step S608).

In step S610, the computer 37 accesses the server 47 of the advertising client 45-M on the basis of the URL corresponding to the link button which is pressed. The server 47 of the advertising client 45-M then transmits the corresponding HTML information to the computer 37 of the store 35-K in step S500. In step S612, then, the computer 37 receives and parses this HTML information, and display a website. In this case, when the link button pressed in step S606 is the link button 120, the website for explaining the commodity indicated by the barcode information transmitted in step S602 is displayed. When the link button as pressed is the link button 102, the home page of the advertising client 45-M of the commodity indicated by the barcode information is displayed. When the link button as pressed is the link button 106, the website for distributing the commercial message of the commodity indicated by the barcode information is displayed. When the link button pressed in step S606 is the link button 128, the website of the commodities which are related to the commodity indicated by the barcode information is displayed.

In step S614, the computer 37 performs processing and communication with the server 47 of the advertising client 45-M in response to the input from the user. In step S502, the server 47 performs processing and communication with the computer 37 in response to the access from the computer 37.

On the other hand, in step S616, the computer 37 accesses the center server 31 on the basis of the URL corresponding to the link button 122 as pressed. The communication control unit 212 of the center server 31 then transmits the corresponding HTML information to the computer 37 of the store 35-K in step S702. In this case, the questionnaire aggregation unit 220 of the center server 31 generates the HTML information of the website in which a questionnaire can be conducted.

The computer 37 receives and parses the HTML information, and displays the website in which a questionnaire can be conducted in step S618.

In step S620, the computer 37 performs processing and communication with the center server 31 in response to the input operation by the user. In step S704, the center server 31 performs processing and communication with the computer 37 in response to the access from the computer 37. In this case, the questionnaire aggregation unit 220 of the center server 31 performs various processing for collection and aggregation of the questionnaire, and stores the result of the processing in the questionnaire file 260.

Referring to FIG. 14, when it is determined in step S608 of FIG. 13 that any one of the link buttons 126, 168 and 124 is pressed, the computer 37 accesses the server 77 of the store central office 75-P in step S900 on the basis of the URL corresponding to the link button which is pressed. This server 77 then transmits the corresponding HTML information to the computer 37 of the store 35-K in step S800. In step S902, then, the computer 37 receives and parses this HTML information, and displays a website. In this case, the computer 37 displays a website describing special services of the store 35-K indicated by the store code which is transmitted in step S602 when the link button pressed in step S606 is the link button 126, displays the home page of the store central office 75-P which manages the store 35-K indicated by the store code when the link button pressed is the link button 168, and displays a website describing information for sales of the store 35-K indicated by the store code when the link button pressed is the link button 124.

In step S904, the computer 37 performs processing and communication with the server 77 of the store central office 75-P in response to the input operation by the user. In step S802, the server 77 performs processing and communication with the computer 37 in response to the access from the computer 37.

Meanwhile, in the case of the application example 2, the first individual portal screen 130 shown in FIG. 9 can be displayed in place of the first individual portal screen 100.

As described above, in accordance with the application example 2, the center server 31 can provide effective service and contents considering a situation of the user even if the barcodes are the same as each other. For example, since it is possible to perform processing by taking into consideration the mental state of the user and in which step the user is when purchasing the commodity (for example, after or before purchasing, away from home or at home), it is possible to effectively provide services and content by taking into consideration the mental state of the user and in which step the user is when purchasing the commodity. This is because differences in the installation locations (referred to as transmission sources of the barcodes, or connection locations of the barcode readers 7) of the communication terminals (37, 43), i.e., the locations the users stay, may result in differences in regard to the mental state of the user and in which step the user is when purchasing the commodity.

Also, only the installation locations of the communication terminals (37, 43) are taken into consideration in processing regardless of the hardware performances of the communication terminals. Accordingly, in the case where the categories (e.g., a store and a personal residence) of the installation locations of the communication terminals are different from each other, the center server 31 provides the different contents even if the hardware performances of the communication terminal are equal to each other, conversely in the case where the categories of the installation locations of the communication terminals are the same as each other, the center server 31 provides the same contents even if the hardware performances are different from each other. Needless to say, it is also possible to change the contents depending on the hardware performances (e.g., a personal computer and a mobile phone) of the communication terminals in addition to changing the contents depending on the installation locations.

As described above, it is possible to provide the different services (including contents) based on the same barcodes depending on the installation locations of the communication terminals (37, 43) even if the hardware performances of the communication terminals are equal to each other.

### Application Example 3

The system configuration of the application example 3 is similar to the system configuration shown in FIG. 4. In what follows, this example will be explained by focusing on its characterizing points with reference to drawings.

FIG. 15 is an explanatory view for showing the application example 3. Referring to FIG. 15, in the case of the application example 3, the center server 31 performs processing by classifying the barcodes into a first group 251 and a second group 252. The first group 251 includes barcodes each of which consists of a 13-digit or 8-digit JAN (Japanese Article Number) code 2510, and the second group 252 includes barcodes each of which consists of a barcode 2520 which is not a JAN code.

The JAN code is a common product code (a common code is assigned to the same commodity items) used in Japan, and has been applied typically to POS (Point Of Sale) systems, also applied to ordering systems, inventory clearance systems and inventory control systems, and further applied to payment systems for public utility charges and so forth. The first group 251 corresponds to the group of the eleventh example as described above. On the other hand, the barcode 2520 of the second group is, for example, a 14-digit barcode which is issued by the advertisement support corporation in correspondence with each service or content item thereof. The second group 252 corresponds to the groups of the first to tenth examples as described above. When setting a plurality of groups into which barcodes are classified in this manner, 14-digit barcodes are issued to belong respectively to the groups without overlapping between groups, and each group corresponds to each service or each content.

In the case of the application example 3, the center server 31 determines the number of digits of the barcode which is received from the PC 43, and determines which the received barcode is the barcode 2510 (i.e., a JAN code) belonging to the first group 251 or the barcode 2520 belonging to the second group 252. In this case, the center server 31 determines that the barcode belongs to the first group 251 if the number of digits of the received barcode is 13 or 8, and otherwise the barcode belongs to the second group 252.

Then, if the received barcode is the barcode 2510 belonging to the first group 251, the center server 31 transmits the first individual portal screen 100 (needless to say, the first individual portal screen 130 may be transmitted instead) to the PC 43. On the other hand, if the received barcode is the barcode 2520 belonging to the second group 252, the center server 31 performs processing in accordance with the group to which the barcode 2520 belongs, of the second group, generates content in accordance with this group and in correspondence with the barcode 2520, and transmits the content to the PC 43.

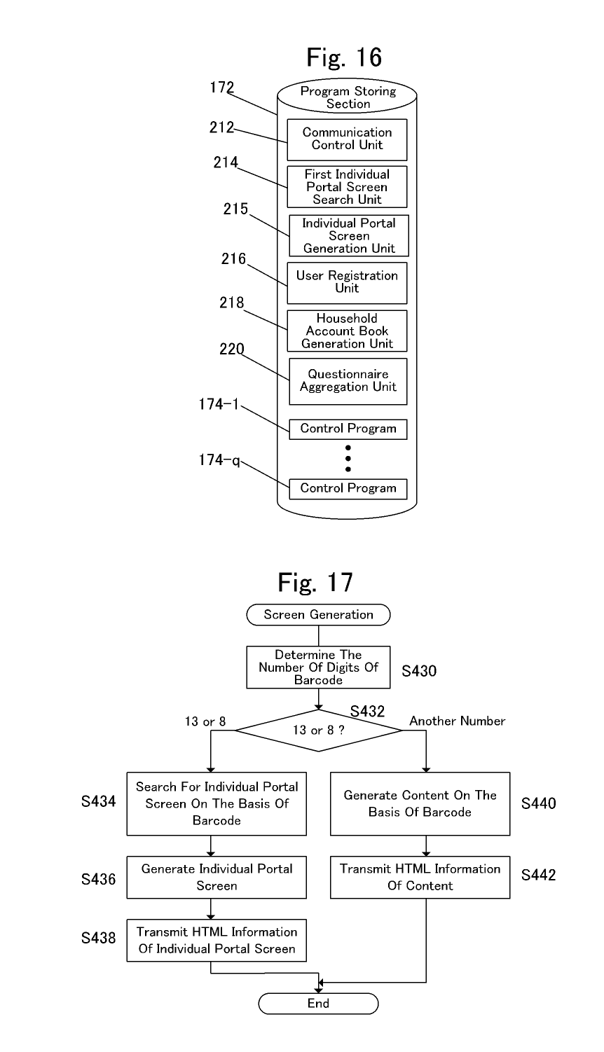

Incidentally, the programs and data segments are stored in the storage area 200 of the center server 31 in the same fashion as illustrated in FIG. 6(b). However, a program storing section 172 shown in FIG. 16 is used in place of the program storing section 210. The program storing section 172 is provided with control programs 174-1 to 174-q in addition to the configuration of the program storing section 210. The control programs 174-1 to 174-q are collectively referred to as the control programs 174-Q.

The 14-digit barcodes other than JAN codes are classified into a plurality of groups. These groups are associated with various services in a one-to-one correspondence. The PC 43 is then provided with the content in correspondence with the group to which the received 14-digit barcode belongs. In this case, the content is generated by running the control program 174-Q corresponding to this group. Accordingly, each group is provided with the control program 174-Q corresponding thereto. Of course, the storage area 200 is also used to store the resources which are used by each control program 174-Q in addition to those illustrated in the figure.

Meanwhile, the communication procedure among the server 47 of the advertising client 45-M, the PC 43 of the personal residence 41-N and the center server 31 is performed in the advertisement support system of the application example 3 in the same manner as shown in the flow chart of FIG. 7. Nevertheless, there are different points which will be explained sequentially in the following description.

In the case of the application example 3, the process of generating the screen as shown in FIG. 17 is performed in place of steps S300, S302 and S304 of FIG. 7.

Referring to FIG. 17, the communication control unit 212 of the center server 31 determines the number of digits of the received barcode information in step S430. In step S432, then, when the number of digits of the received barcode is 13 or 8, i.e., when a JAN code is received, the communication control unit 212 proceeds to step S434 by giving control to the first individual portal screen search unit 214. Conversely, when the number of digits of the received barcode is not 13 nor 8, the process proceeds to step S440 by giving control to the control program 174-Q corresponding to the group to which the barcode information belongs.

In step S434, the first individual portal screen search unit 214 accesses the first individual portal screen file 230, and searches this file for the URLs (refer to FIG. 6(c)) which are associated with the barcode information as received. In step S436, then, the individual portal screen generation unit 215 generates HTML information for enabling the PC 43 of the personal residence 41-N to display the first individual portal screen 100 including the link buttons corresponding to the URLs acquired in step S434. In step S438, the communication control unit 212 of the center server 31 transmits the HTML information generated in step S436 to the PC 43 of the personal residence 41-N. The subsequent processes are the same as those of FIGS. 7 and 8.

On the other hand, in step S440, the control program 174-Q generates HTML information of the content corresponding to the received barcode information. In step S442, then, the communication control unit 212 of the center server 31 transmits the HTML information of the content generated in step S440 to the PC 43 of the personal residence 41-N. Then, the PC 43 parses the HTML information to display the content.

Incidentally, while the computer 37 of the store 35-K correspond to the PC 43 of the personal residence 41-N, the communication procedure of the application example 3 among the center server 31, the computer 37 and the advertising client 45-M is performed in the same manner as the communication procedure among the center server 31, the PC 43 and the advertising client 45-M, and therefore no redundant description is repeated.

By the way, in the case of the application example 3 as has been discussed above, the center server 31 classifies a barcodes as received into either the first group 251 or the second group 252, and processing is performed in accordance with the result of classification. The first group 251 includes the JAN code 2510 which is originally designed for use in the POS system rather than for use in the present system. In other words, the JAN codes 2510 are provided independently of the present system, and widely distributed in the world. Accordingly, the present system provides services, i.e., individual portal screens by the use of the JAN code 2510 which has been widely distributed in the world. On the other hand, while the second group 252 includes the barcodes 2520 other than the JAN code 2510, the barcodes 2520 are designed for the purpose of providing a particular service by the use of the present system, but not designed for use in the POS system. Namely, the barcodes 2520 are provided for use in the present system. Accordingly, a variety of services are provided by the present system in accordance with the purpose of preparing the barcodes 2520.

As discussed above, while the barcode 2510 belonging to the first group 251 is different from the barcode 2520 belonging to the second group 252 in nature and feature, the user can scan these barcodes by the use of the same barcode reader 7 without awareness of this fact, and receive the service provided in accordance with the first group 251 and a variety of services in accordance with the various barcodes 2520 belonging to the second group 252.

In addition, the user can easily obtain a good to which the JAN code 2510 having been widely distributed is attached, and the present system can readily be available only with the barcode reader 7 on the assumption that an appropriate network environment has been established. On the other hand, the user can receive a wide variety of different services by scanning the barcode 2520 belonging to the second group 252.

Furthermore, on the system installation side, since the JAN code 2510 having been widely distributed can be used, it requires smaller labor as compared with the case where only the barcodes 2520 are used.

### Application Example 4

The application example 4 makes use of a camera unit 180 in place of the barcode reader 7 shown in FIG. 4. In what follows, this example will be explained by focusing on its characterizing points with reference to drawings.

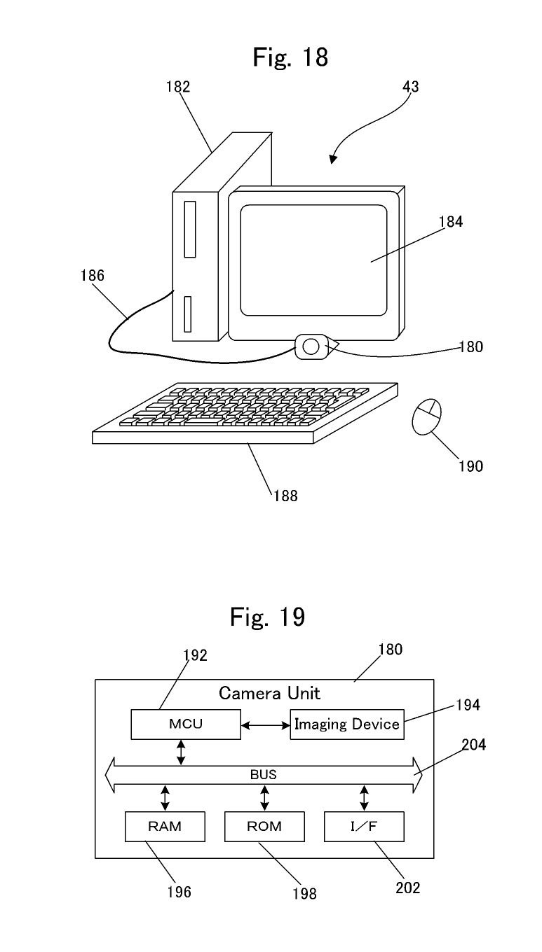

FIG. 18 is a perspective external view for showing the PC 43 and the camera unit 180 installed in the personal residence 41-N. Referring to FIG. 18, the PC 43 includes a computer unit 182, a monitor 184, a wireless keyboard 188 and a wireless mouse 190. The camera unit 180 is connected to the computer unit 182 of the PC 43 by a USB (Universal Serial Bus) cable 186. The camera unit 180 is located below the monitor 184. However, the camera unit 180 can be placed in an arbitrary location, such as on the top of the monitor 184.

When the camera unit 180 is connected to the PC 43, the PC 43 recognizes the camera unit 180 as a keyboard and a mouse. The camera unit 180 takes an image of the barcode 11 attached to a commodity produce which is held by the over the camera unit 180. Then, the camera unit 180 analyzes the image as taken to numerically convert, converts the result into keyboard data, and outputs this data to the PC 43. The barcode which is numerically converted is called barcode information. This camera unit 180 serves also as a mouse (pointing device) at the same time. Namely, when the user holds the commodity product over the camera unit 180, and moves the commodity product itself, the camera unit 180 calculates the amounts of moving the commodity product (in both the X-axis and the Y-axis), and outputs them to the PC 43. The PC 43 moves the cursor 114 displayed in the individual portal screen in accordance with the amounts of motion as received. In other words, the cursor 114 is moved in synchronization with the motion of the commodity product. Also, the camera unit 180 successively calculates the area of the image of the commodity product which is taken. When the area of the image increases by a predetermined factor or more, i.e., when the commodity product substantially approaches the camera unit 180, the camera unit 180 recognizes this motion as the gesture of clicking and transmits clicking information to the PC 43. Accordingly, when receiving the clicking information from the camera unit 180 while the cursor 114 is located in a link button of the individual portal screen, the PC 43 determines that the link button is pressed.

FIG. 19 is a schematic diagram for showing the electric configuration of the camera unit 180 as shown in FIG. 18. Referring to FIG. 19, the camera unit 180 includes an MCU (Microcontroller Unit) 192, an imaging device 194 such as a CCD or an image sensor, a RAM 196, a ROM 198, an interface (I/F) 202 and a bus 204. The MCU 192 is connected to the RAM 196, the ROM 198 and the I/F 202 through the bus 204. The imaging device 194 is, for example, a VGA (Video Graphics Array) compatible device. Also, the I/F 202 includes a USB controller. The ROM 198 is used to store a control program to be described below with reference to a flow chart. The RAM 196 is used as a storage area for storing image data transmitted from the imaging device 194, a working area and so forth.

The communication procedure among the server 47 of the advertising client 45-M, the PC 43 of the personal residence 41-N and the center server 31 is performed in the advertisement support system of the application example 4 in the same manner as shown in the flow chart of FIG. 7.

In addition, the camera unit 180 can be used in place of the barcode reader 7 of the store 35-K. Also, the communication procedure among the server 47 of the advertising client 45-M, the computer 37 of the store 35-K and the center server 31 is performed in the advertisement support system of the application example 4 in the same manner as shown in the flow chart of FIG. 7.

Next, the process performed by the MCU 192 will be explained with reference to a flow chart.

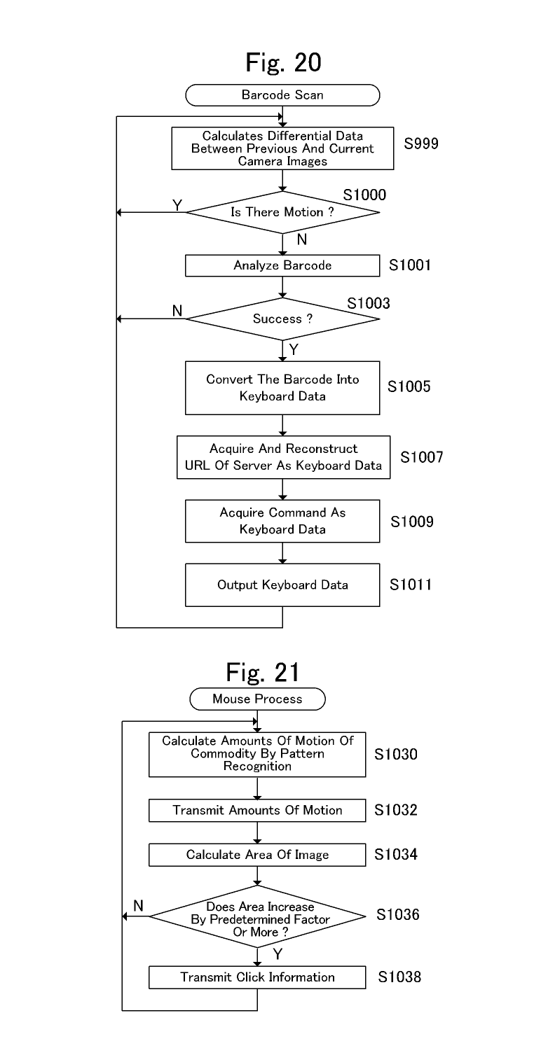

FIG. 20 is a flow chart for showing an example of the process of scanning a barcode by the MCU 192 of FIG. 19. Referring to FIG. 20, the MCU 192 calculates the differential data between the previous camera image (taken in the previous frame) and the current camera image (taken in the current frame) to acquire the differential image therebetween in step S999. In step S1000, the MCU 192 determines whether or not the commodity product being imaged has moved on the basis of the differential image. If the commodity product has moved, since the barcode cannot be scanned, the process is returned to step S999. Conversely if the commodity product has not moved, the process proceeds to step S1001. Incidentally, if the commodity product has moved, it is recognized that the user utilizes the camera unit 180 as a pointing device by moving the commodity product.

In step S1001, the MCU 192 analyzes the barcode included in the image taken by the imaging device 194, and numerically converts the barcode image to acquire barcode information. In step S1003, the MCU 192 determines whether or not the barcode has been successfully analyzed. If the barcode has not been successfully analyzed, the process is returned to step S999. Conversely if the barcode has been successfully analyzed, the process proceeds to step S1005.

In step S1005, the MCU 192 converts the barcode information which is the result of analysis into keyboard data, and stores the keyboard data in the RAM 196. In step S1007, then, the MCU 192 acquires the URL (for example, “http://www.ssd.co.jp”) of the center server 31 as keyboard data from the ROM 198, appends the barcode information (for example, “4560256580016”) and the serial number 30 (for example, “13222159”) of the camera unit 180 as keyboard data to the end of the URL, and stores it in the RAM 196 as a new URL (for example, “http://www.ssd.co.jp/?bc=4560256580016&sn=13222159”).

In step S1009, the MCU 192 acquires a command from the ROM 198 in the form of keyboard data which instructs the PC 43 to launch the browser and access the center server 31, and stores the command in the RAM 196. In step S1011, the MCU 192 outputs the keyboard data (the command and URL (server URL+barcode information+serial number) to the PC 43 through the USB controller of the I/F 202. The PC 43 launches the browser in response to this command, and transmits the barcode information and the serial number to the center server 31.

FIG. 21 is a flowchart for showing an example of processing mouse operation by the MCU 192 of FIG. 19. Referring to FIG. 21, in step S1030, the MCU 192 calculates, by pattern recognition, the amounts of motion (in the X-axis and the Y-axis) of the moving commodity product (i.e., the commodity product which is held and moved by the user in his hand) on the basis of the image as a result of imaging operation by the imaging device 194. Then, in step S1032, the MCU 192 transmits the amounts of motion to the PC 43 through the USB controller of the I/F 202. The PC 43 receives the information about the amounts of motion, and can synchronize the motion of the cursor 114 in the individual portal screen with the motion of the commodity product, which is held and moved by the user in his hand, and has the barcode.

In step S1034, the MCU 192 calculates the area of the image of the moving commodity product. Namely, when the user holds the commodity product in his hand and move it closer to the camera unit 180, the area of the image of the commodity product increases. Processing is performed in step S1034 in order to detect this increase in the area of the image. In step S1036, then, the MCU 192 determines whether or not the area of the image increases by a predetermined factor (exceeding one) or more in comparison with the area calculated a predetermined number of routines earlier. If the area does not increase, the process proceeds to step S1030. Conversely, if the area increases, the process proceeds to step S1038 by determining that the user moves the commodity product close to the camera unit 180. When the area of the image Increases by the predetermined factor or more in comparison with the area calculated the predetermined number of routines earlier, the MCU 192 recognizes that the user has made the gesture of clicking (corresponding to mouse click) and transmits clicking information to the PC 43 through the USB controller of the I/F 202 in step S1038. The PC 43 can recognize through the reception of the click information that the click operation is performed.

Meanwhile, as has been discussed above, in the case of the application example 4, the user-friendliness can be improved by the use of the camera unit 180 as an input device to the terminal “tm”.

In other words, the user can display the individual portal screen on the monitor of the terminal “tm” only by having the camera unit 180 take an image of the barcode attached to a commodity product such that the terminal “tm” automatically transmits the barcode information to the center server 31 in response to the command from the camera unit 180, without need for cumbersome operation performed by the user (the terminal “tm” need not be manipulated). Also, the terminal “tm” performs processing required for realizing the present system in response to the command from the camera unit 180, and thereby it is possible to save the user from the trouble of installing a new program in the terminal “tm” and so forth.

Furthermore, the camera unit 180 serves not only as a means for acquiring the barcode information, but also as a mouse (pointing device). Accordingly, after taking an image of the barcode attached to a commodity product for the purpose of acquiring the barcode information to be transmitted to the center server 31 by the camera unit 180, the user can manipulate the cursor 114 displayed in the individual portal screen only by moving the commodity product which faces the camera unit 180, and thereby the structure is very user-friendly.

### Application Example 5

Referring to FIG. 1, in the application example 5, the host computer 1 receives the barcode 11 scanned by the barcode reader 7, transmits data corresponding to the barcode 11 to the terminal 5, launches a predetermined application program, which has been installed in the terminal 5, based on the data as received, and makes the predetermined application program perform processing based on the data as received. In what follows, the example, in which the predetermined application program is a virtual terrestrial globe application program (hereinafter referred to as a “terrestrial globe application”), will be described. The terrestrial globe application displays satellite photographs and aerial photographs around the world like a map. The Earth is displayed on a screen, view approaches a desired place from the sky in response to the operation of a user, and thereby it is possible to look at the satellite photograph or the aerial photograph of the place.

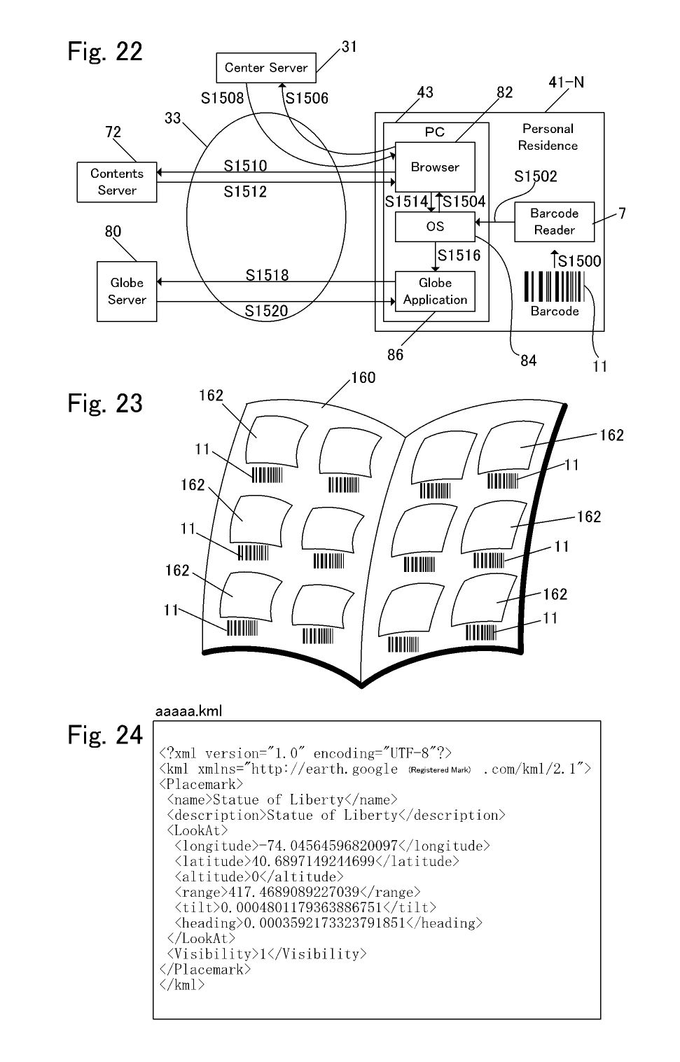

FIG. 22 is an explanatory view for showing an application example 5. In this case, a center server 31, a contents server 72, and a terrestrial globe server 80 of FIG. 22 corresponds to the host computer 1 of FIG. 1. The electric configuration of the contents server 72 is similar to that of the center server 31 shown in FIG. 6(a).

Referring to FIG. 22, in step S1500, the barcode reader 7 scans and decodes the barcode pattern 11 in response to the operation of the user, and obtains the barcode information designated by the barcode pattern 11. In this case, for example, the barcode reader 7 scans the barcode pattern 11 printed on a book 160 with barcodes of FIG. 23 by the operation of the user. This book 160 contains a plurality of sets each of which consists of the satellite photograph 162 or the aerial photograph 162 (hereinafter referred to as the “photograph 162”), and the barcode pattern 11. The user scans the barcode pattern printed below the desired photograph 162 with the barcode reader 7.

Returning to FIG. 22, the operating system (OS) 84 of the PC 43 receives the barcode information obtained by the barcode reader 7 in step S1502, and then sends it to the browser 82 of the PC 43 in step S1504. Then, in step S1506, the browser 82 transmits the received barcode information to the center server 31 through the network 33.

And, in step S1508, the center server 31 converts the received barcode information into the URL, and transmits the URL to the browser 82 of the PC 43. In step S1510, the browser 82 accesses the contents server 72 designated by the received URL. Then, in step S1512, the browser 82 acquires the file (hereinafter referred to as a “controlling file”) designated by the received URL from the contents server 72. As shown in FIG. 24, this controlling file has the suffix (in the example of the figure, “kml”) associated with the terrestrial globe application 86. Also, this controlling file includes information related to the photograph 162 to be displayed by the terrestrial globe application 86. In the example of the figure, the information contains a name (“name”), description (“description”), and display information of the place or the construct taken in the photograph 162. The display information includes degree of longitude (“longitude”), degree of latitude (“latitude”), flight height (“altitude”), a displayed range (“range”), a depression angle (“tilt”), and a direction (“heading”) of the place and so on taken in the photograph 162, and presence information of a mark (“visibility”).

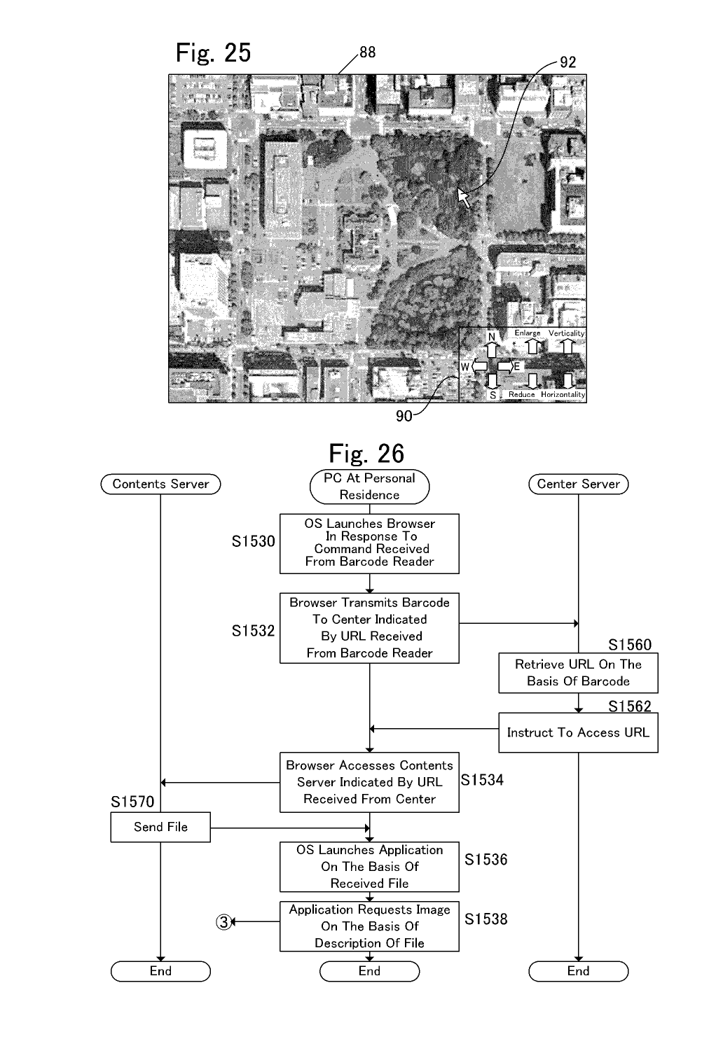

Returning to FIG. 22 again, in step S1514, the browser 82 sends the acquired controlling file to the OS 84. Then, in step S1516, the OS 84 launches the terrestrial globe application 86 based on the suffix of the controlling file, and sends the path of the controlling file to the terrestrial globe application 86. In step S1518, the terrestrial globe application 86 accesses the controlling file based on the path as sent in order to request the terrestrial globe server 80 to transmit the photograph 162 of the place and so on designated by the display information contained in the controlling file. And, in step S1520, the terrestrial globe server 80 stream-distributes the data of the photograph 162 requested by the terrestrial globe application 86. The terrestrial globe application 86 displays the photograph 162 on the monitor based on the data. As shown in FIG. 25, for example, the terrestrial globe application 86 displays the photograph 162 on the monitor on the basis of the data as stream-distributed. As the result, the user can look at the detail and enlargement of the photograph 162, which is placed on the book 160, on the screen of the monitor. Also, the terrestrial globe application 86 displays a photograph manipulation section 90 on the monitor. If the user manipulates each icons in the photograph manipulation section 90 by the cursor 92, the terrestrial globe application 86 performs the change of the location (north, south, east and west), the enlarging or reducing operation (enlargement and reduction), and the change of the depression angle (verticality and horizontality) in accordance with the manipulation.

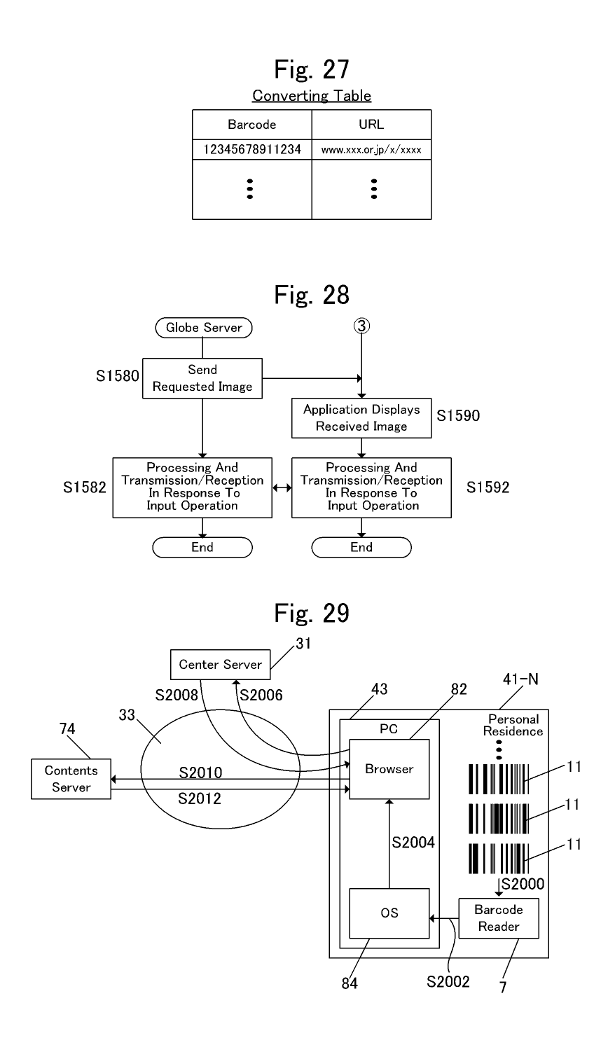

By the way, the programs and data segments are stored in the storage area 200 of the center server 31 in the same fashion as the application example 3 (see FIGS. 16 and 6(b)). In this case, the control program 174-1 of the program storing section 172 of FIG. 16 performs the processing for the application example 5. Further, in the application example 5, the converting table of FIG. 27 as described below is stored in the storage area 200.

FIG. 26 is a flow chart for showing an example of the communication procedure among a contents server 72, the PC 43, and the center server 31 in the case of the application example 5. Meanwhile, since the process as shown in FIG. 26 is performed by the use of well-known protocols such as TCP/IP and HTTP, and therefore the details of the communication procedure will not be described. Also, the flowchart is shown with the assumption that the center server 31 has received the barcode 2520 in the second group 252 of the barcodes 11 (including the barcodes 2510 and 2520). Accordingly, the processes corresponding to the steps S430, S432, S434, S436 and S438 of FIG. 17 are omitted. Incidentally, the subsequent processes of the step S438 in the application example 5 are the same as those of the steps S306 and S308 of FIG. 7. In corresponding thereto, the processing of the PC 43 of the personal residence 41-N and the processing of the server 47 of the advertising client 45-M in accordance with the application example 5 in this case are the same as the processes of the steps S204 to S220, and the steps S100 and S102 of FIG. 7 respectively. Further, in this case, the processes of the PC 43 and the e-commerce server are the same as the processes shown in FIG. 8.

Referring to FIG. 26, in step S1530, the OS 84 of the PC 43 in the personal residence 41-N launches the browser 82 in response to the command given by the barcode reader 7. Then, in step S1532, the browser 82 accesses the center server 31 based on the URL given by the barcode reader 7 to transmit the URL (including the barcode information and the serial number 30) given by the barcode reader 7 to the center server 31. In this case, the processes of the barcode reader 7 before the PC 43 receives these information items are the same as the processes of the steps S1 to S11 of FIG. 3, and therefore the description is omitted. Incidentally, the ROM 19 of the barcode reader 7 stores the URL 27 of the center server 31.

The communication control unit 212 of the center server 31 receives the URL including the barcode information and the serial number 30. And, in step S1560, the control program 174-1 of the center server 31 accesses the converting table of FIG. 27 stored in the HDD 56 with the received barcode information as an index to retrieve the URL corresponding thereto. The process of the step S1560 corresponds to the process of the step S440 of FIG. 17.

As shown in FIG. 27, the converting table is a table in which the barcode information items are associated with the URLs. In this converting table, the URL associated with the barcode information designates the storage location of the controlling file (see FIG. 24) corresponding to the barcode information (i.e., the photograph 162). The controlling file is stored in a storage device (e.g., HDD) of the contents server 72.

Incidentally, in corresponding to the plurality of the groups each of which consists of the barcode information items in the second group, i.e., the plurality of the services, the plurality of the converting tables are stored in the center server 31. One of them is the converting table of FIG. 27. The flow charts of FIGS. 26 and 28 show the processes in the case where the center sever 31 receives the barcode information in the group which uses the converting table of FIG. 27. Incidentally, all the converting tables are tables in which the barcode information items are associated with the URLs.

Returning to FIG. 26, in step S1562, the communication control unit 212 of the center server 31 requests the browser 82 of the PC 43 to access the retrieved URL. The process of step S1562 corresponds to the process of step S442 of FIG. 17.

In step S1534, the browser 82 of the PC 43 accesses the contents server 72 designated by the URL received from the center server 31, and requests to transmit the controlling file designated by the URL. Then, in step S1570, the contents server 72 reads out the requested controlling file from the HDD, and transmits it to the PC 43.

Further then, when the browser 82 of the PC 43 receives the controlling file and sends it to the OS 84, in step S1536, the OS 84 launches the terrestrial globe application 86 associated with the suffix of the controlling file. And, in step S1538, the terrestrial globe application 86 requests the terrestrial globe server 80 to send the corresponding image data in accordance with the information described in the controlling file.

Then, in step S1580 of FIG. 28, the terrestrial globe server 80 stream-distributes the requested image data to the PC 43. Further then, in step S1590, the terrestrial globe application 86 displays the image corresponding to the received image data on the monitor.

In step S1592, the PC 43 performs the processing and communicates with the contents server 72 in response to the input of the user. In step S1582, the contents server 72 performs the processing and communicates with the PC 43 in response to the access of the PC 43.

By the way, as described above, in accordance with the application example 5, since the terrestrial globe application 86 installed in the communication terminal 5 can be launched through the network 33 in response to the scanning of the barcode 11, it is possible to expand the creation of the business model which employs the scanning of the barcodes 11 and the network 33.

Also, the communication terminal 5 can easily recognize the application program to be launched, i.e., the terrestrial globe application 86 only by recognizing the suffix of the controlling file.

Further, since the controlling file is related one-on-one to the barcode 11 (i.e., the photograph 162), it is easily possible to display the desired photograph 162 on the monitor by scan the barcode 11 printed below the desired photograph 162.

Still further, it is possible to control the result of the execution of the terrestrial globe application 86, i.e., the photograph of the place to be displayed on the monitor and the form of the display, by the content of the controlling file.

Still further, since the existing software (the browser and the OS) can launch and control the terrestrial globe application 86 without installing dedicated software, it is possible to improve the convenience of the user. Incidentally, in general, the browser and the operating system are installed in the most PCs 43.

Meanwhile, needless to say, the present example can be applied to launch and control of an application program installed in the computer 37 of the store 35-K as well as an application program installed in the PC 43 of the personal residence 41-N.

By the way, a certain icon (or button) may be displayed on the photograph displayed on the monitor 88 of FIG. 25. And, a certain window may be displayed by clicking the icon. For example, this window may include explanation of a point on which the icon is placed, and an image and a link related with the point. Also, voice may be outputted by clicking the icon.

A command for displaying the icon, a storage address (e.g., URL) of the image to be displayed in the window, the explanation to be displayed in the window, and a storage address (e.g., URL) of the voice data are written in the controlling file of FIG. 24 in advance.

### Application Example 6

Referring to FIG. 1, in the application example 6, the host computer 1 sequentially receive the plurality of the barcodes 11 which the local barcode reader 7 transmits through the terminal 5, transits state sequentially in accordance with the barcodes 11 as received sequentially, performs processing corresponding to the state after the transition, and transmits the result of the processing to the terminal 5.

In this way, since the processing is performed in accordance with the serial transitions caused by the barcodes 11 as received sequentially, it is possible to provide such service as one content defined by one barcode 11 relates to the next one content defined by the next one barcode 11. For the same reason, it is possible to provide such service as one content defined by the plurality of the barcodes 11 relates to the next one content defined by the plurality of next barcodes 11.

Also, for the same reason, it is possible to provide one content defined by the plurality of the barcodes 11. For, example, the host computer performs the processing in accordance with the combination or permutation of the plurality of the barcodes 11 as received sequentially, and sends the content as the result of the processing to the terminal 5.

FIG. 29 is an explanatory view for showing an application example 6. In this case, the center server 31 and the contents server 74 of FIG. 29 correspond to the host computer 1 of FIG. 1. The electrical configuration of the contents server 74 is the same as the electrical configuration of the center server 31 of FIG. 6(a).

Referring to FIG. 29, in step S2000, the barcode reader 7 scans and decodes the barcode pattern 11 in response to the manipulation of the user, and thereby obtains the barcode information designated by the barcode 11. In step S2002, the operating system (OS) 84 of the PC 43 receives the barcode information obtained by the barcode reader 7, and then, in step S2004, the operating system 84 sends it to the browser 82 of the PC 43. And, in step S2006, the browser 82 transmits the received barcode information to the center server 31 though the network 33.

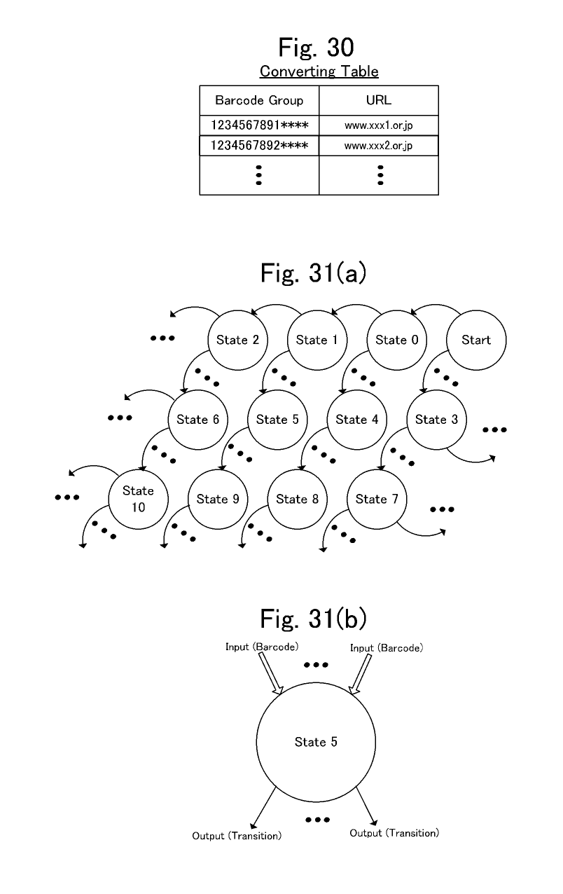

Then, in step S2008, the center server 31 accesses a converting table of FIG. 30 stored in the HDD 56 based on the received barcode information as the index, and thereby obtains the corresponding URL. As shown in FIG. 30, this converting table is a table in which the barcode information items are associated with the URLs. However, one group including the barcode information items is associated with one URL. Accordingly, the barcode information items belonging to the one group are associated with the same URL even if the contents thereof are different from one another. In the figure, for example, if barcode information items each of which consists of fourteen-digit number have the same upper ten digits, the barcode information items are classified into the same group. In this way, the each group is associated with the contents server by the URL corresponding thereto. In the present example, the barcode information items each of which consists of fourteen-digit number and has the upper ten digits “1234567891” are associated with the contents server 74 with assumption that the URL of the contents server 74 is the URL (www.xxx1.or.jp) placed on the first line of the converting table. In what follows, it is assumed that the upper ten digits of the barcode information received by the center server 31 are “1234567891”.

By the way, the center server 31 instructs the browser 82 to append the received barcode information to the URL acquired from the converting table and then access the URL. In step S2010, the browser 82 accesses the contents server 74 designated by the received URL. In this case, the barcode information appended to the URL is transmitted from the browser 82 to the contents server 74. Accordingly, in step S2012, the contents server 74 performs the processing according to the barcode information, and then transmits the content as the result of the processing to the browser 82. In response thereto, the browser 82 displays the received content.

In the application example 6, since the barcode patterns 11 are sequentially scanned (step S2000), the contents server 74 sequentially receives the barcode information items (step S2010). In this case, as shown in FIGS. 31(a) and 31(b), the internal state of the contents server 74 is transited to the other state (output) by the contents server 74 on the basis of the received barcode information (input) as the condition for transiting the state, and thereby the contents server 74 generates the content in accordance with the state after transition. In this way, the contents server 74 has a function as a state machine.

And, the contents server 74 transmits the corresponding content to the browser 82 each time the state is transited. In this case, by giving relevance among the contents corresponding to the respective states, it is possible to provide the plurality of the serial contents having relevance to one another to the PC 43, i.e., the user by sequentially scanning the barcode patterns 10. Furthermore, since the state after the transition differs depending on the barcode information designated by the barcode pattern 11, it is possible to provide not uniformed contents but various contents. For example, it is possible to include a story to the contents.

Also, the contents server 74 may transmit the content to the browser 82 when the predetermined number of times of state transitions (2 or larger integer) are caused. In this case, the content corresponding to the latest state when the predetermined number of times of the transitions have been caused may be sent to the browser 82, or the content corresponding to the history when the predetermined number of times of the transitions have been caused may be sent to the browser 82. For example, a single content is defined by the combination or permutation of the prescribed number of the barcode information items (=the above predetermined number of times).

Meanwhile, the state transition of FIG. 31 is just an example, and therefore it may be set arbitrarily that to which state a state transition is made by what barcode. Needless to say, the barcode which instructs to transit to the same state may be set.

Incidentally, in FIG. 31(b), the arrows (white) of the inputs (barcodes) and the arrows (black) of the outputs (transitions) are shown by focusing on the state “5” in order to describe the input and output in detail. However, in FIG. 31(a), the arrows (white) of the inputs (barcodes) are omitted, and only the arrows (black) of the outputs (transitions) are shown.

Referring to FIG. 31(b), it is assumed that a current internal state is the state “5”. In this case, the internal state of the content server 74 transits from the state “5” to any one of the plurality of the other states depending on the barcode 11 which is inputted.

The barcode 11 to be input may be a barcode sent from a barcode reader 7 of a specific user, or a barcode sent from a barcode reader 7 of an arbitrary user. That is, in all internal states to which can be transited, the barcode to be input may be a barcode sent from the barcode reader 7 of the specific user, or a barcode to be input in one internal state and a barcode to be input in the other internal state may be sent from different barcode readers of different users.

Also, the contents server 74 may have a single internal state in common with all the users. In this case, the content may be produced in accordance with the final internal state after the state transitions of all the users, i.e., after the inputs of the barcodes from all the users (parallel inputs), or the content may be produced in accordance with the state transition each time the state transition of one user is made, i.e., each time the barcode is input by the one user (serial inputs). In this way, the inputs to the single internal state may be the serial inputs or the parallel inputs.

On the other hand, the contents server 74 may have the internal state for each user. In this case, the content may be individually produced in accordance with each state for each user, or the content may be produced in common with the users in accordance with the combination or permutation of the internal states corresponding to the respective users. In the case where the content is produced in common with the users in accordance with the combination or permutation of the internal states corresponding to the respective users, the content may be produced after the state transitions of all the users, i.e., after the inputs of the barcodes from all the users (parallel inputs). Or, each time a state transition of one user is made, i.e., each time the barcode is input by the one user (serial inputs), the content may be produced in accordance with the state after the state transition and the current (or past) state of the other user. In this way, the inputs to the one internal state may be the serial inputs or the parallel inputs.

By the way, the programs and data segments are stored in the storage area 200 of the center server 31 in the same fashion as the application example 3 (see FIGS. 16 and 6(b)). However, in the application example 6, a program storing section 172 shown in FIG. 16 stores the classifying program in place of the controlling programs 174-1 to 174-q. Also, in the application example 6, the storage area 200 stores the converting table of FIG. 30.

Next, the process flow will be explained with reference to a flow chart as necessary. The processing of the barcode reader 7 is the same as the steps S1 to S11 of FIG. 3, and therefore the description thereof is omitted. Incidentally, ROM 19 of the barcode reader 7 stores the URL 27 of the center server 31. Also, the processing after the PC 43 receives the barcode information from the barcode reader 7 is the same as the steps S1530 and S1532 of FIG. 26, and therefore the description thereof is omitted.

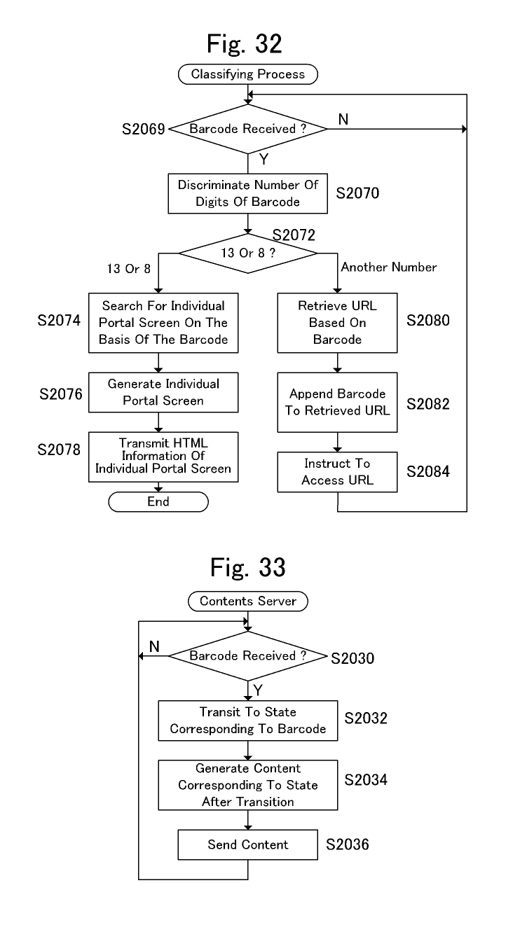

The center sever 31 receives the barcode information from the PC43, and executes the classifying process shown in FIG. 32 thereafter. Referring to FIG. 32, in step S2069, the center server 31 proceeds to step S2070 when the center server 31 receives the barcode information, and otherwise the center sever 74 returns to step S2069. In step S2070, the communication control unit 212 of the center server 31 discriminates the number of digits of the received barcode information. Then, in step S2072, the communication control unit 212 proceeds to step S2074 to give the control to the first individual portal screen search unit 214 when the number of digits of the received barcode information is 13 or 8, i.e., when the JAN code is received. On the other hand, the communication control unit 212 proceeds to step S2080 to give the control to the above classifying program when the number of digits of the received barcode information is not 13 nor 8.

In step S2074, the first individual portal screen search unit 214 accesses the first individual portal screen file 230 to retrieve the URL associated with the received barcode information (see FIG. 6(c)). Then, in step S2076, the individual portal screen generation unit 215 generates the HTML information for displaying the first individual portal screen 100 on the PC 43 in the personal residence 41-N. The first individual portal screen 100 includes the link button corresponding to the URL acquired in step S2074. In step S2078, the communication control unit 121 of the center server 31 transmits the HTML information as generated in step S2076 to the PC 43 in the personal residence 41-N.

Incidentally, the subsequent processes of the step S2078 in the application example 6 are the same as those of the steps S306 and S308 of FIG. 7. In corresponding thereto, the processing of the PC 43 of the personal residence 41-N and the processing of the server 47 of the advertising client 45-M in accordance with the application example 6 in this case are the same as the processes of the steps S204 to S220, and the steps S100 and S102 of FIG. 7 respectively. Further, in this case, the processes of the PC 43 and the e-commerce server are the same as the processes shown in FIG. 8.

By the way, on the other hand, in step S2080, the classifying program of the center server 31 accesses the converting table of FIG. 30 with the received barcode information as the index to acquire the URL corresponding thereto. Then, in step S2082, the classifying program appends the barcode information to the acquired URL. Further, in step S2084, the communication control unit 212 instructs the PC 43 to access the URL to which the barcode information is appended. Then, the process proceeds to step S2069. Incidentally, in what follows, the description will proceed with the assumption that the center server 31 receives the barcode information associated with the URL designating the contents server 74.

The PC 43 accesses the contents server 74 addressed by the instructed URL in response to the instruction of the center server 31. In this case, the URL to which the barcode information is appended is sent to the contents server 74.

Then, as shown in FIG. 33, in step S2030, the contents server 74 receives the URL, i.e., the barcode information, and proceeds to step S2032, and otherwise returns to step S2030. In step S2032, the contents server 74 transits the internal state to the state corresponding to the barcode information (see FIG. 31). In step S2034, the contents server 74 generates the content corresponding to the state after the transition. And, in step S2036, the contents server 74 transmits the content to the PC 43. Then, the process proceeds to step S2030. The PC 43 receives the content as transmitted by the contents server 74 to display the monitor.

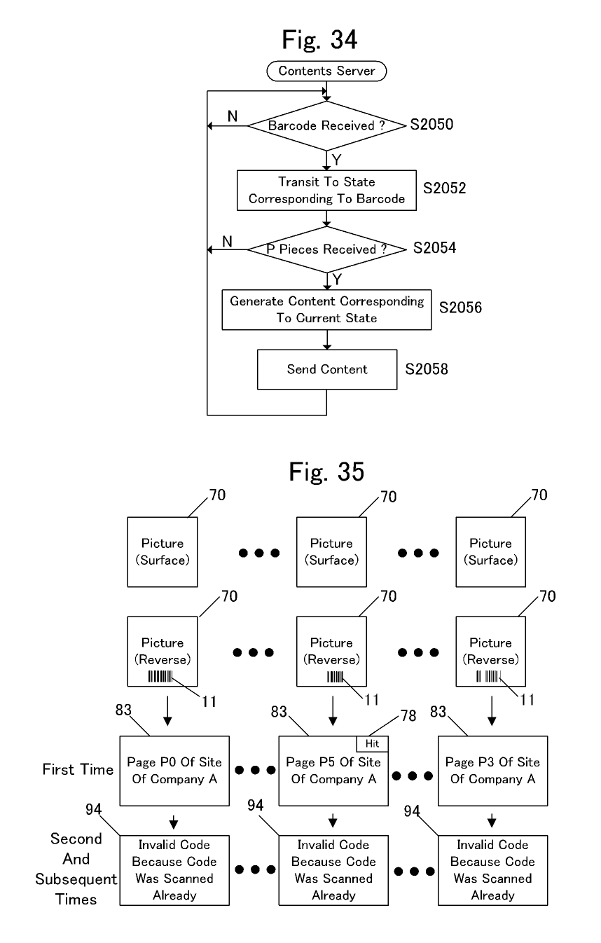

Also, the contents server 74 may execute the processing of FIG. 34 in place of the processing of FIG. 33. Referring to FIG. 34, in step S2050, the contents server 74 proceeds to step S2052 when the contents server 74 receives the URL, i.e., the barcode information, and otherwise the center server 74 returns to step S2050. In step S2052, the contents server 74 transits the internal state to the state corresponding to the barcode information (see FIG. 31). In step S2054, the contents server 74 determines whether or not P (2 or larger integer) pieces of the barcode information items are received, the process proceeds to step S2056 if they are received, conversely the process returns to step S2050 if they are not received.

In step S2056, the contents server 74 generates the content corresponding to the current state. And, in step S2058, the contents server 74 transmits the content to the PC 43. Then, the process returns to step S2050. The PC 43 receives the content transmitted by the contents server 74 to display on the monitor. Incidentally, the content corresponding to the history of the past state transitions may be generated in step S2056.

The processing of FIG. 34 is an example of processing of the contents server 74 when the contents server 74 executes the processing in accordance with the combination or permutation of the plurality of the barcodes as received sequentially and transmits the content as the execution result to the terminal 5.

By the way, as described above, in accordance with the application example 6, since the contents server 74 performs the processing in accordance with the serial state transitions caused by the barcodes 11 as received sequentially, it is possible to provide such service as one content defined by one barcode 11 relates to the next one content defined by the next one barcode 11 (This processing corresponds to the processing of FIG. 33). Also, for the same reason, it is possible to provide one content defined by the plurality of the barcodes 11 (This processing corresponds to the processing of FIG. 34). That is, since the processing is performed in accordance with the combination or permutation of the plurality of the barcodes 11, it is possible to provide one content defined by the plurality of the barcodes 11. In comparison with the case where one barcode 11 corresponds to one content, it is possible to provide various contents by less barcodes, and it is possible to provide the user with the amusement different therefrom because the use can not anticipate or is difficult to anticipate what content is provided. Also, for the same reason, it is possible to provide such service as one content defined by the plurality of the barcodes 11 relates to the next one content defined by the plurality of the next barcodes 11.

Further, since the state transition is made in accordance with the barcodes 11 inputted by the plurality of the users, it is possible to enjoy the content while influencing to one another among the plurality of the users. For example, the application example 6 may be applied to an online game (network game). Referring to FIG. 29, it is assumed that the first user of the personal residence 41-1 and the second user of the personal residence 41-2 login to an online game. In this case, the contents server 74 sequentially receives the barcode 11 inputted from the barcode reader of the first user and the barcode 11 from the barcode reader of the second user, transits the internal state, generates the content (the result of the game) in accordance with the state after transition, and sends to the PCs 43 of the first user and the second user.

### Application Example 7

Although the application example 7 to be described below can be realized by various techniques, in what follows, the example, in which the application example 7 is realized by using the above application example 6, is cited. Accordingly, the application example 7 employs the system configuration of FIG. 29.

By the way, many people now request a specialty shop to print an image captured by a digital camera, or develop, print, and enlarge a film obtained by a still camera (development, printing, and enlargement). In the application example 7, this specialty shop prints a barcode 11 on a picture to be printed. In this case, the group to which the barcode 11 to be printed belongs is the second group of FIG. 15, and each barcode 11 is unique. When the user which requests the specialty shop to print the pictures scans the barcode 11 printed on the picture with the barcode reader 7, an WEB page from the contents server 74 is displays on the PC 43.

The WEB page as displayed by scanning the barcode 11 may be a hit page, and thereby the user can get a prize. This prize makes all charges for printing pictures next time free. The WEB page to be displayed by scanning is a page in an WEB site of a sponsor, and this sponsor bears the prize, i.e., the charges for printing the pictures. Thus, it is possible to remove an economic load of the user when the user requests the specialty shop to print the pictures.

Also, since the user scans the barcode 11 actively so as to get the prize, the user views the WEB site of the sponsor surely, and thus the sponsor can lead the user into its WEB site effectively. Furthermore, since the user is available a free printing, the user is supposed to request the specialty shop which prints such barcode 11 on the picture to print more, and thereby it is anticipated to increase in sales for such specialty shop in comparison with a general specialty shop.

FIG. 35 is an explanatory view for showing an application example 7. Referring to FIG. 35, it is assumed that the user of the barcode reader 7 requests the specialty shop to print the images captured by the digital camera, and thereby the P pieces of the pictures 70 are produced. The captured image is printed on the surface of each picture 70 while the unique barcode 11 is printed on the reverse side thereof. It is assumed that a company “A” which is a sponsor provides the prize.

When the barcode reader 7 scans the barcode 11 of the first picture 70 in response to the manipulation of the user, the barcode 11 is sent to the contents server 74 of the company “A” through the center server 31, and then the contents server 74 sends the page P0 of the WEB site of the company “A” to the PC 43. Thus, the PC 43 displays the page P0 of the company “A”. Further, When the barcode 11 of the p-th picture 70 is scanned, the barcode 11 is sent to the contents server 74 of the company “A” through the center server 31, and then the contents server 74 sends the page P5 of the WEB site of the company “A” to the PC 43. Thus, the PC 43 displays the page P5 of the company “A”. Since this page P5 includes the hit icon 78, the user can request to print the pictures without charge by presenting the barcode 11 when the user requests the specialty shop which printed the barcode 11 on the picture to print next time. When the barcode 11 of the last P-th picture 70 is scanned, the barcode 11 is sent to the contents server 74 of the company “A” through the center server 31, and then the contents server 74 sends the page P3 of the WEB site of the company “A” to the PC 43. Thus, the PC 43 displays the page P3 of the company “A”.

The contents server 74 determines that the contents server 74 transmits which page of the WEB site 83 in accordance with the barcode information as received. Also, the contents server 74 generates the hit page which includes the hit icon 78 with a predetermined probability.

If the barcode 11 of the same picture is scanned again, the center server 31 sends the message which indicates to be invalid due to have been scanned already to the PC 43. That is, in the application example 7, the barcode 11 can be used only one time.

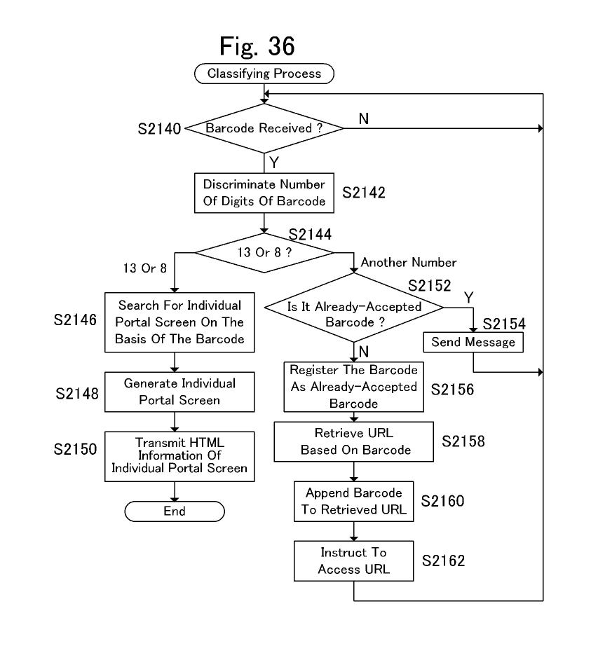

Next, the processing of the center server 31 in accordance with the application example 7 will be described. In this case, it is assumed that the center server 31 receives the barcode 11 printed on the picture 70. After the center server 31 receives the barcode 11 from the PC 43, the center server 31 performs the classifying processing shown in FIG. 36. Referring to FIG. 36, in step S2140, the center server 31 proceeds to step S2142 if the center server 31 receives the barcode 11, otherwise returns to step S2140. In step S2142, the communication control unit 212 of the center server 31 determines the number of digits of the received barcode 11. Then, in step S2144, when the number of digits of the received barcode 11 is 13 or 8, i.e., when a JAN code is received, the communication control unit 212 proceeds to step S2146 by giving control to the first individual portal screen search unit 214. Conversely, when the number of digits of the received barcode is not 13 nor 8, the process proceeds to step S2152 by giving control to the classifying program of the application example 6 as described above.

The processes of the steps S2146, S2148 and S2150 are the same as the processes of the steps S2074, S2076 and S2078 of FIG. 32 respectively, and therefore the description thereof is omitted.

On the other hand, in step S2152, the classifying program determines whether or not the received barcode 11 is the barcode which has been accepted already with reference to a database in which the barcode 11 as already accepted is registered (hereinafter referred to as “acceptance registration database”), if it is the barcode 11 which has been accepted, the process proceeds to step S2154. Then, the communication control unit 212 sends the message 94 of FIG. 35 to the PC 43, and proceeds to step S2140. The classifying program proceeds to step S2156 if the received barcode 11 is the barcode 11 which has not been accepted yet.

In step S2156, the classifying program registers the received barcode 11 into the acceptance register database as a barcode which has been already accepted. And, in step S2158, the classifying program in the center server 31 accesses the converting table of FIG. 30 with the received barcode 11 as an index to acquire the URL corresponding thereto. Then, in step S2160, the classifying program appends the barcode 11 to the acquired URL. Further, in step S2162, the communication control unit 212 instructs the PC 43 to access the URL to which the barcode 11 is appended. Then, the process proceeds to step S2140. Incidentally, in what follows, the description will be made with the assumption that the center server 31 has received the barcode 11 associated with the URL indicating the contents server 74.

The PC 43 responds the instruction of the center server 31, and accesses the contents server 74 indicated by the instructed URL. In this case, the URL to which the barcode 11 is appended is sent the contents server 74.

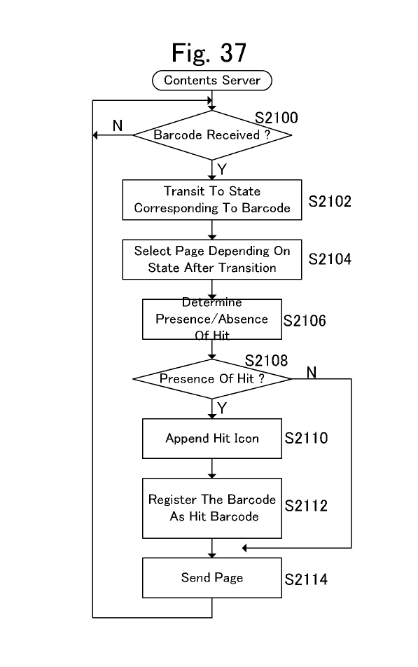

Then, as shown in FIG. 37, the contents server 74 receives the URL, i.e., the barcode 11 in step S2100, and then proceeds to step S2102, otherwise returns to step S2100. In step S2102, the contents server 74 transits the internal state to the state corresponding to the barcode 11 (see FIG. 31). In step S2104, the contents server 74 selects the WEB page corresponding to the state after transition. Besides, the respective internal states are associated with the WEB pages.

In step S2106, the contents server 74 determines whether or not to include the hit icon 78 in the selected WEB page. In step S2108, the contents server 74 proceeds to step S2110 if the hit icon 78 is included, conversely the process proceeds to step S2114 directly if the hit icon 78 is not included. In step S2110, the contents server 74 includes the hit icon 78 in the selected WEB page. Then, in step S2112, the contents server 74 registers the barcode 11 into a database (hereinafter referred to as a “hit registration database”) as a hit barcode.

In step S2114, the contents server 74 transmits the selected WEB page to the PC 43. Then, the process returns to step S2100. The PC 43 receives the WEB page transmitted by the contents server 74 to display on the monitor.

Next, another example of the processing of the contents server 74 will be described. In this case, the classifying process of the center server 31 is the same as the classifying process of FIG. 32.

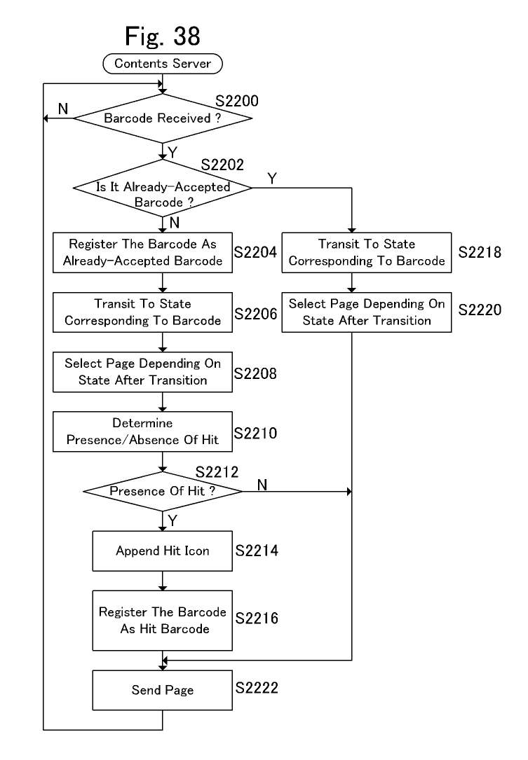

FIG. 38 is a flow chart for showing another example of the processing of the contents server 74 in the case of the application example 7. Referring to FIG. 38, the contents server 74 receives the URL, i.e., the barcode 11 in step S2200 to proceeds to step S2202, otherwise returns to step S2200.

In step S2202, the contents server 74 determines whether or not the received barcode 11 is a barcode which has been accepted already with reference to a database in which the barcode 11 as already accepted is registered (hereinafter referred to as a “acceptance registration database”), the process proceeds to step S2218 if it is the barcode 11 as accepted already, conversely the process proceeds to step S2204 if it is the barcode which has not been accepted yet.

In step S2218, the contents server 74 transits the internal state to the state corresponding to the barcode 11 (see FIG. 31). In step S2220, the contents server 74 selects the WEB page corresponding to the state after transition, and then proceeds to step S2222.

On the other hand, in step S2204, the contents server 74 registers the received barcode 11 as a barcode which has already been accepted into the acceptance registration database. In step S2206, the contents server 74 transits the internal state to the state corresponding to the barcode 11 (see FIG. 31). In step S2208, the contents server 74 selects the WEB page corresponding to the state after transition.

In step S2210, the contents server 74 determines whether or not to include the hit icon 78 in the selected WEB page. In step S2212, the contents server 74 proceeds to step S2114 if the hit icon 78 is included, conversely the process proceeds to step S2222 directly if the hit icon 78 is not included. In step S2214, the contents server 74 includes the hit icon 78 in the selected WEB page. Then, in step S2216, the contents server 74 registers the barcode 11 into a database (hereinafter referred to as a “hit registration database”) as a hit barcode.

In step S2222, the contents server 74 transmits the selected WEB page to the PC 43. Then, the process returns to step S2200. The PC 43 receives the WEB page transmitted by the contents server 74 to display on the monitor.

By the way, in the application example 7, the advertisement support corporation, which manages the center server 31, issues the barcodes 11. Accordingly, this advertisement support corporation can get paid for the barcodes 11 from the company “A”, which manages the WEB site 83. That is, the printing expense (a prize) to be paid to the specialty shop and the price to be paid to the advertisement support corporation are the advertising expenses for the company “A”, which is a sponsor.

By the way, as described above, in accordance with the application example 7, the user of the barcode reader 7 can get the prize by scanning the barcode 11. Accordingly, it is anticipated that the user scans many barcodes 11 in order to get the prize. That is, the prize creates incentive to scan many barcodes 11. Eventually, the user views the sent WEB page each time he/she is performed the scanning. Thus, a host of a site having the WEB page to be sent can lead the user into its own page effectively.

Peculiarly, in the above example, since the barcode 11 with the prize is printed in the picture 70 which is printed by the specialty shop, it is possible to attract more customers to the specialty shop which prints such a barcode 11.

Also, in the application example 7, the barcode 11 can be used only once. Thus, it is possible to prevent unfair access which the host of the WEB site 83 wants to preclude. For example, if the same barcode 11 can be scanned any number of times and thereby the prize is gotten, it is concerned about the possible appearance of a person who gets the prize without looking at the WEB site 83 by producing a program for sending the barcode 11 repeatedly to the center server 31. Such a case must be precluded because the host of the WEB site 83 offers the prize for the purpose of having its own WEB site 83 looked at by the user.

### Application Example 8

In the application example 8, an example, in which a personal computer (PC) 361 is used as the stationary terminal 5f of FIG. 1 and a BC mouse 363 is used instead of the local barcode reader 7, will be described.

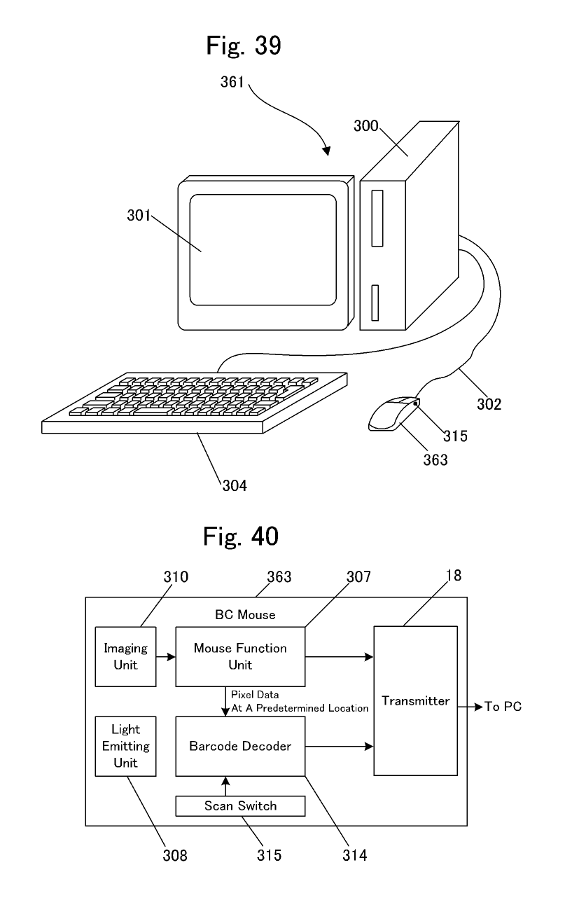

FIG. 39 is a perspective external view for showing the PC 361 and the BC mouse 363. Referring to FIG. 39, the PC 361 includes a computer unit 300, a monitor 301, a keyboard 304 and the BC mouse 363. The BC mouse 363 is coupled with the computer unit 300 of the PC 361 by a USB (Universal Serial Bus) cable 302. The BC mouse 363 is provided with a scan switch 315, which is continuously held down in scanning the barcode 11, on the side thereof.

FIG. 40 is a functional block diagram for showing the BC mouse 363 of FIG. 39. Referring to FIG. 40, the BC mouse 363 includes an imaging unit 310 having an image sensor (not shown in the figure), which photographs a surface to be photographed, a light emitting unit 308 having a light emitting diode (not shown in the figure), which emits light to the surface to be photographed, a mouse function unit 307, the scan switch 315, a barcode decoder 314, and a transmitter 18.

First, a function as an ordinary mouse will be described simply. The imaging unit 310 photographs the surface to be photographed, i.e., a surface under the BC mouse 363 in a predetermined period T, and sequentially outputs frame pictures as obtained to the mouse function unit 307. The mouse function unit 307 converts these frame pictures into digital data and stores them, and computes a moving direction and a moving amount of the BC mouse 363, i.e., operation information of the BC mouse 363 by comparing the same images (e.g., a specified pattern on a desk, which is the surface to be photographed) in the respective frame pictures. Then, the mouse function unit 307 outputs the operation information as computed to the transmitter 18. For example, the mouse function unit 307 may be formed from a DSP (Digital Signal Processor) and a program which makes the DSP execute the above processing.

Next, a function for reading a barcode will be described. When the user slides a bottom of the optical mouse 63 on the barcode 11 while holding the scan switch 315 down, the barcode 11 is read and then decoded. Meanwhile, the optical mouse 63 is provided with a photographing window for the image sensor of the imaging unit 310 in the bottom thereof. This point is similar to a ordinary optical mouse. The details are follows.

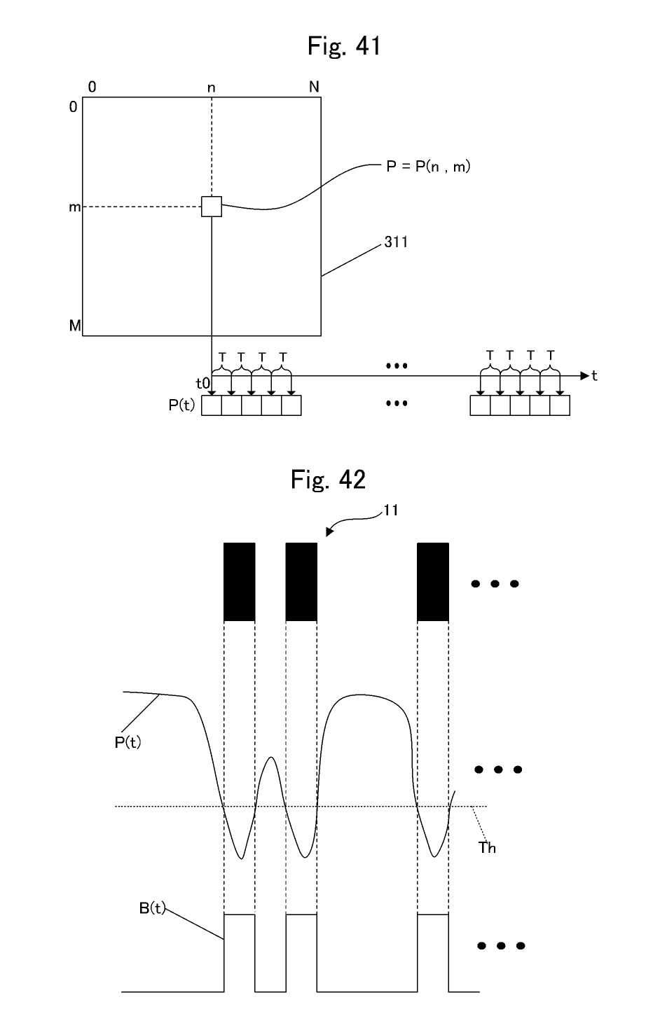

FIG. 41 is an explanatory view for showing a barcode reading method of the BC mouse 363 of FIG. 39. Referring to FIG. 41, it is assumed that a frame picture 311 outputted from the imaging unit 310 has been converted into the digital data. The image sensor of the imaging unit 310, i.e., the frame picture 311 consists of (N+1)*(M+1) of pixels. The mouse function unit 307 outputs pixel data P (n, m) at a predetermined location (n, m) to the barcode decoder 314 each time the frame picture 311 is acquired. That is, the mouse function unit 307 sequentially outputs the pixel data P (n, m) to the barcode decoder 314 in the imaging period T of the imaging unit 310. The references “n” and “m” represent constants respectively.

Meanwhile, the pixel data P(n,m), which is sequentially outputted, is referred to as “P(t)”. The variable “t” is a value of integral multiple of the imaging period T.

FIG. 42 is a view for showing examples of the barcode 11, the pixel data P(t) at the predetermined location (n, m) in the frame picture 311, and the binary data B (t) thereof. Referring to FIG. 42, level of the pixel data P (t) changes depending on a black-and-white pattern of the barcode 11. That is, level of brightness decreases when the pixel data P(t) represents a black bar, and conversely the level of the brightness increases when the pixel data P(t) represents a white spacing.

The barcode decoder 314 compares the pixel data P(t) as sequentially inputted with a predetermined threshold value Th to obtain the binary data B (t). That is, the barcode decoder 314 determines that the pixel data P(t) represents the white spacing when the pixel data P(t) exceeds the predetermined threshold value Th, and sets the binary data B(t) of the pixel data P(t) to “0”. On the other hand, the barcode decoder 314 determines that the pixel data P(t) represents the black bar when the pixel data P(t) is the predetermined threshold value Th or less, and sets the binary data B(t) of the pixel data P(t) to “1”.

In this way, the barcode decoder 314 binarizes the pixel data P(t) as sequentially inputted, and decodes the barcode 11 based on the obtained data B(t) by means of a known decoding technique. Then, the barcode decoder 314 converts the result of the decoding, i.e., the barcode information into the keyboard data and then outputs it to the transmitter 18. Also, the barcode decoder 314 outputs the command, which is used to instruct the PC 61 to run a browser and transmit the barcode information to the host computer 1, as the keyboard data to the transmitter 318. However, when the barcode 11 is scanned under a condition where the user keeps holding the scan switch 315 down, the barcode decoder 314 performs the decoding process and the command issuing process. For example, the barcode decoder 314 may be formed from an MCU (Micro Controller Unit) and a program which has the MCU execute the above processing.

The transmitter 18 selectively transmits the operation information as sent from the mouse function unit 307 and the keyboard data as sent from the barcode decoder 314 to the PC 361 in accordance with a request of the PC 61. For example, the transmitter 18 may be formed from a USB controller.

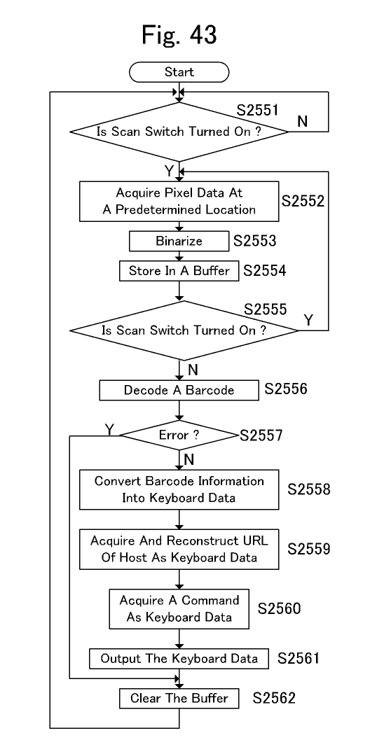

FIG. 43 is a flowchart for showing an example of the process of the barcode decoder 314 of FIG. 40. Referring to FIG. 43, in step S2551, the barcode decoder 314 determines whether or not the scan switch 315 is turned on, the process returns to step S2551 if OFF, and conversely the process proceeds to step S2552 if ON.

In step S2552, the barcode decoder 314 receives the pixel data P(t) at the predetermined location (n, m) from the mouse function unit 307. In step S2553, the barcode decoder 314 compares the pixel data P(t) with the predetermined threshold value Th to binarize the pixel data P(t), and whereby obtains the binary data B(t). In step S2554, the barcode decoder 314 stores the binary data B(t) in a buffer.

In step S2555, the barcode decoder 314 determines whether or not the scan switch 315 is turned on, if ON, since it represents that the scan is being performed, the process returns to step S2552, and conversely if OFF, since it represents that the scan has been completed, the process proceeds to step S2556. In step S2556, the barcode decoder 314 decodes the binary data B(t) as stored in the above buffer based on the known barcode decode technique.

When the barcode decoder 314 determines in the step S2557 that the decode of the barcode 11 has not been completed correctly, the barcode decoder 314 proceeds to step S2562 to clear the above buffer and then returns to step S2551. On the other hand, when the barcode decoder 314 determines that the decode of the barcode 11 has been completed correctly, the barcode decoder 314 proceeds to step S2558.

In step S2558, the barcode decoder 314 converts the barcode information as the decoding result into keyboard data and stores it in a RAM (not shown in the figure). Then, in step S2559, the barcode decoder 314 acquires URL of the host computer 1 (for example, “http://www.ssd.co.jp”) from a ROM (not shown in the figure) as keyboard data, appends the barcode information (for example, “4560256580016”) as keyboard data to the end of the URL, and stores it in the RAM (not shown in the figure) as a new URL (for example, “http://www.ssd.co.jp/?bc=4560256580016”).

In step S2560, the barcode decoder 314 acquires a command from the ROM (not shown in the figure) in the form of keyboard data which instructs the PC 61 to launch the browser and access the host computer 1, and stores the command in the RAM (not shown in the figure). The barcode decoder 314 outputs the keyboard data (the command and the URL) as obtained in steps S2559 and S2560 to the transmitter 18 in step S2561, clears the above buffer in step S2562, and then returns to step S2551.

By the way, as has been discussed above, it is possible to further improve the convenience of the user by implementing the barcode reading function in the optical mouse. That is, since the PC 361 automatically transmits the barcode information to the host computer 1 in response to the command from the BC mouse 363 only by scanning the barcode 11 attached to a commodity using the BC mouse 363, the user can receive service in accordance with the barcode 11 from the host computer 1, without need for cumbersome operation performed by the user (the PC 361 need not be manipulated). In addition, since the PC 361 performs processing required for realizing the present system in response to the command from the BC mouse 363, it is possible to save the user from the trouble of installing a new program in the PC 361 and so forth.

Needless to say, the BC mouse 363 serves also as a pointing device. Accordingly, the user can manipulate the PC 361 only by operating the BC mouse 363 after scanning the barcode 11 by the BC mouse 363, and whereby the structure is very user-friendly.

Also, In spite of the implementation of the imaging unit 310, the barcode 11 is decoded based on the pixel data which is located at the predetermined location and is temporally continuous, without using image analysis which decodes the barcode 11 based on the image of the barcode 11 in the obtained picture. Thus, the optical mouse based on the radically novel barcode reading method, which is nonconventional, is realized.

### Application Example 9

Barcodes whose purposes are novel and a system for providing them will be described as the application example 9. The novel barcodes is applied to the remote barcode reader system of FIG. 1 as well as the barcodes 11.

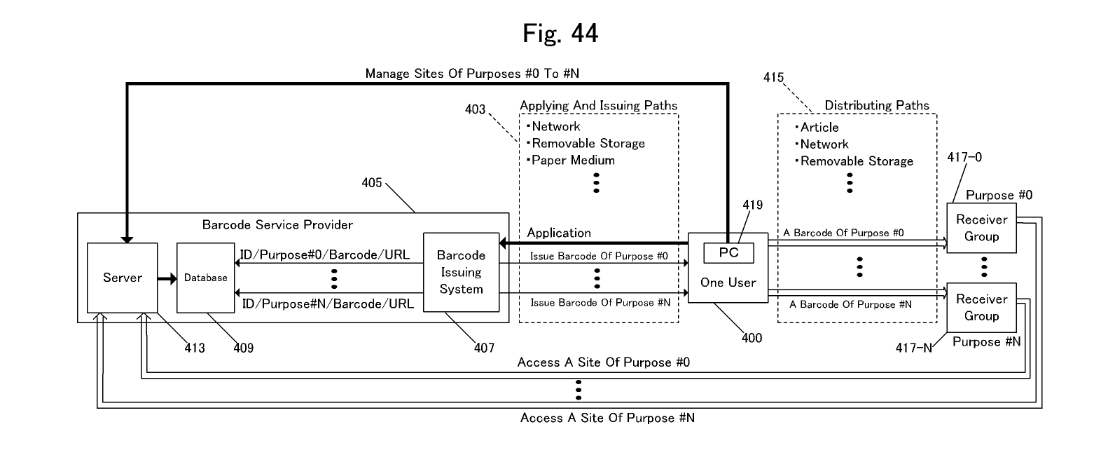

FIG. 44 is a schematic representation of a business model realized by a barcode service providing system in accordance with the application example 9. Referring to FIG. 44, a certain user 400 applies for a barcode service with a barcode service provider 405. The user 400 is an individual, an enterprise, a store, and so on.

Then, a barcode issuing system 407 assigns a unique barcode 431 to the user 400 and provides it to the user 400. In this case, the user 400 can apply for issuing a plurality of kinds of barcodes 431, and it is not limited to one kind. That is, the user 400 can apply for issuing the different barcode 431 for each purpose #0 to #N (N is an Integer). In this case, the barcode issuing system 407 issues the different barcode 431 for each purpose #0 to #N. When there is no need to distinguish the purposes #0 to #N, the term “purpose #n” is simply used.

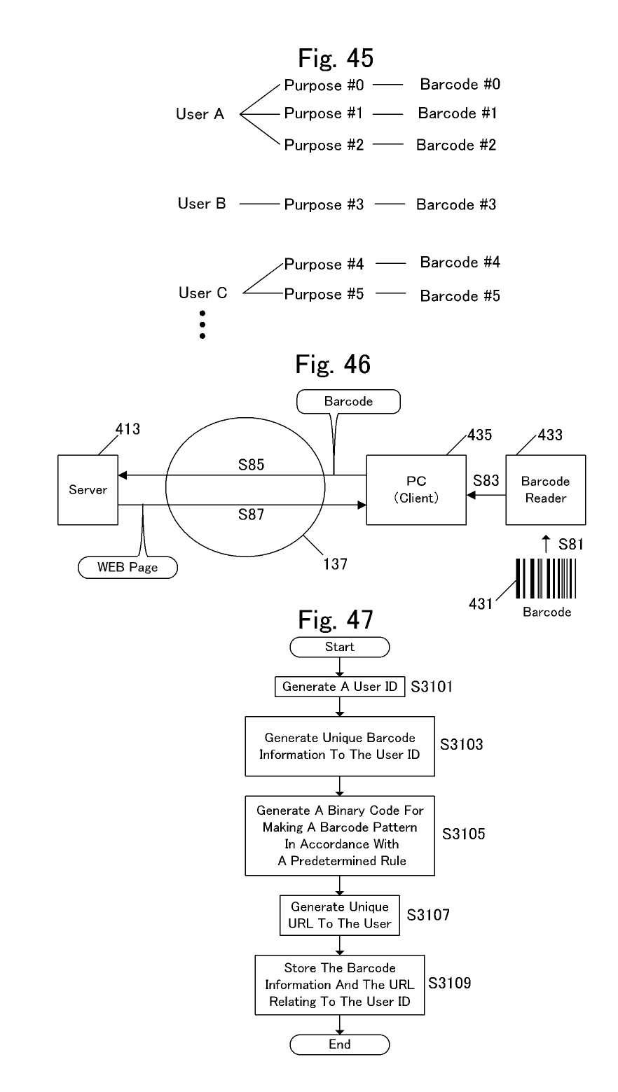

FIG. 45 is an explanatory view of barcode assignment in accordance with the application example 9. Referring to FIG. 45, the barcodes 431 (#0, are assigned to not articles as in the prior art but the users 400 (A, . . . ). Accordingly, the user 400 can attach the barcodes 431 to desired various articles even if the barcodes 431 are the same. In addition, if the user 400 has a plurality of kinds of the barcodes 431, the user 400 can use the different barcodes 431 for different purposes. Needless to say, in this case, the same barcodes 431 may be attached to the desired various articles.

Returning to FIG. 44, paths 403 for applying for and/or issuing the barcode may be optionally determined between the barcode service provider 405 and the user 400. Examples of the path of the application by the user 400 include applying via a network such as Internet, sending an application form by post or the like, and so on. Also, examples of the path (i.e., providing path) for issuing the barcode 431 by the barcode service provider 405 include providing the barcode 431 via a network such as Internet, providing a removable storage such as CD-ROM and a floppy disk which store the barcode 431, and providing a paper medium such as a decal on which the barcode 431 is printed.

When the barcode issuing system 407 issues the barcode 431 to the user 400, the barcode issuing system 407 relates the barcode 431 to a URL (Uniform Resource Locator) for each pair of the user 400 and the purpose #n, and stores them in a URL reference file of a data base 409. That is, the barcode issuing system 407 assigns the URL to each pair of the user 400 and the purpose #n. Because of this, a directory is assigned to each pair of the user 400 and the purpose #n in a server 413. Incidentally, the URL consists of a protocol, a host name, a directory, and a file name and so on.

The user 400 accesses the server 413 using a personal computer (PC) 419 to make and/or update an HTML file in the directory which is assigned to each purpose #n (i.e., each barcode 431), i.e., make and/or update contents for each purpose, and thus manages a WEB site for each purpose #n.

On the other hand, the user 400 distributes the different barcodes 431 for the respective purposes #0 to #N to receiver groups 417-0 to 417-N each of which includes a single receiver or a plurality of receivers. When there is no need to distinguish the receiver groups 417-0 to 417-N, the term “receiver group 417-n” is simply used. For example, the user 400 distributes the barcodes 431 corresponding to the purpose #0 to the receiver group 417-0 for the purpose #0 (private business), and distributes the barcodes 431 corresponding to the purpose #1 to the receiver group 417-1 for the purpose #1 (company business).

A path 415 for distributing the barcodes 431 by the user 400 may be optionally determined. For example, the user 400 can attach the barcodes 431 to the desired various articles (including electrical information such as software, image data, and audio data, and a paper medium such as a magazine, a visiting card, a postal card, a catalogue, and a advertising leaflet) and then distribute the barcodes 431 together with the articles. For example, the user 400 can store the barcodes 431 in removable storages and then distribute the barcodes 431 together with the removable storages. For example, the user 400 can distribute the barcodes 431 via E-mail. For example, the user 400 can distribute the barcodes 431 through a WEB site.

The receiver in the receiver group 417-n, to which the barcode 431 corresponding to the purpose #n is distributed by the user 400, accesses the server 413 based on the barcode 431 corresponding to the purpose #n to visit a WEB site assigned to the barcode 431 corresponding to the purpose #n. As the result, the receiver can easily acquire information which the user 400 delivers.

FIG. 46 is a schematic view for showing the communication procedure between the receiver group 417-n and the server 413 of the barcode service provider 405 of FIG. 44. Referring to FIG. 46, it is assumed that the receiver in the receiver group 417-n of FIG. 44 owns the personal computer (PC) 435 and the barcode reader 433 coupled therewith. Incidentally, the PC 435 may be referred to as a client 435. In step S81, the receiver operates the barcode reader 433 to scan the barcode 431 as distributed. Then, the barcode reader 433 decodes the barcode 431 to obtain a character string represented by the barcode 431, i.e., the barcode information.

In step S83, the barcode reader 433 outputs the barcode information, which is the result of the decoding, as keyboard data to the PC 435. The PC 435 receives the barcode information as the keyboard data as outputted from the barcode reader 433, and then transmits it to the server 413 of the barcode service provider 405 through the network 137 in step S85. In this case, the PC 435 launches a browser in response to the command as the keyboard data as sent from the barcode reader 433 to transmit the barcode information. Accordingly, it is not acquired for the PC 435 to install dedicated software.

In step S87, the server 413 transmits information for displaying a WEB page corresponding to the barcode information as received from the PC 435 to the PC 435 through the network 137. Then, the PC 435 displays the WEB page based on the information as received.

Incidentally, the sever 413 corresponds to the host computer 1 of FIG. 1, the PC 435 corresponds to the terminal 5 of FIG. 1, the barcode reader 433 corresponds to the local barcode reader 7 of FIG. 1, and the network 137 corresponds to Internet 3 of FIG. 1.

FIG. 47 is a flow chart for showing the process of issuing the barcode by the barcode issuing system 407 of FIG. 44. Referring to FIG. 47, the barcode issuing system 407 generates user identification information (user ID) in step S3101. In step S3103, the barcode issuing system 407 generates the unique barcode information (character string) to the generated user ID. In step S3105, the barcode issuing system 407 generates a binary code for making a barcode pattern 431, which represents the barcode information, in accordance with a predetermined rule. In step S3107, the barcode issuing system 407 generates a unique URL to the user ID, i.e., the generated barcode information. In step S3109, the barcode issuing system relates the barcode information and the URL to the user ID, and stores them in the URL reference file of the data base 409.

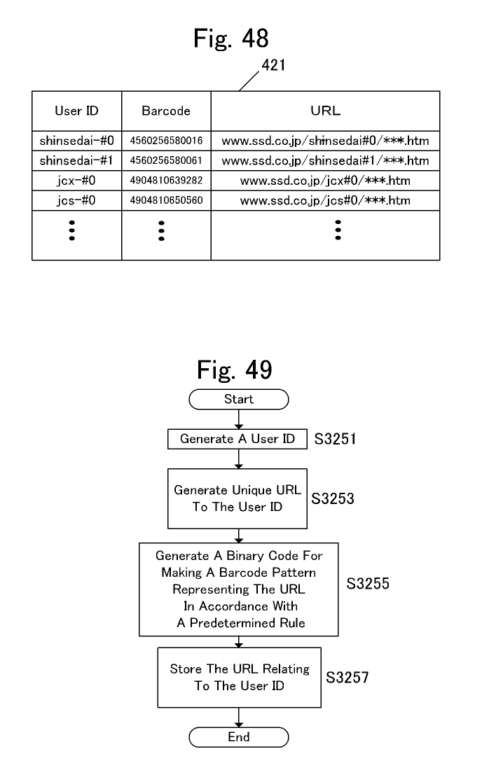

FIG. 48 is a schematic representation of the URL reference file 421 stored in the data base 409 of FIG. 44. Referring to FIG. 48, the URL reference file 421 is a table in which the user IDs, the barcodes 431, and the URLs are related to one another. In this example, the user ID includes the information of the purpose #n. That is, the user ID includes a user identification section and a purpose identification section as hyphenated.

Meanwhile, the communication procedure among the barcode reader 433, the client 435, and the server 413 is the same as the communication procedure among the local barcode reader 7, the terminal 5, and the host computer 1 shown in FIG. 3. In this case, in step S31, the server 413 accesses the data base 409, and refers to the URL reference file 421 to retrieve the URL (see FIG. 48) related to the received barcode 431. Then, in step S33, the server 413 transmits the URL acquired in step S31 to the client 435. Then, in step S25, the client 435 accesses the server 413 based on the received URL to display the WEB page.

Next, a modification of the barcode issuing system 407 will be described. In the modification, the barcode 431 represents a URL itself, which is designated by characters, numerals, and symbols.

FIG. 49 is an explanatory view for showing the modification of the barcode issuing system 407. Referring to FIG. 49, in step S3251, the modification of the barcode issuing system 407 generates the user ID. In step S3253, the modification of the barcode issuing system 407 generates the unique URL to the user ID. In step S3255, the modification of the barcode issuing system 407 generates a binary code for making a barcode pattern 431, which represents the URL, in accordance with a predetermined rule. In step S3257, the modification of the barcode issuing system relates the URL to the user ID, and stores them in the data base 409. In this way, the server 413 is not required the process for retrieving the URL (see step S31) by setting the barcode 431 to the URL itself.

By the way, as described above, in accordance with the application example 9, the generated barcode 431 is related to the URL of the content made by the user 400 (see FIG. 48). Accordingly, a person to which the barcode 431 is distributed can access the content on the server 413 by sending the barcode 431 to the server 413 through the client 435. Since the barcode 431 is assigned to not an article but the user 400 and unique to the user, the user 400 of the barcode 431 can make contents independently of the article to which the barcode 431 is attached.

By comparison, in the case where a barcode is assigned to an article, since a person to which the barcode is distributed accesses so as to obtain information of the article, if the contents unrelated to the article are made, they not only prove to be disappointing but also the person will never again access on the basis of the barcode. If a user wants a person to access the contents of the user itself which do not depend on the article, as in the present embodiment, the barcode needs to be related to the user 400.

Also, since the barcode 431 is not assigned to the article, the user 400 can attach the barcodes 431 to the different articles even if the barcodes 431 are the same as each other, and also distribute only the barcode 431 independently of the articles.

Further, in the application example 9, it is possible to issue a plurality of different barcodes 431 to one user. Accordingly, the user 400 can own the plurality of the different barcodes 431. That is, the user 400 can make the contents in accordance with the respective barcodes 431. Thus, the user 400 can deliver objective information to a person appropriate to the objective by distributing the different barcodes 431 to the different receivers in accordance with the purposes #n. That is, the same user may want to deliver many information items. In this case, since there is not only the desired information item but also the unnecessary information item, it is inconvenient for the receiver sides. Also, the same user may want not to deliver all information items to all persons. That is, he/she may want to deliver specific information item only to a particular person.

Further, in the modification, in addition to the above advantage, it is possible to decrease processing load of the server 413. Because, since the barcode 431 includes the URL in itself, the server 413 is not required the retrieving process of the URL (see step S31).

### Application Example 10

In the application example 1, the center server 31 (corresponding to the host computer 1 of FIG. 1) generates the individual portal screen with reference to the file 230 of FIG. 6(c), which is stored in the HDD 56, and the table of FIG. 10. However, there is the case where these file and table do not register the barcode 11 as received. Also, even if these file and table are not prepared, if it is possible to generate the individual portal screen, it is valuable. Therefore, the application example 10 provides a system capable of generating the individual portal screen even if these file and table are not prepared necessarily.

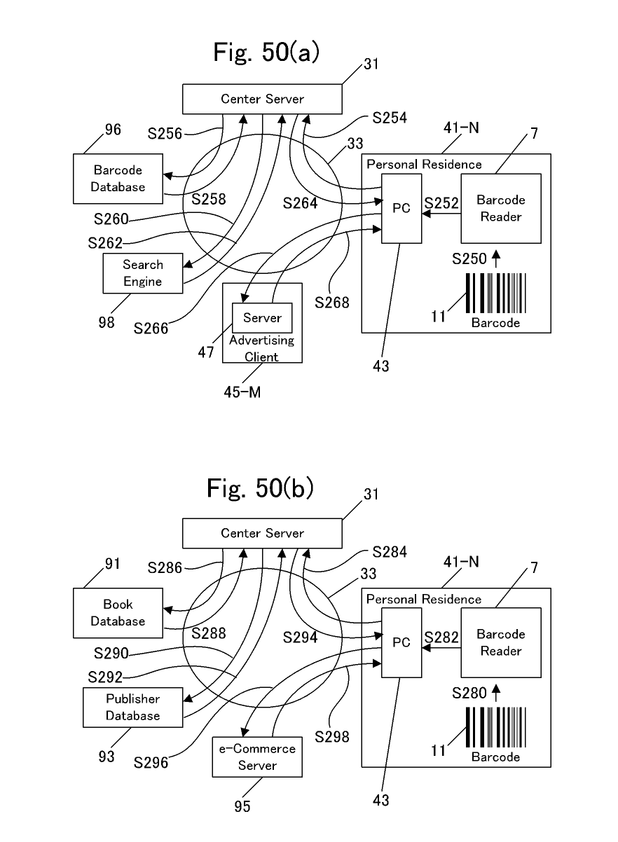

FIGS. 50(a) and 50(b) are explanatory views for showing the application example 10. FIG. 50(a) is the explanatory view of the case where the barcode 11 received by the center server 31 is any one of the JAN code, EAN code and UPC code except the ISBN code. FIG. 50(b) is the explanatory view of the case where the barcode 11 received by the center server 31 is the ISBN code.

Referring to FIG. 50(a), the barcode reader 7 scans and decodes the barcode pattern 11 in response to the operation of the user to obtain the barcode information which the barcode pattern 11 designates in step S250, and then sends the barcode information together with the URL of the center server 31 and the command to the PC 43 in step S252. This command is a command which instructs the PC 43 to launch the browser and accesses the center server 31 addressed by the sent URL.

In step S254, the PC 43 responds to the sent command and transmits the sent barcode information to the center server 31 via the network 33 based on the sent URL.

In step S256, the center server 31 accesses the barcode database 96 to search for the received barcode information. Then, in step S258, the center server 31 acquires the company name designated by the maker code and the commodity name designated by the item code from the barcode database 96. The maker code and the item code are included in the searched barcode information. The barcode database 96 is a database which associates the barcode information with the company name and the commodity name.

In step S260, the center server 31 accesses the search engine 98 to search for each of the acquired company name and commodity name on the network 33. Then, in step S262, the center server 31 acquires the URLs which appear at the highest positions in the search ranking of the respective search results, and regards them as the address of the web site of the company and the address of the web site of the commodity. Thus, it is easily possible to determine the URL to be acquired even if many web sites appear in the search result.

In step S264, the center server 31 transmits the individual portal screen, which includes link buttons for accessing the acquired URLs (the home page of the company and the web site of the commodity), to the PC 43. In step S266, when the link button is depressed, the PC 43 accesses the server 47 addressed by the URL corresponding to the link button. Then, in step S268, the PC 43 receives the display information of the site from the server 47 to display the site.

Referring to FIG. 50(b), the processes of the step S280, S282 and S284 are the same as the step S250, S252 and S254 of FIG. 50(a) respectively, and therefore the descriptions thereof are omitted.

In step S286, the center server 31 accesses a book database 91 to retrieve the received barcode information (i.e., ISBN). Then, in step S288, the center server 31 acquires a book title, an author name, a publisher name, and a URL of an electronic commerce site capable of purchasing a book with the book title, which are designated by the retrieved barcode information, from the book database 91. The book database 91 is a database which associates a book title, an author name, a publisher name, and a URL of an electronic commerce site capable of purchasing a book with the book title with the barcode information.

In step S290, the center server 31 accesses a publisher database 93 to retrieve a publisher code which is included in the barcode information. Then, in step S292, the center server 31 acquires the URL which is associated with the retrieved publisher code from the publisher database 93. The publisher database 93 is a database which associates the publisher code included in the barcode information with the URL of the publisher. Needless to say, the publisher database 93 may be a database which associates the publisher name indicated by the publisher code included in the barcode information with the URL of the publisher. In this case, the center server 31 retrieves the publisher name from the publisher database 93.

In step S294, the center server 31 transmits the individual portal screen to the PC 43. The individual portal screen includes the acquired book title, author name, publisher name, link button to the site of the publisher, and link button to the electronic commerce site capable of purchasing a book with the book title. In step S296, when the link button to the electronic commerce site capable of purchasing a book with the book title is depressed, the PC 43 accesses a electronic commerce server 95 addressed by the URL corresponding to the link button. Then, in step S298, the PC 43 receives the display information of the site for purchasing the book with the book title to display the site. Meanwhile, when the link button of the publisher in the individual portal screen is depressed, the PC 43 accesses a server (not shown in the figure) addressed by the URL corresponding to the link button.

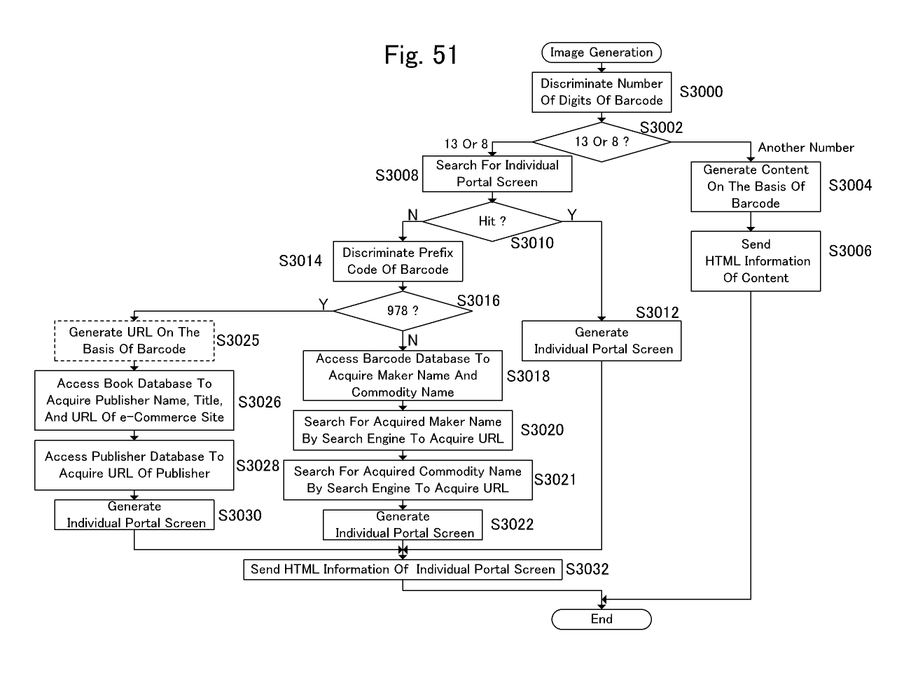

FIG. 51 is a flow chart for showing a process of generating the individual portal screen of the application example 10. Referring to FIG. 51, in step S3000, the communication control unit 212 of the center server 31 determines the number of digits of the received barcode information. Then, in step S3002, the communication control unit 212 proceeds to step S3008 by giving control to the first individual portal screen search unit 214 if the number of digits of the received barcode is 13 or 8, i.e., any one of the JAN code, the EAN code and the UPC code is received. Conversely, the communication control unit 212 proceeds to step S3004 by giving control to the control program 174-Q corresponding to the group to which the barcode information belongs if the number of digits of the received barcode information is not 13 nor 8.

In step S3008, the first individual portal screen search unit 214 accesses the first individual portal screen file 230 to search for the received barcode information (see FIG. 6(c)). Then, in step S3010, the first individual portal screen search unit 214 proceeds to step S3012 if the inputted barcode information is registered on the first individual portal screen file 230, conversely the process proceeds to step S3014 if the inputted barcode information is not registered.

In step S3012, the individual portal screen generating unit 215 generates the HTML information for displaying the first individual portal screen 100 on the PC 43 in the personal residence 41-N. The first individual portal screen 100 includes the link buttons corresponding to the URLs acquired in step S3008.

On the other hand, in step S3014, the first individual portal screen search unit 214 discriminates the prefix code (the upper 3 figures of the barcode information) of the barcode information. In step S3016, the first individual portal screen search unit 214 proceeds to step S3026 if the prefix code is “978”, i.e., the barcode information is the ISBN (International Standard Book Number) code (the step S3025 is not executed in this example), otherwise proceeds to step S3018.

In step S3018, the first individual portal screen search unit 214 accesses the barcode database 96 to retrieve the received barcode information, and then acquires the company name and the commodity name indicated by the barcode information. In step S3020, the first individual portal screen search unit 214 searches for the acquired company name by the search engine to acquire the URL which appears at the highest position in the search ranking. In step S3021, the first individual portal screen search unit 214 searches for the acquired commodity name by the search engine to acquire the URL which appears at the highest position in the search ranking. In step S3022, the individual portal screen generation unit 215 generates the HTML information for displaying the first individual portal screen 100 on the PC 43 in the personal residence 41-N. The first individual portal screen 100 includes the link buttons corresponding to the URLs acquired in steps S3020 and S3021.

On the other hand, in step S3026, the first individual portal screen search unit 214 accesses the book database 91 to search for the received barcode information, and thereby acquires a book title, an author name, a publisher name, and a URL of an electronic commerce site capable of purchasing a book with the book title, which are designated by the barcode information. In step S3028, the first individual portal screen search unit 214 accesses the publisher database 93 to search for the publisher code included in the received barcode information, and thereby acquires the URL of the site which the publisher manages. In step S3030, the individual portal screen generation unit 215 generates the HTML information for displaying the first individual portal screen 100 on the PC 43 in the personal residence 41-N. The first individual portal screen 100 includes the link buttons corresponding to the URLs acquired in steps S3026 and S3028.

In step S3020 after steps S3012, S3022 or S3030, the communication control unit 212 of the center server 31 transmits the generated HTML information to the PC 43 in the personal residence 41-N. The subsequent processes are the same as the processes of the FIGS. 7 and 8.

Also, in step S3004, the control program 174-Q generates the HTML information of the content corresponding to the received barcode information. Then, in step S3006, the communication control unit 212 of the center server 31 transmits the HTML information of the content generated in step S3004 to the PC 43 in the personal residence 41-N. Then, the PC 43 parses the HTML information to display the content.

Incidentally, the communication procedure between the PC 43 and the barcode reader 7 is the same as the communication procedure between the terminal 5 and the barcode reader 7 of FIG. 3, and therefore the description thereof is omitted.

By the way, as described above, in the application example 10, it is possible to acquire the URLs of the sites relating to the company and item corresponding to the barcode 11 using the existing search engine 98, so that there is no need to preliminarily prepare the URLs of the sites relating to the company and item by associating with the barcode 11. As the result, it is possible to reduce the cost. By comparison, to prepare URLs of the sites of all the companies or URLs of the sites of all the items, a lot of time, effort and cost are required. Also, even the case where the URLs are preliminarily prepared by associating with the barcodes 11, it is possible to complement URLs which are not prepared by acquiring the URLs using the search engine 98.

Besides, when the individual portal screen is generated, the URL relating to the company or the commodity corresponding to the barcode 11 is acquired using the search engine 98. Thus, in as far as the site of the company or the commodity corresponding to the barcode 11 exists on the network 33, it is possible to prevent such disadvantageous situation as the link of the company or the commodity corresponding to the barcode 11 is not included in the individual portal screen. That is, since it is possible to prevent inability to access the site of the company or the site of the commodity as much as possible, it is possible to prevent the existing user from disaffiliating, and also contribute to new user acquisition.

### Application Example 11

The application example 11 provides new utilization of GPS (Global Positioning System) using the remote barcode reader system.

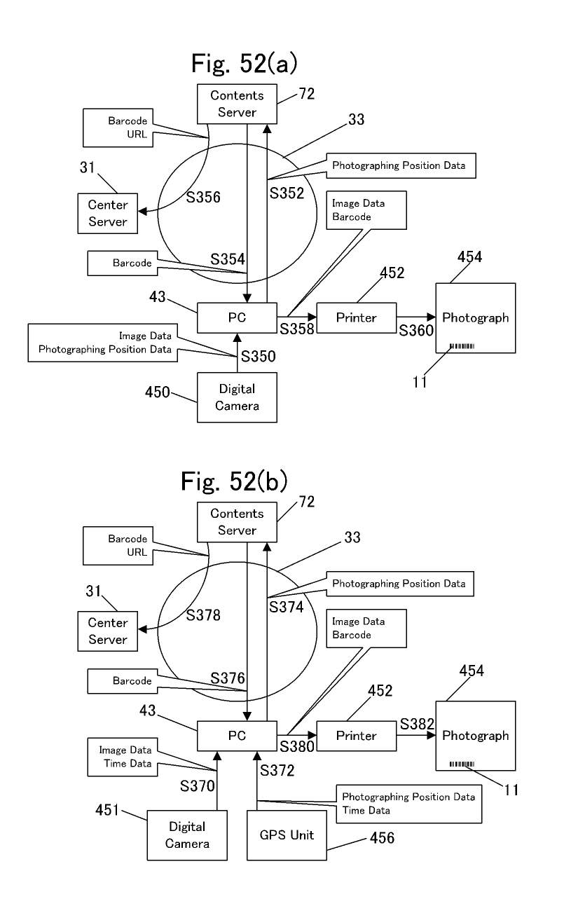

FIG. 52(a) is an explanatory view for showing the application example 11. Referring to FIG. 52(a), a digital camera 450 includes a GPS receiver (not shown in the figure) and a GPS controller (not shown in the figure). The GPS receiver receives information transmitted by the GPS satellites. The GPS controller computes a photographing position (including latitude, longitude, and altitude) based on the information received by the GPS receiver. The digital camera 450 associates the image data obtained by the photographing with the photographing position data obtained at that time, and stores them in a storage device (e.g., a memory).

In step S350, the digital camera 450 transmits the image data and the photographing position data corresponding thereto to the PC 43 in response to the operation of the user. In step S352, the PC 43 transmits the photographing position data received from the digital camera 450 to the contents server 72 via the network 33 in response to the operation of the user. Then, in step S354, the contents server 72 assigns the unique barcode 11 to the photographing position data received from the PC 43, and then transmits the barcode 11 to the PC 43 via network 33. The PC 43 associates the received barcode 11 with the corresponding image data and photographing position data, and stores them in a storage device (e.g., HDD). Also, the contents server 72 generates the controlling file of FIG. 24 based on the photographing position data (latitude data and longitude data), and then associates it with the barcode 11 assigned to the photographing position data, and stores them in a storage device (e.g., HDD). Meanwhile, a constant value is set to flight height (i.e., a reduced scale) of an airplane or a satellite included in the controlling file.

In step S356, the contents server 72 transmits the barcode 11 and the URL of the controlling file associated therewith to the center server 31. The center server 31 registers the received barcode 11 and URL in the converting table of Fig.

In step S358, the PC 43 sends the image data and the barcode 11 corresponding thereto together with a printing command to a printer 452 in response to the operation of the user. Then, in step S360, the printer 452 prints the received image data and barcode 11 on a printer sheet. Thus, a photograph 454 including the barcode 11 arises. The barcode 11 of the photograph 454 corresponds to the barcode 11 of FIG. 23. Accordingly, the same usage as the barcode 11 of the application example 5 can be applied to the barcode 11 of the photograph 454. That is, the processing after scanning the barcode 11 of the photograph 454 by the barcode reader 7 is the same as the processing of the application example 5 (FIGS. 22, 26, and 28), and therefore the detailed description is omitted. The description will be made simply with reference to FIG. 22.

Referring to FIG. 22, in step S1500, the barcode reader 7 scans and decodes the barcode pattern 11 in the photograph 454 (see FIG. 52) in response to the operation of the user to acquire the barcode information indicated by the barcode pattern 11.

The OS 84 of the PC 43 receives the barcode information obtained by the barcode reader 7 in step S1502, and then sends it to the browser 82 of the PC 82 in step S1504. And, in step S1506, the browser 82 transmits the received barcode information to the center server 31 via the network 33.

Then, in step S1508, the center server 31 converts the received barcode information into the URL by the converting table of FIG. 27, and then transmits the URL to the browser 82 of the PC 43. The browser 82 accesses the contents server 72 addressed by the received URL in step S1510, and then acquires the controlling file (see FIG. 24) addressed by the received URL from the contents server 72 in step S1512.

In step S1514, the browser 82 sends the acquired controlling file to the OS 84. Then, in step S1516, the OS 84 launches the terrestrial globe application 86 based on the suffix of the controlling file, and sends the path of the controlling file to the terrestrial globe application 86. In step S1518, the terrestrial globe application 86 accesses the controlling file based on the path as sent to request the terrestrial globe server 80 to transmit the photograph (the aerial photograph or the satellite photograph) of the photographing position (the longitude and latitude) designated by the controlling file.

And, in step S1520, the terrestrial globe server 80 stream-distributes the data of the photograph requested by the terrestrial globe application 86, to the terrestrial globe application 86. The terrestrial globe application 86 displays the photograph on the monitor based on the data. In this case, the terrestrial globe server 80 has a database of aerial photographs and satellite photographs over the world associated with longitudes and latitudes.

Incidentally, the center server 31 and the contents server 72 correspond to the host computer 1 of FIG. 1. This is true for the example of FIG. 52(b) to be described next, too.

FIG. 52(b) is an explanatory view for showing the modification of the application example 11. Referring to FIG. 52(b), the digital camera 451 associates the image data obtained by photographing with the time data at that time to store them in a storage device (e.g., a memory). Also, a GPS unit 456 includes a GPS receiver (not shown in the figure) and a GPS controller (not shown in the figure). The GPS receiver receives information transmitted by the GPS satellites. The GPS controller computes a photographing position (including latitude, longitude, and altitude) based on the information received by the GPS receiver. Then, the GPS unit 456 associates the computed photographing position data with the time data at that time to store them in a storage device (e.g., a memory). In this case, the user photographs with the digital camera 451 while having the GPS unit 456.

In step S370, the digital camera 451 transmits the image data and the time data corresponding thereto to the PC 43 in response to the operation of the user. On the other hand, in step S372, the GPS unit 456 transmits the photographing position data and the time data corresponding thereto to the PC 43 in response to the operation of the user. The PC 43 associates the photographing position data corresponding to the time data received from the GPS unit 456, which indicates the same time as the time data received from the digital camera 451, with the image data corresponding to the time data, and stores them in a storage device (e.g., HDD).

In step S374, the PC 43 transmits the photographing position data to the contents server 72 via the network 33 in response to the operation of the user. Then, in step S376, the contents server 72 assigns the unique barcode 11 to the received photographing position data from the PC 43, and then transmits the barcode 11 to the PC 43 via the network 33. The PC 43 associates the received barcode 11 with the image data and the photographing position data corresponding thereto to store them in a storage device (e.g., HDD). Also, the contents server 72 generates the controlling file of FIG. 24 based on the photographing position data, and then associates it with the barcode 11 assigned to the photographing position data to store them in a storage device (e.g., HDD).Meanwhile, a constant value is set to flight height (i.e., a reduced scale) of an airplane or a satellite included in the controlling file.

In step S378, the contents server 72 transmits the barcode 11 and the URL which indicates the storage location of the controlling file associated with the barcode 11 to the center server 31. The center server 31 registers the received barcode 11 and URL in the converting table of FIG. 27.

In step S380, the PC 43 sends the image data and the barcode corresponding thereto together with the printing command to the printer 452 in response to the operation of the user. Then, in step S382, the printer 452 prints the received image data and barcode 11 on a printer sheet. Thus, a photograph 454 including the barcode 11 arises. The barcode 11 of the photograph 454 corresponds to the barcode 11 of FIG. 23. Accordingly, the same usage as the barcode 11 of the application example 5 can be applied to the barcode 11 of the photograph 454. This point is the same as the example of FIG. 52(a).

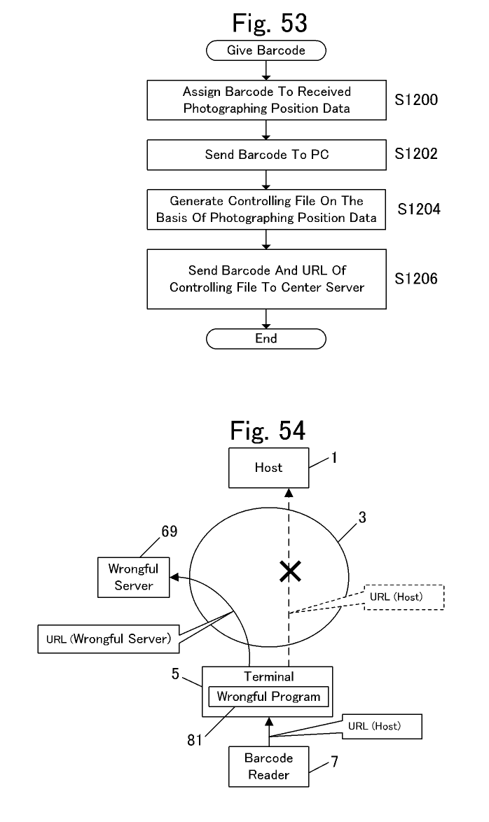

FIG. 53 is a flow chart for showing processing of giving barcodes in the case of the application example 11. Referring to FIG. 53, in step S1200, the contents server 72 assigns the unique barcode 11 to the photographing position data received from the PC 43 (see steps S352 and S374). In step S1202, the contents server 72 transmits the assigned barcode 11 to the PC 43. In step S1204, the contents server 72 generates the controlling file of FIG. 24 based on the photographing position data (latitude data and longitude data). In step S1206, the contents server 72 transmits the barcode 11 and the URL which indicates the storage location of the controlling file to the center server 31.

By the way, as described above, in accordance with the application example 11, the photographed image data as obtained by the digital camera 450 or 451 is associated with the photographing position data based on the GPS. And, the unique barcode 11 is assigned to this photographing position data. Then, the photographed image data is printed together with the barcode 11 assigned thereto, and thereby the photograph 454 is made. On the other hand, the controlling file of FIG. 24 is generated based on the photographing position data corresponding to the photographed image data.

Accordingly, when the barcode 11 printed on the photograph 454 is scanned by the barcode reader 7, the PC 43 acquires the controlling file of FIG. 24 from the contents server 72 to launch the terrestrial globe application 86. Then, the terrestrial globe application 86 receives the image data of the place indicated by the controlling file, i.e., the image data of the place indicated by the photographing position data from the terrestrial globe server 80 to display it on the monitor. The photographing position data indicates the photographing position by the digital camera 450. Thus, the user can view the aerial photograph or the satellite photograph of the place and so on included in the photographed image by the digital camera 450 or 451 on the monitor. In this case, by manipulating the icons of the photograph manipulation section 90 (see FIG. 25), the user can make the enlarging or reducing operation and the change of the depression angle, and view the neighboring photograph.

In this way, the user can view the place and so on included in the photographed image by the digital camera 450 or 451 with the various viewpoints and expressions. Also, if the photographs stored in the terrestrial globe server 80 are updated to the latest ones one after another, it is possible to observe that how the place and so on included in the past photographed image by the digital camera 450 or 451 has changed currently, or the like.

As described above, since the photographing position by the digital camera 450 or 451 is acquired from the GPS and is associated with the barcode 11, the user can view the aerial photograph or the satellite photograph of the place and so on taken in the photograph 454 only by scanning the barcode 11 in the photograph 454. In this way, it is possible to provide the new utilization of the GPS by the application example 11.

Also, the contents server 72 issues the barcode 11 while the side of the PC 43, i.e., the user side does not issue the barcode 11, and thereby it is easily possible to collect the charge for issuing the barcode 11. For example, the contents server 72 charges each time the barcode 11 is issued.

### Application Example 12

In the application example 12, a program, which commits a dishonest act against to the remote barcode reader system in accordance with the present embodiment, will be described. By obtaining rights such as a patent relating to the program which commits the dishonest act, if the wrongful programs are distributed or sold, it is possible to exclude them by the rights such as the patent.

FIG. 54 is an explanatory view for showing the application example 12. Referring to FIG. 54, it is assumed that a wrongful program 81 is installed in a terminal 5. This wrongful program 81 may be a program which is newly installed in the terminal 5, or a program produced by remodeling a program (e.g., a driver, a browser, or the like) being installed already in the terminal 5.

As thus far described, the barcode reader 7 scans the barcode 11, and then transmits the barcode 11, the URL of the host computer 1, the command for launching the browser, and the serial number as the keyboard data to the terminal 5 (see FIG. 2(a)).

The wrongful program 81 receives such the keyboard data, and then accesses not the host computer 1 addressed by the URL which the barcode reader 7 sends but a wrongful server 69 addressed by a URL different therefrom. There is the case where the wrongful program 81 is distributed with the purpose of making the terminal 5 access the wrongful server 69 forcibly (with the malicious purpose). Also, there is the case where the wrongful program 81 is distributed with the purpose of providing a specific service (e.g., making a library) by the third party (with the well-meant purpose). In this case, although the user may voluntarily install the wrongful program 81 for enjoying the service, it is impermissible because the business of the host of the remote barcode reader system is thwarted.

Or, while the wrongful program 81 receives such the keyboard data, extracts the barcode 11 sent by the barcode reader 7 therefrom, and performs the processing using the barcode 11 (e.g., making a library), the wrongful program 81 may not access the host computer 1.

Such the access and the processing hurt the host of the remote barcode reader system regardless whether or not the user intends them (obstruction of business), and therefore are impermissible and must be prohibited.

Or, the wrongful program 81 scraps such the keyboard data. In this case, since the access to the host computer 1 is not performed, the business of the host of the remote barcode reader system is thwarted, and therefore such the process must be rightly prohibited.

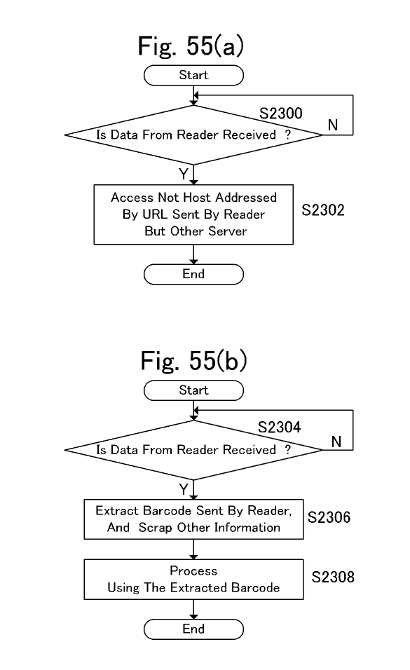

FIG. 55(a) is a flow chart for showing processing by the wrongful program 81 in the case of the application example 12 (the first example). Referring to FIG. 55(a), in step S2300, the wrongful program 81 checks whether or not the keyboard data (the URL, command, barcode, and serial number) is sent from the barcode reader 7, the process proceeds to step S2302 if it is sent, conversely the process returns to step S2300 if it is not sent. In step S2302, the wrongful program 81 accesses the wrongful server 69 different from the host computer 1 addressed by the URL included in the received keyboard data. In this case, the wrongful program 81 may send the barcode to the wrongful server 69 or may not send it.

FIG. 55(b) is a flow chart for showing processing by the wrongful program 81 in the case of the application example 12 (the second example). Referring to FIG. 55(b), in step S2304, the wrongful program 81 checks whether or not the keyboard data (the URL, command, barcode, and serial number) is sent from the barcode reader 7, the process proceeds to step S2306 if it is sent, conversely the process returns to step S2304 if it is not sent. In step S2306, the wrongful program 81 extracts the barcode from the received keyboard data while scraps other data. In step S2308, the wrongful program 81 performs the processing using the extracted barcode.

By the way, if the wrongful program 81 is executed, the access to the proper host computer 1 to be originally accessed is not performed. As the result, the business of the business entity providing the service based on the access to the proper host computer 1 is thwarted (obstruction of business). Also, if the user of the terminal 5 desires to access the proper host computer 1, the benefit of the user is also damaged. Accordingly, by obtaining a patent relating to the wrongful program 81, if the wrongful programs 81 are distributed or sold, it is possible to exclude them by the patent. That is, it is possible to prevent the injustice when accessing the network 33 using the barcode 11.

Also, it is possible to prevent the wrongful program 81 from sending the barcode 11 to the wrongful server 69 or using the barcode 11 on the terminal 5 without permission. As the result, a misuse of the barcode 11 can be obstructed.

### Application Example 13

In the application example 13, a barcode creating apparatus for dynamically creating the barcode 11 of the remote barcode reader system of FIG. 1 will be described.

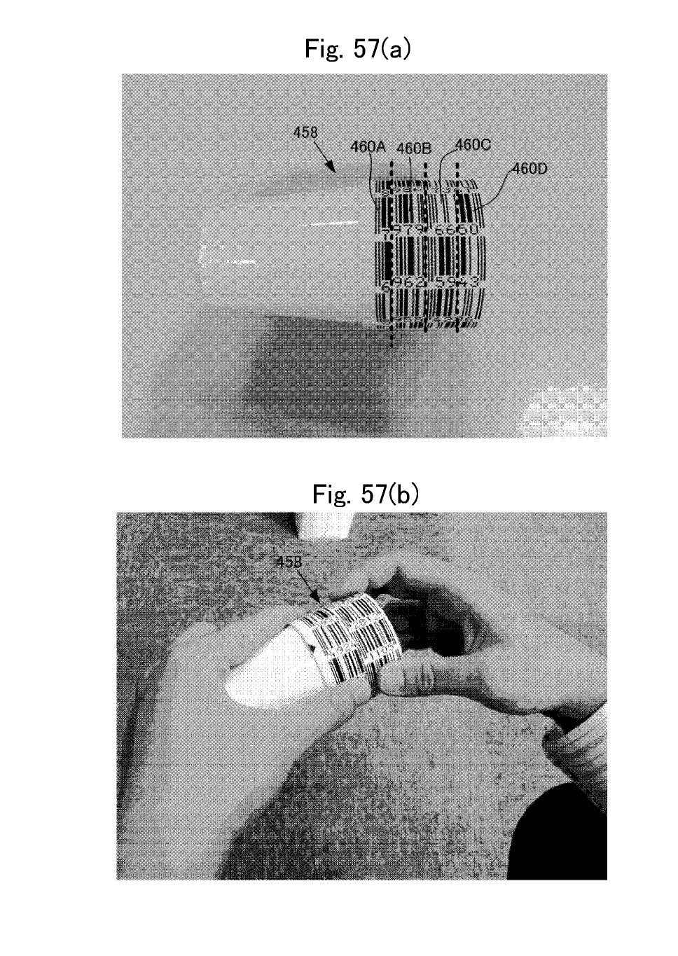

FIG. 57(a) is a schematic diagram for showing an example of the barcode creating apparatus according to the application example 13. FIG. 57(b) is an explanatory view for showing how to use the barcode creating apparatus of FIG. 57(a). Referring to FIG. 57(a), the barcode creating apparatus 458 has construction in which respective rotating drums 460A to 460D (corresponding to pieces) independently rotate and align by commonly using a rotation axis. Hereinafter, the rotating drums 460A to 460D are collectively referred to as the “rotating drums 460”. The each rotating drum 460 is divided into a plurality of blocks, and barcode-characters and digits designated by the barcode-characters are indicated in the each block.

As shown in FIG. 57(b), when a user just aligns the barcode-characters by rotating the each rotating drums 460, the barcode 11 that can be read by the local barcode rader 7 of FIG. 1 is created. Since the each barcode-character is obtained by bar coding the digit printed thereunder, when the local barcode reader 7 reads this barcode 11, these digits are output as the barcode information. In this application example, the barcode information to be output from the local barcode reader 7 is an eight-digit number.

In the case where the barcode 11 created by the barcode creating apparatus 458 is scanned, the processes to be performed by the local barcode reader 7, the terminal 5, and the host computer 1 are similar to the process flows as shown in FIG. 3. When the local barcode reader 7 reads the barcode 11, since the host computer 1 provides the terminal 5 with the content depending on the barcode 11, the user can receive the content just by scanning the barcode 11.

Incidentally, the barcode 11 to be created by the barcode creating apparatus 458 may be a barcode according to a unified standard, such as CODE128, or a barcode according a standard that a business entity operating the remote barcode reader system independently defines. However, since order of the barcode-characters is arbitrarily determined, there is a possibility of occurrence of a reading error depending on a combination of the barcode-characters in a standard having a definite rule for arrangement order of the barcode characters, such as JAN code in which the m-th barcode-character is determined by the n-the barcode character, and therefore it is unsuitable. Consequently, a barcode standard in which the barcode-characters designate predetermined barcode information without depending on the arrangement order thereof is preferable.

While the barcode 11 to be created by the barcode creating apparatus 458 is an eight-digit barcode in this application example, a barcode creating apparatus capable of creating the barcode 11 other than the eight-digit barcode also can be formed by changing the number of the barcode-characters indicated on the each rotating drum 460, or changing the number of the rotating drums 460.

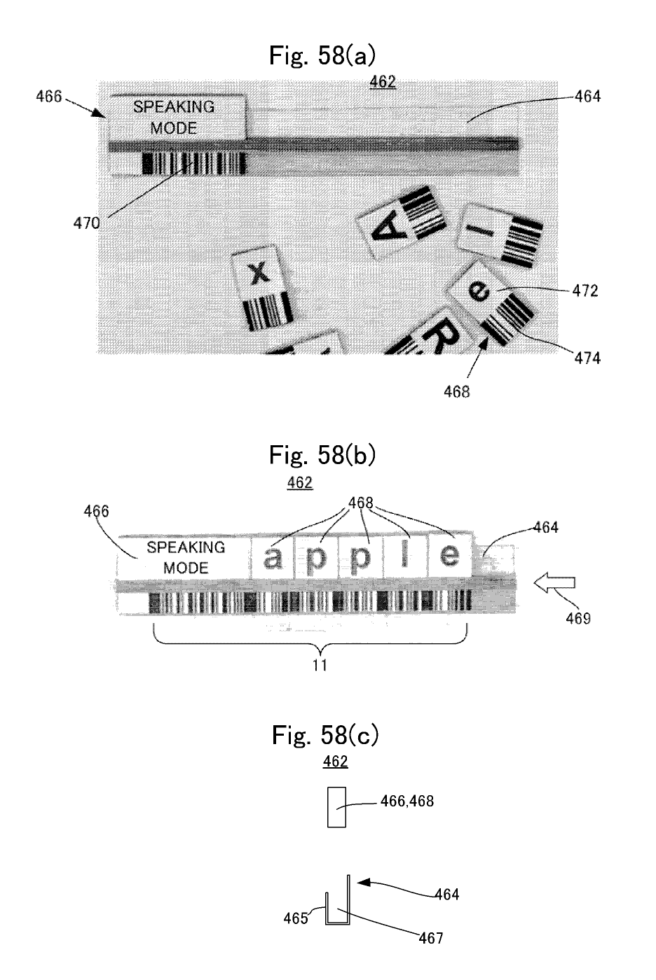

FIG. 58(a) is a schematic diagram for showing another example of the barcode creating apparatus according to the application example 13. Referring to FIG. 58(a), a barcode creating apparatus 462 is provided with a case 464 (corresponding to aligning means), a start card 466, and letter cards 468 (corresponding to pieces). The case 464 is formed by transparent material, and has a slot into which the start card 466 and the letter cards 468 just fit.

The start card 466 and the letter cards 468 will be described. A start code 470 is printed on the start card 466. There is the plurality of kinds of the start cards 466 as not shown in the figure, and the different start cord 470 is printed thereon depending on the kind. The letter card 468 is provided with a letter indicating part 472 on which a letter is indicated, and a letter code 474, on the surface thereof. In this embodiment, the letter code 474 is created by bar coding a two-digit number, and the different letter code 474 is indicated depending on a letter, a numeral, or a drawing indicated in the letter indicating part 472.

FIG. 58(b) is an explanatory view for showing a state of the case 467 inserted the start card 466 and 5 letter cards 468. The start card 466 is arranged at the left end, and the arbitrary number of the letter cards 468 are subsequently arranged in the arbitrary order. When the start card 466 and the letter cards 468 are arranged in the case 464, as shown in the figure, they align, and therefore the complete barcode 11 is formed from the start code 470 and the letter codes 464. The unique barcode 11 is created depending on the order and the number of the letter cards 468. Since the case 464 is transparent as described above, the local code reader 7 or the other barcode reader can scan the barcode 11.

In FIG. 58(b), the letter cards 468 are inserted into the case 464 so that an alphabetic word of “apple” is formed by the letter indicating parts 472.

FIG. 58(c) is an explanatory view for showing the configuration of the case 464, and shows the state of viewing the case 464 from the immediate lateral side (the direction of the arrow 469 of FIG. 58(b)). Referring to this figure, the case 464 has the hook-like cross-sectional shape, and the slot 467 capable of just inserting the start card 466 and the letter cards 468 as described above. When the start card 466 and the letter cards 468 are arranged in the slot 467, as shown in FIG. 58(b), the respective cards align, and therefore the barcode 11 is formed along a barcode exposure part 465 of the case 464. While the case 464 is transparent almost as a whole in this embodiment, only the barcode exposure part 465 may be transparent. Or, the barcode 11 may be exposed by forming an aperture on the barcode exposure part 465.

The barcode 11 varies in length depending on the number of the letter cards 468 to be inserted into the case 464. That is, since the barcode 11 is a variable length barcode whose digit number varies depending on the content thereof, further, the local barcode reader 7 in this application example is designed so that the variable length barcode can be read.

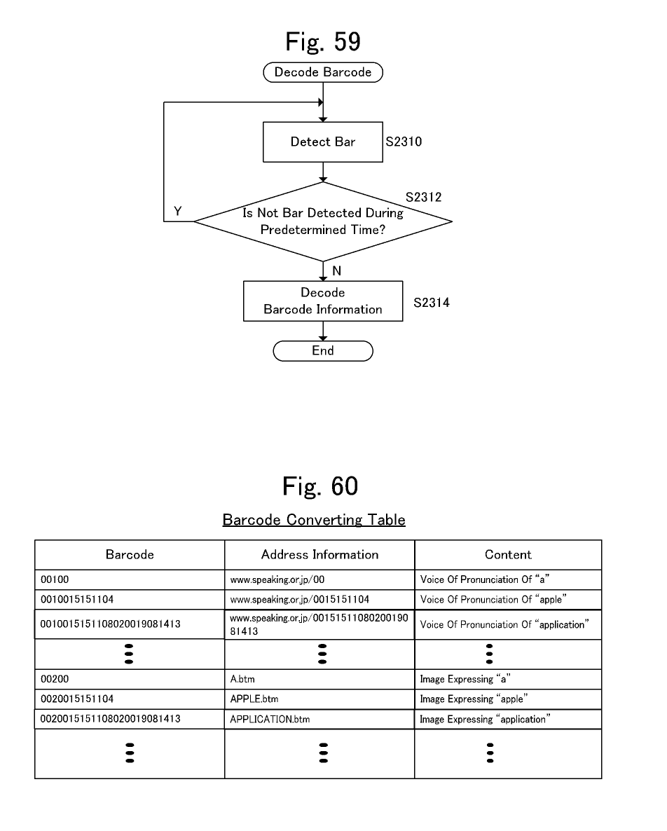

FIG. 59 is a flow chart for showing a process of the local barcode reader 7 in decoding the barcode 11 in the application example 13. Referring to FIG. 59, after the local barcode reader 7 detects the first bar in step S2310, the local barcode reader 7 returns to step S2310 if the next bar is detected during a predetermined time in step S2312 in order to sequentially detect a bar. The local barcode reader 7 determines that the scanning of the last bar of the barcode 11 has been completed if a bar is not detected during the predetermined time in step S2312, proceeds to step S2314 in order to acquire the barcode information by decoding the reading result, and then returns. Incidentally, this process is performed as the barcode reading process in step S3 of FIG. 3.

Referring to FIG. 60, the host computer 1 is provided with a converting table in which the barcode 11 is associated with address information designating a storage location of a corresponding content. The address information includes, for example, a URL. In the case where the barcode 11 is scanned, the processes to be performed by the local barcode reader 7, the terminal 5, and the host computer 1 are similar to the processes as shown in FIG. 3. However, in the application example 13, in step S31 of FIG. 3, the host computer 1 searches the converting table of FIG. 60 by the received barcode 11 as an index in order to acquire the address information corresponding to the barcode 11. In step S33, the host computer 1 sends the address information, such as a URL that designates a storage location of a content, to the terminal 5 instead of sending the content directly. Then, in step S25, the terminal 5 accesses the host computer 1 on the basis of the received address information, and displays the content.

Returning to FIG. 60, the address information corresponding to the each barcode 11 is address information of the content related to the word that is formed by aligning the letter indicating parts 472. For example, the barcode 11 of FIG. 58(b) corresponding to the word “apple” formed by the letter indicating parts 472 designates “0010015151104”. Three-digit number “001” from the left end indicates the start code 470, and the remaining number “0015151104” indicates the letter codes 474. The address information corresponding to this barcode 11, i.e., “0010015151104” is the URL designating “www.speaking.or.jp/0015151104”, and the content located on the URL is voice indicating the word “apple” (see FIG. 60).

Also, as described above, there is the plurality of kinds of the start cards 466, and they indicate the start codes 470 designating the different barcode information respectively. That is, if the kind of the start card 466 differs, even when the same letter cards 468 are aligned, the barcode information to be sent to the host computer 1 differs, and therefore the different address information is sent to the user. For example, in FIG. 58(b), in the case where the user replaces the start card 466 and thereby the start code 470 changes from “001” to “002”, the barcode 11 indicates “0020015151104”, the address information stored corresponding to this barcode 11 indicates the file name of “Apple.btm”, and therefore the content is the image expressing the “apple”. Incidentally, in this case, the image expressing the “apple” is stored in the host computer 1, and the address information indicates not a URL but the file name. Therefore, the host computer 1 identifies the image expressing the “apple”, and sends it to the terminal 5 directly.

Needless to say, these are illustrative only, as described by the application examples, the host computer 1 can perform the various processes and provide the various contents.

In this way, the user arranges the start card 466 followed by the each card in the case 464 so that the word is formed by the letter cards 468, then, scans the created barcode 11 by the local code reader 7, and thereby can receive the various contents related to the word. For example, it is possible to listen to a pronunciation of the word, look at a screen display for explaining a meaning of the word, or the like. Needless to say, it is not necessarily the case that the content has to relate to the word formed by the letter cards 468, and therefore it is also possible to provide a content not related to the word.

By the way, as described above, in accordance with the application example 13, the user can dynamically creates the barcode 11 by rotating the rotating drums 460 of the barcode creating apparatus 458 and thereby changing the combination of the barcode characters, and therefore receive the various contents from the host computer 1.

Also, the user can dynamically creates the barcode 11 by changing the number and/or the order of the start card 466 and the letter cards 468 of the barcode creating apparatus 462 and thereby changing the combination of the barcode characters, and therefore receive the various contents from the host computer 1.

Further, the user can easily recognize the barcode information of the barcode 11 by indicating the numbers corresponding to the barcode characters like the barcode creating apparatus 458. Still further, the barcode creating apparatus 462 indicates a letter, a numeral, and/or a drawing corresponding to the barcode character while the user scans the barcode 11 created by arranging the desired letter and so on, and thereby the user can receive the content related to the desired letter and so on.

Still further, since the barcode 11 includes the start code 470 at the head thereof in the barcode creating apparatus 462, when the barcode 11 is used in the remote barcode reader system, the host computer 1 can easily recognize that the barcode 11 is created by the barcode creating apparatus 462 and differs from a barcode according to the other standard.

Meanwhile, the present invention is not limited to the above embodiment, and a variety of variations may be effected without departing from the spirit and scope thereof, as described in the following modification examples.

(1) In the case of the above examples, there is no need to install dedicated software in the terminal 5 for transmitting the barcode 11 through a browser to the host computer 1, because the local barcode reader 7 is designed to output the command 29. However, it is also possible to omit the functionality of outputting the command 29 from the local barcode reader 7, by installing such dedicated software in the terminal 5. In this case, it is preferred to launch the dedicated software in response to the input of the barcode 11, and automatically transmit the barcode 11. Also, it is possible to have the local barcode reader 7 output a command to the dedicated software, which then transmits the barcode 11 to the host computer 1 in response to the command.

Furthermore, in the case of the above examples, the local barcode reader 7 is designed to output the URL 27 of the host computer 1, such that there is no need to input the URL 27 of the host computer to the terminal 5. However, it is also possible to omit the functionality of outputting the URL 27 from the local barcode reader 7 by prompting the user to input the URL 27 of the host computer 1, or by writing the above software to include the URL 27 in the terminal 5.

The local barcode reader 7 which does not output the URL 27 and the command 29 is equivalent to an ordinary barcode reader. Accordingly, an ordinarily available barcode reader can be used for the present system by installing such software in the terminal 5.

(2) While the configuration of the individual portal screen is illustratively shown in FIG. 5(b), FIG. 9 and FIG. 11(a), the link buttons are not limited to those shown in these figures. Also, the advertisement support corporation can arbitrarily determine which link buttons are default. In addition, the advertisement support corporation can also arbitrarily determine which link buttons are provided as pay services.

Furthermore, the content items displayed in the individual portal screen are not necessarily limited to link buttons. Also, it is possible that the center server 31 does not provide the individual portal screen, but returns the URL of the website associated with the commodity indicated by the received barcode to the PC 43 or the like, and directly displays this website. The information about the commodity described in this website includes all the information items, of which the advertising client 45-M wants to inform the user after and before purchasing the commodity. This is true also in the case of the information about the commodity distributed from the target of a link button in the individual portal screen.

(3) The link targets of the link buttons 102, 106, 118, 108 and 116 contained in the first individual portal screen 100 are files in the server 47 of the advertising client 45-M. However, as physically viewed, this server 47 is not necessarily a single server, but the link targets thereof may be contained in a plurality of servers. This alternative can be applied in the same manner to the case where the link targets of the link buttons contained in the first individual portal screen 130 are files in the server 47 of the advertising client 45-M. Furthermore, this is true also in the case where the link targets of the link buttons contained in the second individual portal screen 101 are files in the server 47 of the advertising client 45-M.

Likewise, the user registration function, the questionnaire function and the household account book generation function of the center server 31 can be implemented with separate servers respectively. Of course, the processes of the center server 31 can be performed by a plurality of servers as distributed processing.

Furthermore, the link targets of the buttons 126, 168 and 124 displayed in the frame 164 of the second individual portal screen 101 are files in the server 47 of the store central office 75-P. However, as physically viewed, this server 77 is not necessarily a single server, but the link targets may be contained in a plurality of servers.

(4) In the case of the above examples, while the barcodes 11 and 431 is employed as the information to be transmitted to the host computer 1 and the center server 31, the present invention is not limited thereto. For example, an electronic tag (IC tag) such as RFID (Radio Frequency Identification System) can be used. However, in this case, the information encoded in the electronic tag is read by an electronic tag reader (IC tag reader) in place of the barcode readers 7 and 433. Preferably, the electronic tag reader is designed to issue the same command as the barcode readers 7 and 433, and output the URL of the host computer 1. Also, while a one-dimensional barcode which is a one-dimensional code is used in the above examples, it is possible to use a two-dimensional barcode or QR code as a two-dimensional code.

(5) As physically viewed, the host computer 1 and the center server 31 can be implemented with a single computer. Alternatively, the processes of the host computer 1 or the center server 31 can be performed by a plurality of servers as distributed processing. Of course, in the case where distributed processing is employed, the respective computers may be located in the same country, or distributed in a plurality of countries. Meanwhile, the host computer 1 and the center server 31 as referred to herein are devices which are implemented by means of hardware and/or software.

(6) In the case of the application examples 1 through 6, when receiving an instore code from the barcode reader 7 or the camera unit 180, the center server 31 can return a predetermined message (for example, a notification that no service is available) to the terminal “tm”. The instore code is a barcode which is defined by a retail seller for use only in the store. Accordingly, since the code is not necessarily unique in the whole market, it is rejected.

(7) It is also possible to use the barcode recognition feature implemented with the camera of a cellular phone in place of the barcode reader 7. This is true in the case of the recognition of QR codes. In this case, for example, software is installed in the cellular phone for transmitting the barcode to the host computer 1 and the center server 31.

(8) While the first group 251 includes the JAN code in the case of the above examples, it is possible to also include EAN (European Article Number) and/or UPC (Universal Product Code) in the first group 251.

(9) The application example 2 and the application example 3 as described above can be combined. Namely, the center server 31 performs processing by classifying the barcode as received into either the first group 251 or the second group 252. In this case, when receiving a barcode belonging to the first group 251, the center server 31 provides different content items between the individual portal screen displayed on the PC 43 of the personal residence 41-N from which the user accesses the center server 31 and the individual portal screen displayed on the computer 37 of the store 35-K from which the user accesses the center server 31, even though the same barcode is scanned. In the same manner, there may be a combination of the application example 2 and the application example 5, a combination of the application example 2 and the application example 6, or a combination of the application example 2 and the application example 7.

Also, the application example 5 and the application example 6 can be combined. In this case, for example, the center server 31 of the application example 6 is employed. Accordingly, the classifying program of the center server 31 accesses the converting table of FIG. 30 to acquire the URL associated with the group to which the received barcode information belongs, appends the barcode information to the URL, and instructs the PC 43 to access the contents server addressed by the URL. For example, it is assumed that the URL associated with the barcode group of the first line of the converting table of FIG. 30 indicates the contents server 74, and the URL, associated with the barcode group of the second line indicates the contents server 72. And, in this case, the contents server 72 searched for the controlling file (see FIG. 24) corresponding to the barcode information received from the PC 43, and then transmits it to the PC 43. The contents server 74 is the same as the application example 6. In the same manner, there may be a combination of the application example 5 and the application example 6.

Further, there may be a combination of the application example 2, the application example 5, and the application example 6, or a combination of the application example 2, the application example 5, and the application example 7. Needless to say, the camera unit 180 of the application example 4 and the BC mouse 363 of the application example 8 can be employed by all the application examples instead of the barcode reader 7.

(10) In the case of the above application example 2, it is determined in which of the store 35-K and the personal residence 41-N the terminal “tm” is installed, on the basis of the URL transmitted from this terminal “tm” (step S400 of FIG. 12). However, any other appropriate method can be employed as long as the center server 31 can determine the location where the terminal “tm” is installed, i.e., the location from which the barcode is transmitted. Also, although the two kinds of the individual portal screens are prepared depending on the installation sites, the three or more kinds of the individual portal screens may be prepared depending on the installation sites.

(11) In the case of the above application example 3, the received barcode is classified into either the first group 251 or the second group 252 with reference to the number of digits of the received barcode (step S430 of FIG. 17). However, any other appropriate method can be employed as long as it is possible to determine the belonging group of the barcode. For example, the barcode can be classified by giving the center server 31 the information indicative of the belonging group of the barcode transmitted from the barcode reader 7 or the terminal “tm” together with the barcode itself.

(12) While the center server 31 runs the control programs 174-1 to 174-q shown in FIG. 16, it is also possible to run these programs by separate computers (contents servers) respectively. In this case, the communication control unit 212 transmits the barcode 2520 belonging to the second group 252 to the computer responsible for running the control program 174-Q corresponding to this barcode 2520, and this computer provides the corresponding content to the terminal “tm”. In the above description, the application example 6 belongs to this type.

(13) The above individual portal screen (100, 130, and 101) is one example of portal screens in accordance with the present invention. The portal screen is a relay WEB page for accessing a WEB site (hereinafter referred to as a “direct site”) which directly relates to a “thing” to which a code (a barcode, a QR code, an RFID, or the like) is assigned, one example thereof is the above individual portal screen. In this case, the “thing” includes tangible entity such as goods and estate, intangible entity such as service and information, commodity, and living being such as human being and animal, and the information includes image, sound, program, and data.

In the present invention, the user accesses the direct site via always such the portal screen which relates thereto. Accordingly, the business entity operating the host computer 1 or the center server 31 can promptly obtain statistical data relating to the “things” to which the codes are assigned by collecting and analyzing status of user access to the respective portal screens and the linked pages included therein. For example, it is possible to analyze the market of the “thing” based on the obtained statistical data Also, it is also possible to analyze based on the comparison with a “thing” of the same sort. These are economically worth, and therefore can be income stream of the business entity. Further, the business entity can also generate revenue in the same manner as the above individual portal screen which is specific to the commodity. In this way, it is possible to increase income-generating opportunity of the business entity by providing the portal screen. By comparison, if the user can directly access the direct site in response to the scan of the code, the business entity can not recognize the access status to the respective direct sites.

(14) The application example 5 takes the terrestrial globe application 86 as an example of an application program which is installed in the communication terminal 5 and controlled by the controlling file sent by the center server 31. However, the application program to be controlled by the controlling file is not limited thereto. For example, it is possible to control the various kinds of application programs such as word-processing software, spreadsheet software, a database, a mailer, and a game program by the controlling files. Also, it is not necessarily the case that the application program is controlled by the file, and the application program may be controlled by data with the other format.

(15) In the application example 5, the existing browser and OS are employed instead of installing dedicated software for controlling the terrestrial globe application 86. However, by installing the dedicated software, it may transmit the barcode, and launch and control the terrestrial globe application 86 based on the controlling file. In this case, the controlling file with the format of FIG. 24 is not necessarily required. That is, a format of data, which is sent by the center server 31, and launches and controls the terrestrial globe application 86, may be optionally designed depending on the specification of the dedicated software.

(16) In the application example 5, the image data relating to the photograph 162 is acquired from the terrestrial globe server 80. However, the PC 43 may preliminarily store the image data in a storage device such as an external hard disk drive and a built-in hard disk drive. Also, the both can also have the image data.

(17) The first to third examples will be described as methods for classifying the barcode information. First of all, the first example will be described. This example has been applied to the application example 6. That is, the center server 31 has the converting table of FIG. 30, retrieves the URL associated with the group to which the received barcode information belongs, appends the barcode information to the URL, and instructs the PC 43 to access the contents server addressed by the URL. The contents server generates the content in accordance with the barcode information appended to the URL in response to the access, and transmits it to the PC 43. However, in this example, the center server 31 does not necessarily append the barcode information as it is to the URL. After converting the barcode information in accordance with a predetermined algorism, the converted one may be appended.

Next, the second example will be described. This example has been applied to the application example 5. That is, the center server 31 has the converting table of FIG. 27 for each group to which the barcode information belongs, accesses the converting table corresponding to the group to which the received barcode information belongs, retrieves the URL associated with the barcode information, and instructs the PC 43 to access the contents server addressed by the URL. The contents server transmits the content designated by the URL to the PC 43 in response to this access. The content in this case corresponds to the controlling file in the application example 5. In this way, in the present specification, meaning of the content contains not only the content as it is but also data and information which defines the content.

Next, the third example will be described. In this example, the barcode reader 7 stores URLs of a plurality of contents servers as well as the URL of the center server 31 in the ROM 19. Also, the barcode reader 7 has a table where the barcode information is associated with the URL of the contents server. And, the barcode reader 7 sends the URL of the center server 31 as default to the PC 43. However, when the barcode information associated with the URL of the contents server is read, the barcode reader 7 sends the URL of the contents server to the PC 43. Accordingly, in this case, the PC 43 accesses directly the contents server instead of the center server 31, since then, the scanned barcode information is sent to the contents server. In this case, the barcode reader 7 sends the URL of the center server 31 to the PC 43 when a certain time is elapsed, a certain number of times of accesses (one or more integer) are performed, or a specific barcode which instructs to return to the default is read.

(18) In the application example 6, the content depending on the state transition of the contents server 74 is provided. However, one set may be formed by permutation or combination of the predetermined number of barcodes, and the plurality of the sets may be defined. Then, a table, where each set is associated with one content, may be prepared. In this case, the contents server 74 produces the content to be provided with reference to this table. Incidentally, even this case, many substantially perform the processing in accordance with the state transition of the contents server 74.

Even this case, the processing can be performed in accordance with permutation or combination of the plurality of barcodes, which may be inputted from the plurality of barcode readers of the plurality of users as well as from one barcode reader 7 of a specific user. Therefore, it is possible to enjoy the content while influencing to one another among the plurality of the users.

(19) In the application example 7, the barcode 11 to be printed on the photograph 70 is unique. However, the same barcode 11 may be scanned as many times, in response, the prizes may be given as many times. Even this case, the user views the site of the sponsor eventually, and therefore the advertising effectiveness can be expected fully.

(20) Although the application example 7 has taken the example where the sponsor is one company, the number of sponsors may be optional. In this case, the center server 31 instructs the PC 43 to access the contents server 74 (of the sponsor) corresponding to the barcode 11 with reference to the converting table of FIG. 30. In this way, in the case where there are many sponsor, for example, the barcodes 11 of the plurality of sponsors may be included in the plurality of photographs based on a single request from the user. Also, for example, the barcode 11 of the same sponsor may be printed on the plurality of photographs based on a single request, and the barcode 11 of the other sponsor may be printed when there is the other request. Further, for example, the sponsor may be switched in accordance with the number of the photographs to be printed irrespective of the users.

(21) In the application example 7, the single barcode 11 is printed on the single photograph. However, the plurality of barcodes 11 may be printed on the single photograph. In this case, the barcodes 11 of the different sponsors or the same sponsor may be printed. Also, although the barcode 11 has been printed on the back face of the photograph, the barcode 11 may be printed on the surface of the photograph. Further, the barcodes 11 may be printed on several of the photographs based on the single request instead of printing the barcodes 11 on all the photographs.

In the application example 7, the prize has made the full mount of the charge for printing the photographs free. However, a part of the charge for printing may be free. Also, the prize is limited to the payment for printing the photographs, and may be optionally set. Further, the charge for printing may be made free essentially as well as next time (pay by the sponsor), and the other thing may be given as the prize (pay by the sponsor).

In the application example 7, the prize has been the payment for printing the photographs. However, the point may be given to the user each time the scan is performed, and the prize may be given when the certain points are accumulated. Also, the point may be given when hitting, and the prize may be given when the certain points are accumulated.

In the application example 7, the rank of the prize has been single. However, there may be ranks such as a special prize, the first rank, and the second rank.

(23) In the above description, when the center server 31 receives the barcode 2510 belonging to the first group 251 of FIG. 15, the individual portal screen 100 or 130 is sent to the PC 43. This case has taken the example where the advertiser is the same as the manufacturer indicated by the barcode 2510. However, the individual portal screen 100 of a specific advertiser may be sent irrespective of the manufacturer indicated by the barcode 2510. For example, it is assumed that there are a company “A” and a company “B” as a competitor thereof, and the company “A” corresponds to the above specific advertiser. In this case, when the barcode 2510 issued by the company “B” is scanned and sent to the center server 31, the center server 31 sends the individual portal screen 100 or 130 of the company “A” to the PC 43. By doing this, it can be expected that the company “A” leads the company “B” with regard to the advertising. In this case, the advertisement support corporation operating the center server 31 receives money from the company “A”. Needless to say, there may be the plurality of the specific advertisers. Also, the WEB site of the company “A” may be directly displayed on the PC 43 instead of sending the individual portal screen 100 and 130.

The business model like this can be combined with the above application example 7. That is, the WEB site of the company “A” may contain the hit page. And, it is anticipated that many people scan various barcodes 2510 printed on various commodities in order to get the prize. The more the barcodes 2510 are scanned, the more the WEB site of the company “A” is accessed, so that advertising effect is enhanced more. In this way, since the prize becomes incentive, a lot of scans are performed, and therefore the accesses to the WEB site of the company “A” increase. Incidentally, the barcodes 2510 belonging to the first group 251 are printed on a lot of commodities, so that the objects to be scanned abound.

By the above manner, since the competitors of the specific advertiser becomes disadvantageous with regard to the advertising, it is expected that these competitors also request the advertisement support corporation operating the center server 31 to provide the same service, and therefore it is expected that this advertisement support corporation can obtain a lot of profit.

(25) The barcode 431, which is issued in the application example 9, can be used as the barcode 11 of all the application examples. Also, the barcode 431 of the application example 9 belongs to the second group of FIG. 15.

(26) In step S3008 of the application example 10, although the first individual portal screen file 230 is referred, the table of FIG. 10 may be referred. Or, the process can proceed from step S3002 to step S3014 unconditionally without having these file and table. Also, although the barcode database 96 associates the barcode information with the company name and the commodity name, the barcode database 96 may associate the barcode information with the company name, or the barcode information with the commodity name. The step S3021 is unnecessary if the center server 31 can obtain only the company name while the step S3020 is unnecessary if the center server 31 can obtain only the commodity name.

Also, in the above description, the center server 31 accesses the book database 91 with the ISBN code (barcode) as an index. However, the method for acquiring the book title and so on is not limited thereto. For example, the book database 91 is constructed by an WEB server in which a file is prepared for each ISBN code. And, each file includes a book title, an author name, and a publisher of a book corresponding to the ISBN code, and a URL of an electronic commerce site for buying the book (may include the URL of the publisher). Then, the center server 31 accesses the book database 91 by indicating the file name, and thereby can obtain the file.

For example, it is assumed that the center server 31 receives the 13-digit ISBN code “9784819018029” from the PC 43. In this case, in step S3025 of FIG. 51, the center server 31 produces a URL (http://www.ssd.co.jp/xavix/4819018027) including the numerals “481901802” which are a part (a country code, a publisher code, and a title code) of the ISBN code, and a check digit “7” as produced newly. And, in step S3026, the center server 31 accesses the book database 91 based on the URL to acquire the file corresponding to the ISBN code “4819018027”. In this case, the character string www.ssd.co.jp is a domain name of the book database 91, the character string “xavix” is a directory name, and the numerals “4819018027” consists of a country code, a publisher code, a title code, and a check digit. Incidentally, in the case where the site designated by “http://www.ssd.co.jp/xavix/4819018027” is an electronic commerce site for purchasing the book, the book database 91 need not have a URL of the electronic commerce site for purchasing the book.

In this way, the center server 31 can also produce the URL based on the received barcode. In this case, the center server 31 can acquire the file which corresponds to the barcode and is located on the network 33 based on the produced URL.

Meanwhile, when the URL is produced, although the part of the barcode is used, all thereof may be used.

Further, as the above description, although the publisher database 93 is prepared separately from the book database 91, the book database 91 may have barcode information associated with the URL of the publisher. In this case, the publisher database 93 is not required.

(27) The application examples 1 to 11 may be combined optionally.

(28) In the application example 11, the unique barcode 11 has been assigned to the photographing position data. However, the photographing position (latitude data and longitude) indicated by the photographing position data may be in itself included in the barcode as characters. In this case, in the digital camera 450 with the GPS function (see FIG. 52(a)), this camera 450 may issue the barcode 11 and give it to the PC 43, or the PC 43 may receive the photographing position data from the camera 450 and issue the barcode 11. Also, in the digital camera 451 without the GPS function (see FIG. 52(b)), the PC 43 may associate the image data with the photographing position data, and issue the barcode 11 including the photographing position data.

In the case like this, since the contents server 72 does not issue the barcode 11, the PC 43 can make the printer 452 print the photograph 454 with the barcode 11 without accessing the contents server 72 (i.e., the steps S352, S354, S374, and S376 are not required). Incidentally, in this case, steps S356 and S378 are not required also.

Also, in this case, when the barcode 11 printed on the photograph 454 is scanned, for example, the following processing is performed in FIG. 22.

Referring to FIG. 22, in step S1506, the browser 82 transmits the barcode information received from the barcode reader 7 to the center server 31 through the network 33.

And, in step S1508, the center server 31 appends the barcode information to the URL of the contents server 72, and transmits the URL to the browser 82 of the PC 43. In step S1510, the browser 82 accesses the contents server 72 designated by the received URL. In this case, the URL including the barcode information is also transmitted to the contents server 72. Then, in step S1512, the contents server 72 produces the controlling file of FIG. 24 based on the photographing position (latitude data and longitude) included in the barcode information, and sends it to the PC 43.

Incidentally, in this case, the processes of the steps S1500, S1504, S1514, S1516, S1518 and 1520 are not modified, so that these descriptions are omitted.

Also, in this case, the PC 43 may access the contents server 72 directly without accessing the center server 31, send the barcode information, and acquire the controlling file.

(29) In the application example 11, the contents server 72 has issued the barcode 11. However, the center server 31 may issue the barcode 31. The example is as follows. The PC 43 transmits the photographing position data to the center server 31. And, the center server 31 assigns the unique barcode 11 to the photographing position data as received, and transmits it to the PC 43. Also, the center server 31 sends the barcode 11 and the photographing position data to the contents server 72. Then, the contents server 72 produces the controlling file of FIG. 24 based on the photographing position data as received, and transmits the URL which indicates the storage location of this controlling file, and the barcode 11, to the center server 31. The center server 31 registers the URL and the barcode 11 in the converting table of FIG. 27. In this case, for example, the center server 31 charges each time the barcode 11 is issued.

(30) The application example 11 has taken an example where the terrestrial globe application 86 acquires the image data from the terrestrial globe sever 80 to display on the monitor 88. However, the contents server 72 may directly transmit the image data to the browser 82 in place of the controlling file, and the browser 82 may display this image data. Needless to say, in this case, sound data and/or character data may be sent together with the image data or in place of the image data. Also, the contents server 72 may transmit the storage location (e.g., URL) of the image data to the browser 82 in place of the controlling file, and the browser 82 may acquire the image from the storage location to display it. Needless to say, in this case, the storage location of sound data and/or the storage location of character data may be sent together with the storage location of the image data or in place of the storage location of the image data.

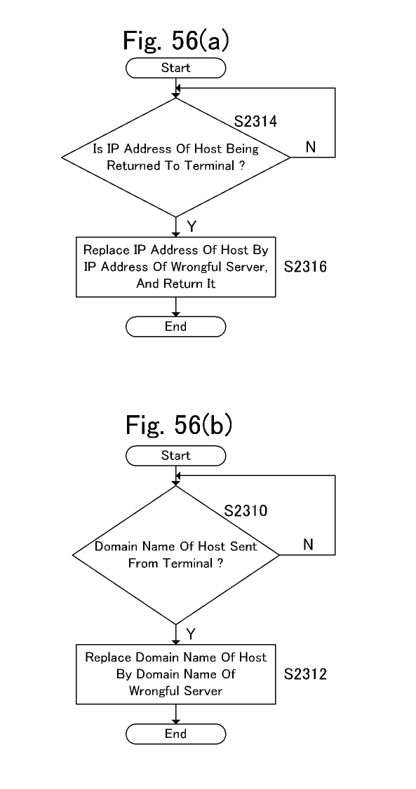

(31) In the application example 12, the wrongful program 81 is installed in the terminal 5. However, a program and a device, which replaces an IP address of the host computer 1 by an IP address of the wrongful server 69 on the network 33 to return it to the terminal 5, are also impermissible because the business of the above business entity is thwarted (obstruction of business), and therefore must be prohibited. That is, referring to FIG. 56(a), in step S2314, the wrongful program located on the network 33 determines whether or not the IP address of the host computer 1 is being returned to the terminal 5, the process proceeds to step S2316 if YES, conversely the process returns to step S2314 if NO. And, in step S2316, the wrongful program replaces the IP address of the host computer 1 by the IP address of the wrongful server 69, and sends it to the terminal 5.

Moreover, a program and a device, which replaces a domain name of the host computer 1 sent to the network 33 by the terminal 5 by a domain name of the wrongful server 69, are also impermissible because the business of the above business entity is thwarted (obstruction of business), and therefore must be prohibited. Because, in this case, since a DNS server sends the IP address of the wrongful server 69 to the terminal 5, the terminal 5 accesses the wrongful server 69 as the result. That is, referring to FIG. 56(b), in step S2310, the wrongful program located on the network 33 determines whether or not the domain name of the host computer 1 has been sent from the terminal 5, the process proceeds to step S2312 if YES, conversely the process returns to step S2310 if NO. And, in step S2312, the wrongful program replaces the domain name of the host computer 1 by the domain name of the wrongful server 69, and sends it to the DNS server.

(32) In the above description, the service (content) from the host computer 1, the center server 31 or the contents server may be provided as a condition that the user logins. For example, the login may be made by a barcode for logging in, or by a serial number of the barcode reader 7.

(33) Although the contents server provides the content via the center server 31 in the above example, the barcode may directly be sent from the PC to the contents server without getting routed to the center server 31 and the content may be provided directly.

(34) As described above, in an example using the barcode creating apparatus 462 of the application example 13, although the host computer 1 has the converting table in which the whole barcode 11 is associated with the address information of the corresponding content, a method of providing the content corresponding to the barcode 11 is not limited thereto.

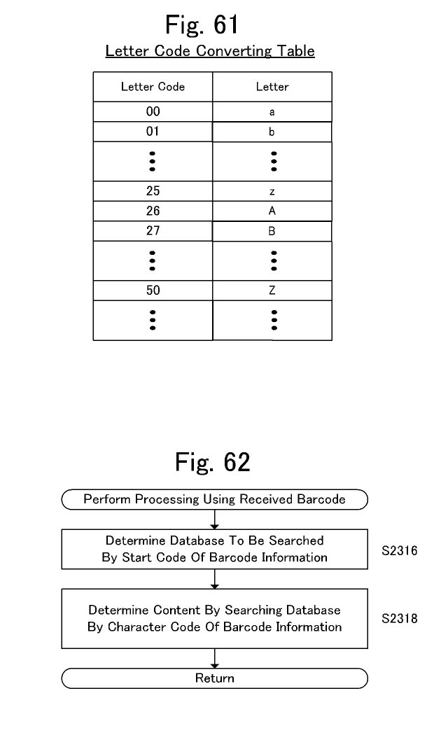

(First Modification of Application Example 13) In an example using the barcode creating apparatus 462 of the application example 13, the letter code 474 may be also perceived as a code obtained by bar coding a character code. For example, as shown in FIG. 61, the host computer 1 may have a letter code converting table in which the letter code 474 is associated with the letter 472, and thus the letter code 474 may be perceived as data indicating the letter 472.

As shown in FIG. 61, the respective letter codes 474 are associated with the predetermined alphabets, “00” to “25” correspond to the small letters “a” to “z”, and “26” to “50” correspond to the capital letters “A” to “Z”. Although the figure is omitted, “51” to “99” correspond to the other letter, numeral, symbol, drawing, or the like.

For example, the host computer 1 determines that letter “a” is input if the letter code 474 of the barcode information as received in step S31 of FIG. 3 indicates “00”, the letters “apple” is input if the letter code 474 indicates “0015151104”, and the letters “application” is input if the letter code 474 indicates “0015151108020019081413”. Since the letter, numeral, drawing, or the like is printed corresponding to the letter code 474 on the letter indicating part 472 of the letter card 468, the user creates the barcode 11 by arranging the letter cards 468 so that the desired letters on the letter indicating part 472 are aligned, scans it by the local barcode reader 7, and thereby can input the desired letters to the host computer.

Although the figure is omitted, the host computer 1 can also send a content corresponding to the desired letters by the user as described above to the user by separately having a database in which the letter string is associated with the content corresponding thereto.

In this way, in the barcode creating apparatus 462, since the character code is output when the local barcode reader 7 scans the barcode 11, if the host computer 1 has the table for converting the character code into the letter, it is possible to input the letter by the barcode or search for the content by the letter.

Incidentally, an optional code and converting table may be employed as the character code indicated by the letter code 474 and the converting table therefor. For example, a character code according to a unified standard, such as JIS, and a converting table according to the unified standard may be employed, or a standard that a business entity operating the remote barcode reader system independently defines may be employed.

(Second Modification of Application Example 13) The processing of the second modification shown in FIG. 62 is performed as the process of step S31 of FIG. 3.

Referring to FIG. 62, the host computer determines a database to be searched by the start code 470 of the barcode information in step S2316. In step S2318, the host computer 1 searches the database determined in step S2316 by the consecutive letter codes 474 as an index, acquires the content or the address information corresponding to the letter codes 474, and returns. With regard to the search, the host computer 1 may converts the letter codes 474 into the letter string by the above letter code converting table instead of using the letter codes 474 as it is, and then search. Also, in this second modification, the host computer 1 need not implement all of the plurality of the databases inside thereof, and may search the external database.

(Third Modification of Application Example 13) The barcode creating apparatuses 458 and 462 can be employed not only under the remote barcode reader system but also under only the terminal 5 as a barcode input device. However, this case requires that software for executing the process that the host computer 1 executes is installed on the terminal 5 itself in order to display the above content on the terminal 5.

(35) In the present specification, the term “unit” as used herein does not always refer to a physical device but can also refer to software for implementing the functions of this unit. Furthermore, the functions of one unit may be implemented by two or more physical devices. Conversely, the functions of two or more units may be implemented by one physical device. These are true for the server and the computer, too.

While the present invention has been described in detail in terms of embodiments, it is apparent that those skilled in the art will recognize that the invention is not limited to the embodiments as explained in this application. The present invention can be practiced with modification and alteration within the spirit and scope of the present invention as defined by the appended any one of claims.

1-32. (canceled)

33. A host computer connectable with a plurality of local code leaders each of which is capable of reading a code and connected with a communication terminal which is provided corresponding to the each local code leader and connectable with Internet, the host computer being connectable with each of the local code leaders through the Internet and the communication terminal corresponding thereto, said host computer comprising:
a receiver operable to receive a plurality of the codes transmitted from the plurality of the local code leaders; and
a processing unit operable to search for a name of a company or an item corresponding to the received code on the Internet by using a search engine, and acquire address information of a site related to the company or the item.

34. (canceled)

35. The host computer as claimed in claim 33 wherein said processing unit acquires the address information which appears at the highest position in search ranking of the search result by the search engine.

36. The host computer as claimed in claim 33 wherein said processing unit generates a screen including link information to the corresponding site on the basis of the acquired address information in order to send to the communication terminal.

37. The host computer as claimed in claim 36 wherein the code is a code given specific to each item, and
wherein the screen is a screen specific to the item corresponding to the code.

38. The host computer as claimed in claim 36 wherein the link information includes link information to a home page of an advertising client of an item indicated by the code information, link information to a site in which a commercial video of the item indicated by the code information is distributed, link information to a site in which the item indicated by the code information can be purchased, link information to a site in which an image of the item indicated by the code information is displayed, link information to a site in which description is given for the item indicated by the code information, link information to a site in which user registration can be done in relation to the item indicated by the code information, link information to a site in which a questionnaire can be conducted in relation to the item indicated by the code information, link information to a site in which after-sales service is provided for the item indicated by the code information, or any arbitrary combination thereof.

39. The host computer as claimed claim 36 wherein the screen includes link information to a site in which user registration can be done, link information to a site in which a questionnaire can be conducted, or any arbitrary combination thereof.

40. The host computer as claimed in claim 36 wherein the screen includes link information to a site of a store or a retailer, which sells an item indicated by the code information.

41. The host computer as claimed in claim 33 wherein said processing unit sends the acquired address information to the communication terminal.

42-44. (canceled)

45. The host computer as claimed in claim 33 wherein the code is a common product code.

46. The host computer as claimed in claim 45 wherein the common product code is a code which is used in a POS (Point Of Sale) system.

47-48. (canceled)

49. The host computer as claimed in claim 45 wherein when the code as received is an instore code, the processing unit returns a predetermined message to the communication terminal.

50. The host computer as claimed in claim 45 further comprising:
a classification unit operable to classify the received code into one of a plurality of groups,
wherein said processing unit performs, by a use of the received code, a process corresponding to the group to which the received code belongs, and
wherein a group in the plurality of groups is a group of the common product code.

51. The host computer as claimed in claim 33 wherein the code is transmitted to said host computer by the communication terminal through the Internet in response to transmission of the code from said local code reader.

52. The host computer as claimed in claim 33 wherein the processing unit performs a different process corresponding to the same code in accordance with a location where the communication terminal is installed.

53. The host computer as claimed in claim 52 wherein the processing unit receives information for determining the installation location of the communication terminal from the communication terminal, and performs a process by a use of the code in accordance with the information.

54. The host computer as claimed in claim 53 wherein the installation location of the communication terminal can be a personal residence or a store,
wherein the processing unit receives, from the communication terminal installed in the personal residence, the information for determining that the communication terminal is installed in the personal residence, and receives, from the communication terminal installed in the store, the information for determining that the communication terminal is installed in the store.

55. The host computer as claimed in claim 33 wherein the codes are assigned to articles which include tangible entities inclusive of goods or estate, intangible entities inclusive of service or information, commodities, and living things inclusive of human being and animals, and wherein the information includes an image, a sound, a program or data.

56. The host computer as claimed in claim 33 wherein the codes includes one-dimensional codes, two-dimensional codes, or codes which are stored in IC tags.

57. The host computer as claimed in claim 56 wherein the one-dimensional codes are one-dimensional barcodes, the two-dimensional codes are QR codes, and the IC tags are RFID tags.

58. A method used by the host computer recited in claim 33.

59. (canceled)

60. A computer readable storage medium storing a computer program that causes a computer to function as the host computer recited in claim 33 by being executed by the computer.

61-86. (canceled)
